(19) United States
(12) Patent Application Publication
(10) Pub. No.: US 2007/0073894 A1
(43) Pub. Date: Mar. 29, 2007

(54) Networked information indexing and search apparatus and method

(75) Inventors: Robert P. Erickson, Queen Creek, AZ (US); David A. Fox, San Francisco, CA (US)

Correspondence Address: GREENBERG TRAURIG LLP, 2450 COLORADO AVENUE, SUITE 400E, SANTA MONICA, CA, 90404, US

(73) Assignee: O Ya! INC., CHANDLER, AZ (US)

(21) Appl. No.: 11/520,968

(22) Filed: Sep. 13, 2006

Related U.S. Application Data
(60) Provisional application No. 60/717,531, filed on Sep. 14, 2005.

(51) Int. Cl. G06F 15/16

(52) U.S. Cl. 709/230

(57) ABSTRACT

A networked information indexing and search apparatus and method provide access, including indexing and search access, to information located on one or more intranets, the Internet, or both. The networked search apparatus, also referred to herein as a network search device or network search appliance, and method comprise configuration, indexing, and searching capabilities to facilitate networked information search and retrieval.

### CROSS-REFERENCE TO RELATED APPLICATIONS

This application claims the benefit of U.S. Provisional Patent Application No. 60/717,531, filed Sep. 14, 2005, the contents of which are incorporated herein by reference.

### BACKGROUND DISCUSSION

1. Field of the Invention

The present disclosure relates generally to the field of indexing and searching network resources, and more particularly to indexing shared resources accessible via a network for search and retrieval, and to an apparatus and method for same.

2. Description of the Related Art

Computer systems are typically used for various business, education, and entertainment-related applications, many of which store, retrieve and process information. The increased availability of computer systems and computer networks, such as intranets and the Internet, for example, has made vast repositories of information available to a huge segment of our population.

While computers have undoubtedly provided enhanced abilities for information accessibility and information processing, the sheer volume of information available in electronic form has, in many ways, exceeded our ability to manage it. This phenomenon has been termed “information overload” and means that, now awash in information, it is becoming increasingly difficult to find information when desired. Accordingly, many new tools are being developed to deal with the ever-expanding volume of information that is now available for consumption in an electronic form. While relatively primitive search capabilities are provided in many desktop operating system environments, the ability to index, categorize, search and retrieve desired documents is quite limited.

For example, the World Wide Web (“WWW” or “web”) can provide access to a vast amount of information. Locating the desired information, however, can be quite challenging. This problem is compounded because both the amount of information available on the web and the number of inexperienced users searching the web is growing exponentially. In an attempt to deal with this problem, a number of specialized search tools, known as “search engines,” have been developed. Several of the more well-known search engines are Google, Yahoo, and MSN Search.

However, convention web-based search engines are not designed for use in an enterprise environment comprising local area networks (LANs) and intranets, with data which can be in many different forms, or formats, using various localized repositories.

In general, search engines attempt to return hyperlinks to specific web pages considered to be relevant to a user's interest(s). The goal of the search engine is to provide the user with multiple links to high quality, relevant results based on the user's search query. Most search engines base their determination of the user's interest on a collection of search terms (called a search query) entered by the user. Typically, the search engine accomplishes this by matching the terms in the search query against a corpus of pre-stored, pre-indexed web pages. Web pages that contain the user's search terms are called “hits” and are returned to the user.

In an attempt to increase the relevancy and quality of the web pages returned to the user, a search engine may also attempt to sort the list of hits so that the most relevant and/or highest quality pages are at the top of the list of hits returned to the user. For example, the search engine may assign a rank or score to each hit, where the score is designed to correspond to the relevance or importance of the web page.

Conventional methods of determining relevance are typically based on the contents of the web page. More advanced techniques determine the importance of a web page based on more than the content of the web page. For example, one known method, described in the article entitled “The Anatomy of a Large-Scale Hypertextual Search Engine,” by Sergey Brin and Lawrence Page, assigns a degree of importance to a web page based on the link structure of the web page. However, such an approach relies on data to be in a web page format, which is not altogether applicable in a LAN environment where much of the data is contained in other than web page format.

For example, while a data repository on the Internet or an intranet may contain a video clip, the search engine may not be capable of indexing and/or accessing the video clip to identify content, depending on the format and/or content of the video clip and the sophistication of the search engine. A similar problem may be encountered with other forms of content such as word processing documents, graphic image files, MP3 clips, interactive blogs, etc.

Furthermore, it may not be desirable for the entire set of links, pages, and/or documents to be made available to a given user. This is especially true in the rapidly evolving area of the desktop computer, local area network, and intranet environments. For example, in certain intranet environments, while one user may be authorized to view certain documents, other users on the same intranet should not be provided with access to a particular document, even if their search query indicates that the document should be returned as part of the result. Since current search engine technologies operate outside of the control of most operating systems, it is extremely difficult to customize access to search results based on any type of security model.

### SUMMARY OF THE INVENTION

A networked information indexing and search apparatus and method provide access, including indexing and search access, to information located on one or more intranets, the Internet, or both. The networked search apparatus, also referred to herein as a network search device or network search appliance, and method comprise configuration, indexing, and searching capabilities to facilitate networked information search and retrieval.

In at least one embodiment of the present disclosure, a device connectable to a network, the device comprising an integrator, a resource identifier and an information retrieval engine. The integrator is configured to integrate the device on the network using dynamically-established network settings including a network address for the network device. The resource identifier is configured to traverse at least a portion of the network to discover one or more network devices connected to the network, identify information sources associated with at least one of the discovered network devices, and create at least one index of information items associated with the identified information sources. The information retrieval engine is configured to identify information items available from the identified information sources that satisfy a search criterion, or search criteria.

In at least one embodiment of the present disclosure, a network search device comprises configuration, or integration, resource identification and indexing, and searching components. During configuration, network settings, such as a network address, are dynamically established for the network search device. The indexing component of the network search device searches the network, identifies sharable resources available on the network, and maintains a search repository, or database, of search information. In response to a search request, the network search device's searching component uses the search database to search for information on the network. In one embodiment of the present disclosure, search results are scored, or ranked, according to one or more scoring mechanisms.

In another embodiment of the disclosure, a method executed by a network search device comprises configuring the network device, including dynamically establishing network settings, such as a network address, corresponding to the network device, creating an index of sharable resources on the network, including searching the network to identify the sharable resources on the network and maintaining a search repository, or database, of search information, and searching for information on the network using the search database, in response to a search request. According to one embodiment of the disclosure, search results are scored, or ranked, according to one or more scoring mechanisms.

According to at least one embodiment of the disclosure, the network search device is configured using a user datagram protocol (UDP) client/server model, wherein messages are transmitted between the search device and a network device (e.g., a network server) to assign Internet Protocol (IP) settings, which include an IP address, for the search appliance. A bootstrap client executes on the network server, which polls the network via a message broadcast to each of the network search devices physically connected to the network, or network segment. In response, each network search device provides identification information, e.g., its Medium Access Control (MAC) address and hostname. The bootstrap client on the network server uses the network search device's identification information to communicate with the network search device to set an IP state of the search appliance, and to reset the search appliance.

The network search device searches, also referred to herein as crawling or web crawling, the network for sharable resources, or shares, and maintains/updates a repository of information associated with each share to facilitate indexing and/or search. For example, a sharable resource can be a hard disk drive, or other storage media, fixed or removable, or one or more file system directories, files, documents, pages etc. stored thereon, with “sharable” access rights. According to one embodiment of the disclosure, a database stores information corresponding to these sharable resources, which is used for indexing and search.

The database includes domain, uri, and page tables used to store information corresponding to pages within documents stored as files at a location, or domain, on the network. The domain table includes a name corresponding to each domain. The uri table includes a universal resource indicator, or uri, for each document, together with other document information (e.g., last modification date and index time). The page table has an entry for each page (e.g., web page, email, page within a word processing document, etc.).

The database further includes a lexicon, or dictionary, of “original” words, which is dynamically updated to include new words. In addition, the database includes parts of speech of each word. One or more, preferably every, stem words constructed from an original word is stored in the lexicon, with each stem word being related in the database to the original word from which it was constructed. A rank table stores entries, each of which records the frequency of occurrence of a stem word with a document/page, as it is currently known (i.e., at the time of the last index and/or modification). A word table identifies locations of original words within a document/page.

In at least one embodiment of the disclosure, the database model is such that new records can be added to one or more database tables using a file import mechanism, instead of a database insert command (e.g., structured query language, SQL, insert command). Existing records are updated using an SQL update command. For example, using a file import mechanism, data used to populate records in one or more of the uri, page, rank and word tables is buffered, and thereafter written to the database (e.g., at the end of indexing and/or as the data buffers become full).

In one or more embodiments of the disclosure, an N-ary trie is used to buffer the lexicon and provides efficient word lookup. The value of “N” is based on the particular character set used to represent the words in the lexicon. For example, “N” can represent the number of characters in an alphabet, together with a number of digits and punctuation marks. In one or more embodiments of the disclosure, prior to performing an indexing operation, the contents of the lexicon table are written to the N-ary trie buffer structure. Updates made during an indexing operation, such as new words found in new or updated documents/pages, are first written to the N-ary trie buffer structure, and then written to the database using the file import mechanism.

In one or more embodiments of the disclosure, a scoring mechanism, which can include one or more “weighting” methodologies is used to provide enhanced search results. More particularly, a scoring mechanism is used to rank results from a search, to determine a relevance score for each item (e.g., document, page, etc.) identified from a keyword search. Even more particularly and in accordance with one or more embodiments of the disclosure, the scoring mechanism is used to rank an item's relevance based on both a frequency of occurrence of a keyword found in a document and a correlation between multiple keywords found in the document. Advantageously, for example, in a case that aggregation of frequency of occurrence corresponding to each keyword found in a search result item identified in the search are comparable for all search result items, the scoring mechanism can be used to determine correlations between multiple keywords found within a given search result item, to assist in differentiating the relevance of a search result item relative to the other search result items uncovered in the search.

In one embodiment of the present disclosure, the scoring algorithm scales products of frequencies of occurrence, using different combinations of frequencies of occurrence associated with the keyword terms, beginning with a first order and increasing to an order equal to the number of keywords in the search, to determine relevance corresponding to a search result item having multiple keywords. According to one embodiment, the relevance can be determined for each search result item having multiple keywords. In an alternate embodiment, a threshold number, which identifies a number of multiple keywords, is used to determine the relevance score assigned to a search result item. More particularly, if a search result item contains less than the threshold number of multiple keywords, its relevance score is set to zero. However, in a case that the search result item contains at least the threshold number of keywords, the scoring algorithm is used to determine a relevance score using the scoring algorithm.

### BRIEF DESCRIPTION OF THE DRAWINGS

Embodiments of the present disclosure will hereinafter be described in conjunction with the appended drawings wherein like designations denote like elements and:

FIG. 1 illustrates a block diagram of a representation of a network of computing devices and peripherals in which one or more embodiments of the present disclosure can be used in provided;

FIG. 2, which comprises FIGS. 2A to 2H, illustrates client/server model message type examples for use in accordance with one or more embodiments of the present disclosure.

FIG. 3 provides an illustrative example of a block diagram of an internal architecture of a search appliance in accordance with one or more embodiments of the present disclosure;

FIG. 4, which comprises FIGS. 4A to 4D, provides examples of scoring in accordance with one or more embodiments of the disclosure.

FIG. 5, which comprises FIGS. 5A and 5B, provides an example of scoring in exemplary cases in accordance with one or more embodiments of the present disclosure.

FIG. 6 illustrates a flowchart of process steps to create and update an index in accordance with one or more embodiments of the present disclosure;

FIG. 7 provides an illustrative example of a block diagram of a search appliance used in indexing and searching in accordance with one or more embodiments of the present disclosure;

FIG. 8 illustrates a flowchart of process steps to score and rank search results in accordance with one or more embodiments of the present disclosure;

FIG. 9, which comprises FIGS. 9A and 9B, provides an illustrative example of a database schema used in one or more embodiments of the disclosure.

FIG. 10 provides an example of a 3-ary trie tree in accordance with at least one disclosed embodiment.

FIG. 11, which includes FIG. 11A to FIG. 11O, provides illustrative examples of screens from a user interface of a search appliance in accordance with one or more embodiments of the disclosure; and

FIG. 12, which includes FIG. 12A to FIG. 12Y, provides illustrative examples of screens from a user interface used in configuration operations for, and/or associated with, a search appliance in accordance with one or more embodiments of the present disclosure.

### DETAILED DESCRIPTION

A networked information indexing and search apparatus and method provide access, including indexing and search access, to information located on one or more intranets, the Internet, or both. The networked search apparatus, also referred to herein as a network search device or network search appliance, and method comprise configuration, indexing, and searching capabilities to facilitate networked information search and retrieval.

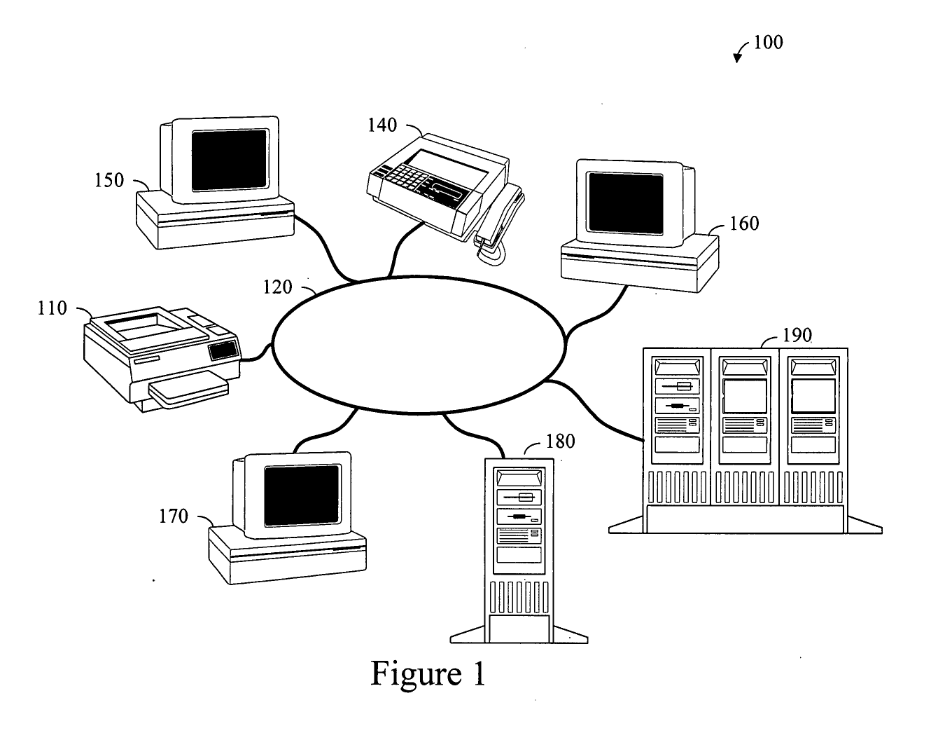

Referring now to FIG. 1, a block diagram of a representation 100 of a network of computing devices and peripherals in which one or more embodiments of the present disclosure can be used in provided. According to one or more embodiments of the disclosure, computers 150, 160, and 170, at least one instance of search appliance 180, and at least one data server 190 are coupled via a network 120. Additionally, an optional printer 110 and an optional fax machine 140 are shown. By virtue of embodiments disclosed herein, individuals, business entities and the like, for example, can efficiently and effectively access and manage the storing, indexing, accessing, and retrieving of electronic data as described herein.

Optional printer 110 and an optional fax machine 140 are standard peripheral devices that can be used for transmitting or outputting paper-based documents, notes, search results, reports, etc. in conjunction with the queries and transactions processed by computer-based system 100. It should be apparent that optional printer 110 and optional fax machine 140 are merely representative of the many types of peripherals that can be utilized in conjunction with the present disclosure, and that other peripheral devices can be used with one or more embodiments of the present disclosure and no such device is excluded by its omission in FIG. 1.

Network 120 is any suitable computer communication link or communication mechanism, including a hardwired connection, an internal or external bus, a connection for telephone access via a modem or high-speed T1 line, radio, infrared or other wireless communications, private or proprietary local area networks (LANs) and wide area networks (WANs), as well as standard computer network communications over the Internet or a network internal (e.g. “intranet”) to an enterprise, or entity, via a wired or wireless connection, or any other suitable connection between computers and computer components known to those skilled in the art, whether currently known or developed in the future. It should be apparent that portions of network 120 can suitably include a dial-up phone connection, broadcast cable transmission line, Digital Subscriber Line (DSL), ISDN line, or similar public utility-like access link. Furthermore, network 120 can comprise one or more network segments.

In one or more embodiments of the present disclosure, at least a portion of network 120 comprises a standard wired or wireless Internet connection between the various components of computer-based system 100. Network 120 provides for communication between the various components coupled to network 120, which allows for information to be transmitted between devices coupled thereto. Using embodiments of the disclosure, a user of computer system, e.g., computer 150, 160 and 170, connected to network 120, for example, can gain access, based on access privileges corresponding to the user, to data and information accessible via network 120. Regardless of physical nature and topology, network 120 serves to link the physical components of computer-based system 100 together, regardless of their physical proximity. It is contemplated that, in one or more embodiments of the present disclosure, data server 190 and computers 150, 160, and 170 can be geographically remote and physically separated from each other.

In accordance with embodiments disclosed herein, computers 150, 160 and 170 can be any type of computer known to those skilled in the art that is capable of being configured for use with computer-based system 100 as described herein. This includes laptop computers, desktop computers, tablet computers, pen-based computers and the like. Computers 150, 160, and 170 are most preferably commercially available computers such as a Linux-based computer, PC-based computers, or Macintosh computers. However, as those skilled in the art should appreciate, the methods and apparatus presently disclosed apply equally to any computer or computer system, regardless of whether the computer is a traditional “mainframe” computer, a multi-user computing apparatus or a single user device, such as a personal computer or workstation.

Additionally, handheld and palmtop devices can also provide examples of devices that can be deployed as computers 150, 160 and 170. It should be apparent that any operating system or hardware platform can be anticipated, and that many different hardware and software platforms can be configured, to be deployed as computers 150, 160 and 170. Various hardware components and software components (not shown) known to those skilled in the art can be used in conjunction with computers 150, 160 and 170.

Data server 190, together with computers 150, 160 and 170, are preferably configured to store and retrieve data, some or all of which is sharable via network 120. Various hardware components (not shown) such as external monitors, keyboards, mice, tablets, hard disk drives, recordable CD-ROM/DVD drives, jukeboxes, fax servers, magnetic tapes, and other devices known to those skilled in the art can be used in conjunction with data server 190, and computers 150, 160 and 170.

In at least one embodiment, data server 190 can be configured with various additional software components (not shown) such as database servers, web servers, firewalls, security software, and the like. While a single data server 190 is shown connected to network 120 of FIG. 1, it should be apparent that embodiments of the present disclosure contemplate and embrace any number of data servers 190. The various data servers can vary in size, complexity and capability, but can all generally be capable of being configured to index and retrieve information via network 120 in accordance with embodiments presently disclosed.

In general, in one or more embodiments presently disclosed, data server 190 can represent a network accessible data server that is configured to store data files for later retrieval by the users of computers 150, 160 and 170 via network 120. A typical transaction can be represented by a request (e.g., identify, retrieve, access, etc.) for information directly stored on data server 190 or on some other computer or computer system that is logically connected to data server 190, for example. A request for information can include requests involving any type of digitized data, whether voice, text, graphics, etc. and the information can be stored in any format known now or later developed/identified.

In general, in accordance with one or more embodiments, search appliance 180 represents a network accessible computing system configured to act as a network-based indexing and search apparatus capable of indexing data, receiving search queries and processing the search queries to return one or more data files accessible via network 120, and any other appropriately designated computers, that are responsive to the search queries. A typical transaction can be represented by a request for files containing certain keywords or phrases from the data store of data server 190 or stored on some other computer or computer system that is logically connected to data server 190. The request to retrieve data can include search requests involving any type of digitized data, whether voice, text, graphics, etc. and the information can be stored in any format now known or later developed/identified.

In accordance with one or more embodiments of the present disclosure, search appliance 180 is configurable automatically via a UDP client/server model. In accordance with one or more embodiments, a user interface comprising displayable web pages using a standard web browser can be used in configuring search appliance 180.

In accordance with at least one embodiment, using the UDP client/server model and prior to configuration (e.g., an initial configuration) on network 120, the search appliance 180 is physically connected to network 120. Once the search appliance 180 is connected to network 120, as is described in more detail below, search appliance 180 transmits a message containing identification information via User Datagram Protocol (UDP) and network 120 to configure search appliance 180. Once configured on network 120, in accordance with embodiments presently disclosed, search appliance 180 can be used to identify sharable resources available on the network, and maintain a search repository, or database, of search information. In response to a search request, the search appliance 180 uses the search database to search information on the network. In one embodiment of the disclosure, search results are scored, or ranked, according to one or more scoring mechanisms.

The UDP client/server model used in one or more embodiments of the disclosure addresses an issue present when installing a network appliance on a network, such as network 120. That is, when configuring a network appliance, such as search appliance 180, on network 120, it is necessary to configure the device for network communications, e.g., TCP/IP Ethernet communication. For example, in a TCP/IP network environment, an IP address and subnet mask should be established for search appliance in order to operate over TCP/IP within the network in which it is deployed.

It is possible to use a manual configuration approach, e.g., manually setting network parameters for search appliance 180. The manual configuration approach assumes a fairly sophisticated knowledge of network configuration needs. It would therefore be beneficial to be able to configure search appliance 180 for network 120 automatically.

Another approach, which can be used with embodiments of the present disclosure, to configure search appliance 180 involves the use of BOOTP, or the superseding and encompassing DHCP, to obtain IP settings. In accordance with one or more embodiments of the present disclosure, search appliance 180 is configured to use any one or a combination of one or more of these.

With reference to the automatic configuration using the UDP client/server model, which can be used with one or more embodiments of the disclosure, it is possible to, automatically and with minimal user intervention, configure search appliance 180, e.g., identify valid IP settings, for communication on network 120. In other words, when a network device, such as search appliance 180, is initially connected to a physical network, such as network 120, without a priori knowledge of the subnet within which it resides, this approach provides an ability to establish initial communication between search appliance 180 and data server 190.

In accordance with one or more embodiments, the UDP client/server model contemplates the use of a set of connectionless UDP broadcast messages that can be used to communicate between a network device, e.g., network data server 190, and search appliance 180, without the need for search appliance 180 to be configured with TCP/IP settings, e.g., a TCP/IP address. It should be apparent that although the client/server model is described with reference to UDP, other protocols can be used. In addition, although a communication protocol defining a set of messages used to communicate with search appliance 180 is described, it should be apparent that other messages types can be used to communicate with search appliance 180 via UDP, or other network protocol.

An illustrative set of message types used in one or more embodiments of the disclosure for configuring search appliance 180 is described and set forth below. The communication protocol defines a structure for messages used in implementing the UDP client/server model. In addition, examples are provided to illustrate end-user network setup using the UDP client/server model.

It should be apparent that implementation of a simple protocol atop UDP within a client/server model is a convenient solution to network device configuration, whether or not a BOOTP, or a DHCP, server is present in the network segment.

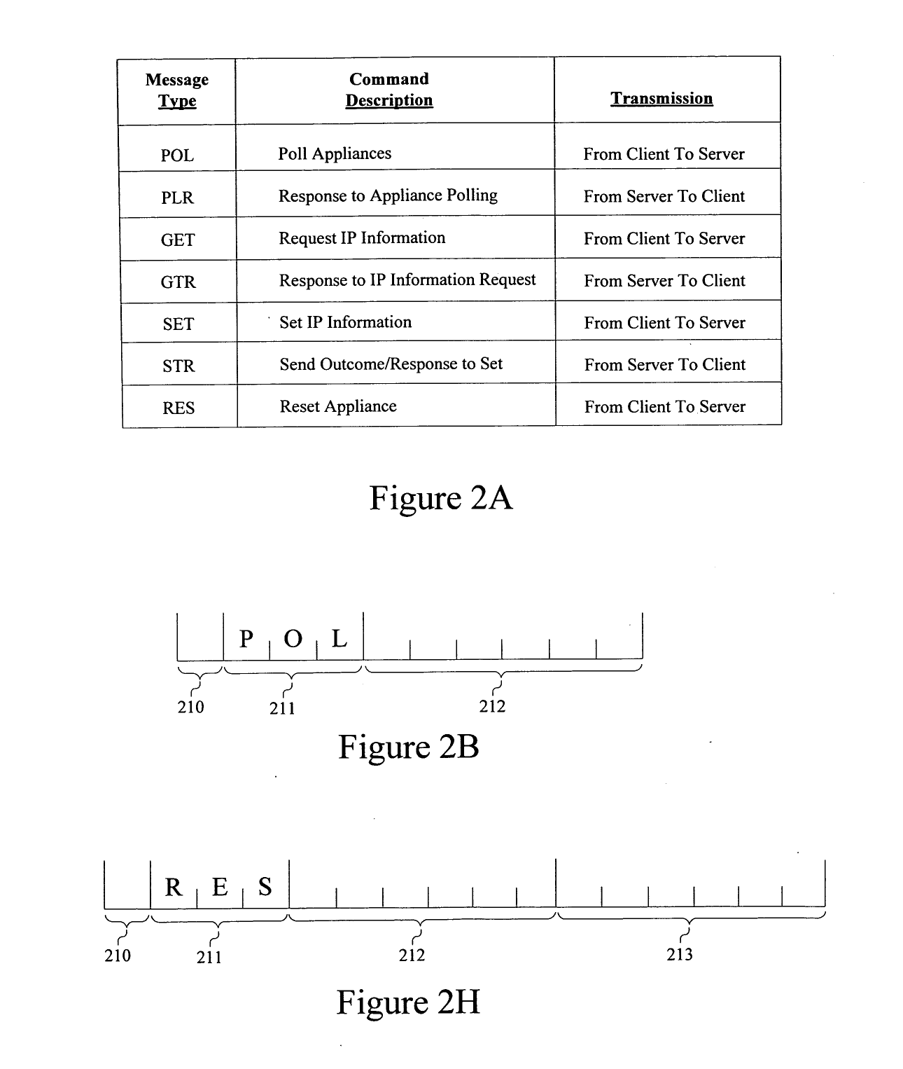

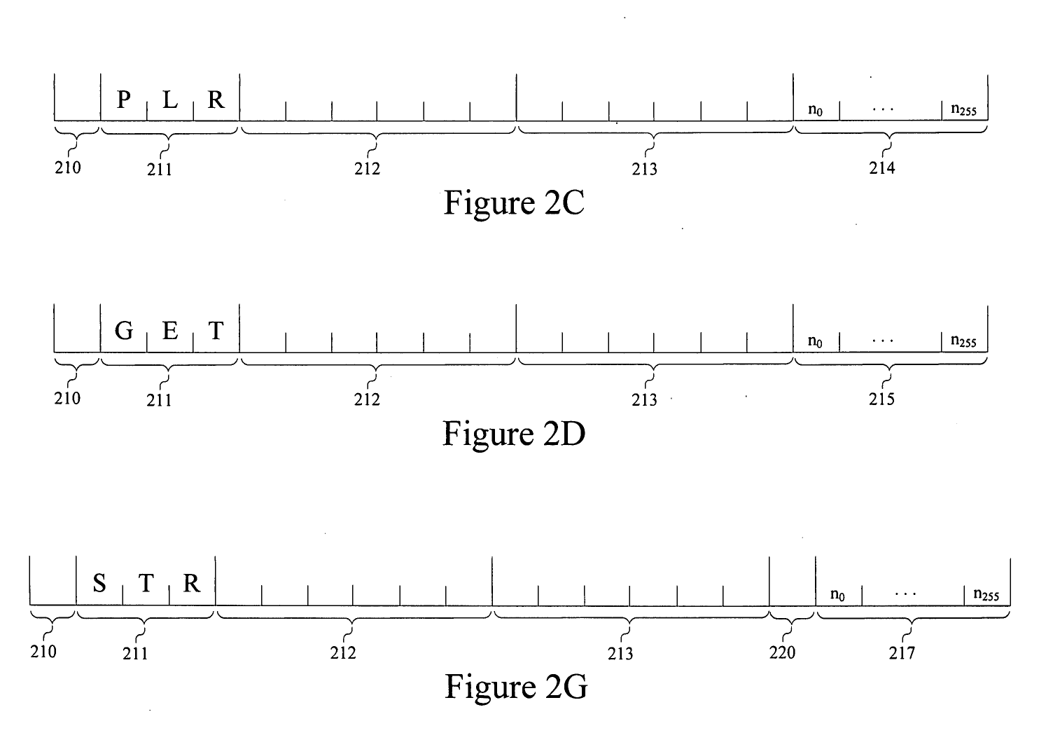

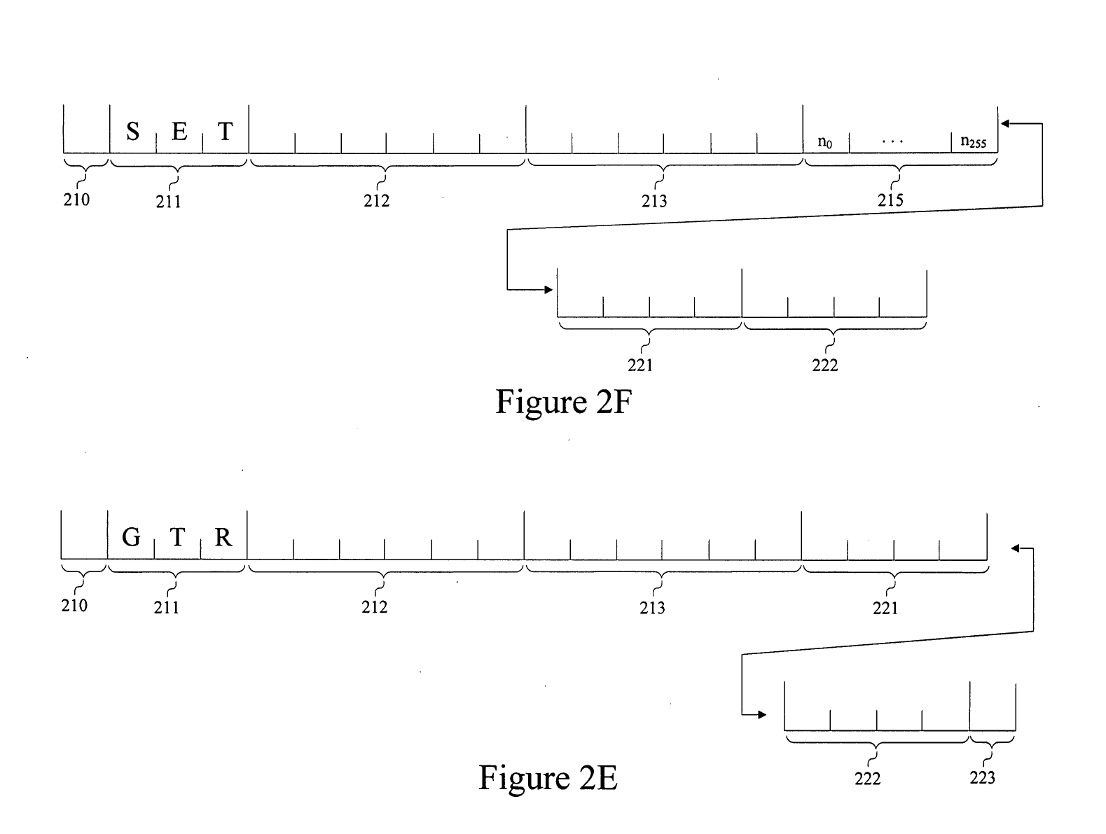

According to the UDP client/server model of the present disclosure, messages can be passed between UDP client and server. More particularly, message types are presented in terms of commands issued by the UDP client, e.g., a networked device such as data server 190, to one or more UDP servers, e.g., search appliance 180. A typical command consists of a message sent by a UDP client to one or more UDP servers listening on a dedicated port. To reply, a response message can be in the form of a message sent by one or more UDP servers back to the UDP client, which in turn listens on its own dedicated port. Unlike remote procedure calls, messages in the form of UDP limited broadcasts are connectionless, and thus, without state. There is no guarantee that an intended recipient of a message receives the message. Messages are broadcast to all devices on the network segment. Examples of messages/commands that can be used with the UDP client/server model of one or more embodiments of the disclosure are shown in FIG. 2.

FIG. 2, which comprises FIGS. 2A to 2H, illustrates client/server model message type examples for use in accordance with one or more embodiments of the present disclosure. Referring to FIG. 2A, the first command, the POL message, is issued by a UDP client, e.g., data server 190, to identify all of the UDP servers, e.g., instances of search appliance 180, in a network, or network segment. A UDP server that receives a POL message can reply with a PLR message. Using identification information provided with the PLR message, additional messages can be sent to specific ones of search appliance 180 to cause search appliance 180 to perform an operation specified by the message. For example, another message that can be issued by a UDP client, a GET message, requests IP information from a specific UDP server (e.g., a specific instance of search appliance 180). The intended UDP server can reply using a GTR message, which contains the requested information.

Another message which can be issued by a UDP client, a SET message, requests the recipient UDP server to set its IP state. The intended UDP server can reply with a STR message, which indicates the result, e.g., success or failure, of the requested operation. An RES message can be issued by a UDP client to instruct a specific instance of the search appliance 180 to initiate a reset operation to reset its state, which is accompanied by a restart of the appliance. Each of these types of messages is discussed in more detail below.

According to one example of a syntax used for the message types described herein, each message is no greater than 512 bytes in length. Of these seven types of messages, as discussed generally above, four of the messages are sent by the UDP client (e.g., network server 190) to the UDP server (e.g., search appliance 180) to initiate an operation to be performed by the search appliance 180. The remaining types of messages identified above are sent by a search appliance 180 to the UDP client in reply. Each message body identifies the sender via a MAC address field. The POL message sent by the UDP client is intended for all UDP servers that might be listening. The remaining message types are intended for a specific recipient, as is identified by its MAC address in the message body.

FIGS. 2B to 2H provide examples of message formats for use with one or more embodiments of the present disclosure. Of course is should be apparent that any other format, including varying lengths for fields described herein, can be used for a request for the identities of network devices for use with embodiments of the present disclosure.

Referring to FIG. 2B, an example is provided of a polling message format for use in accordance with one or more embodiments of the present disclosure. The polling message, e.g., POL, can be sent by a bootstrap client to each of the search appliances 180 (e.g., as a broadcast message) on the network to request the identities of the appliances on the physical network. The message requests the identities of instances of network appliance 180 connected to the network, or portion thereof. In accordance with at least one embodiment, the message comprises a field 210 to identify a version of the message protocol, a field 211 to identify the message type and a field 212 to identify the MAC address of the bootstrap client. In accordance with such an embodiment, fields 210, 211 and 212 can be 1-byte, 3-bytes and 6-bytes, respectively, in length.

FIG. 2C provides an example of a polling response message sent in reply to a polling message in accordance with one or more disclosed embodiments. The polling response message, PLR, is sent by a search appliance 180 to a bootstrap client in response to the POL message. In response to the POL message, a search appliance 180 can send a PLR message to return its MAC address and optionally its hostname. The format of the PLR message shown in FIG. 2C comprises field 210 which identifies a protocol version, field 211 which identifies the message type, field 212 which identifies the MAC address of the client, field 213 which identifies the MAC address of the responding search appliance 180, and field 214 which identifies a hostname of the responding search appliance 180. In accordance with such an embodiment, fields 210, 211, 212 and 213 can be 1-byte, 3-bytes, 6-bytes and 6-bytes, respectively, in length. Field 214 can be a variable byte length field, e.g., from zero to two hundred and fifty-five bytes.

Using the MAC address information received in the PLR message, the bootstrap client can address a specific instance of search appliance 180 to obtain additional information from the appliance. The GET message is sent by the bootstrap client to request information from a search appliance 180, such as the current network configuration of the appliance (e.g., the appliance's network (e.g., IP) address). The GET message can include authentication information, e.g., identifier, password or other authentication information, which the search appliance 180 can use to authenticate the requester (e.g., the bootstrap client).

FIG. 2D provides an example of a GET message format for use with one or more disclosed embodiments. Field 210 identifies a protocol version, field 211 identifies the message type, field 212 contains the MAC address of the bootstrap client, field 213 contains the MAC address of the responding search appliance 180, and field 215 contains authentication information (e.g., identifier, password and/or other authentication information) for use in authenticating the requester (e.g., the bootstrap client) to the search appliance 180. In accordance with such an embodiment, fields 210, 211, 212 and 213 can be 1-byte, 3-bytes, 6-bytes and 6-bytes, respectively, in length. Field 215 can be a variable in length, e.g., from zero to two hundred and fifty-five bytes.

In a case that search appliance 180 sends a response to the GET message received from the bootstrap client, the response can be in the form of a GTR message having a format such as that shown in FIG. 2E. When a search appliance 180 receives a GET message, the authentication information contained in the GET message can be used to authenticate the requester. If search appliance 180 decides to respond to the GET message, e.g., the search appliance 180 can authenticate the requester using the authentication information in the GET message, before the search appliance 180 sends the GTR message. The GTR message returns the current IP address and subnet mask of the search appliance 180. A gateway configuration can be subsequently performed via an HTTP interface.

The GTR message format shown in FIG. 2E comprises field 210 to identify a protocol version, field 211 to identify the message type, field 212 to identify the MAC address of the bootstrap client, field 213 to identify the MAC address of the responding search appliance 180, fields 221 and 222 to identify the IP address and subnet mask of the search appliance 180, and field 223 is a DHCP flag. In accordance with one or more embodiments, the DHCP flag indicates whether the search appliance 180 is configured to use DHCP (e.g., value of “0×01”), or whether the search appliance 180 successfully leased an address from the DHCP server (e.g., value of “0×02”), for example. In accordance with such an embodiment, fields 210, 211, 212, 213, 221, 222 and 223 can be 1-byte, 3-bytes, 6-bytes, 6-bytes, 4-bytes, 4-bytes and 1-byte in length, respectively.

In response to receiving the network information from search appliance 180, a bootstrap client can send a command to the appliance to configure its IP settings. The SET message can be sent by the bootstrap client to the search appliance 180 to set its IP address and subnet mask, together with authentication information. FIG. 2F provides an example of such a SET message, for use with one or more embodiments of the present disclosure. Field 210 identifies a protocol version, field 211 identifies the message type, field 212 contains the MAC address of the bootstrap client, field 213 contains the MAC address of the responding search appliance 180, and field 215 contains authentication information (e.g., identifier, password and/or other authentication information) for use in authenticating the requester (e.g., the bootstrap client) to the search appliance 180. Fields 221 and 222 contain the network address information (e.g., IP address and subnet mask) for use by the search appliance 180 to configure its network settings. In accordance with such an embodiment, fields 210, 211, 212 and 213 can be 1-byte, 3-bytes, 6-bytes, and 6-bytes, respectively, in length. Field 215 can be a variable in length, e.g., from zero to two hundred and fifty-five bytes. Fields 221 and 222 can be 4-bytes in length.

Search appliance 180 can send a response to the SET message, such as an STR message, which indicates a status or outcome of the SET operation. For example, the outcome can indicate a success (e.g., return code has a non-zero value) or failure status (e.g., return code has a value of zero). The STR message can include further information to describe the status in more detail. For example, the STR message can describe failed operation outcome.

FIG. 2G provides an example of a message, e.g., an STR message, indicating a configuration operation (e.g., set and reset operations) outcome in accordance with one or more embodiments. Field 210 identifies a protocol version, field 211 identifies the message type, field 212 contains the MAC address of the bootstrap client, field 213 contains the MAC address of the responding search appliance 180, field 220 identifies a “status code” of the operation, and field 217 contains a message further describing the success or failure of the configuration operation. In accordance with such an embodiment, fields 210, 211, 212, 213 and 220 can be 1-byte, 3-bytes, 6-bytes, 6-bytes and 1-byte, respectively, in length. Field 217 can be a variable length field, e.g., from zero to two hundred and fifty-five bytes.

In accordance with one or more embodiments, an RES message can be used to reset the state of search appliance 180. The RES message requests that the search appliance 180 reset its state to a default configuration, e.g., a factory default configuration. FIG. 2H provides an example of a message, e.g., RES, to reset the search appliance 180 in accordance with one or more embodiments.

Field 210 of the RES message identifies a protocol version, field 211 identifies the message type, field 212 contains the MAC address of the bootstrap client and field 213 contains the MAC address of the responding search appliance 180. In accordance with such an embodiment, fields 210, 211, 212 and 213 can be 1-byte, 3-bytes, 6-bytes and 6-bytes, respectively, in length.

It is contemplated, in accordance with one or more embodiments of the present disclosure, that each instance of search appliance 180 continuously runs a UDP server and is configured in the factory to accept an IP address leased to it by a DHCP server running in its network. If a DHCP server does not exist in the network, in accordance with embodiments disclosed herein, TCP/IP configuration of search appliance 180 can be used through commands received by the UDP server executing in search appliance 180, using the UDP client/server model described above.

In accordance with one or more embodiments, the UDP client/server model described herein can be used to: (i) discover all search appliances 180 connected to the network, e.g., network 120, (ii) obtain the IP address and subnet mask of a specified search appliance 180 so discovered, and/or (iii) set the IP address and subnet mask of a specified search appliance 180 so discovered. Some example scenarios encountered by the end user, and the actions that can be taken, are categorized below.

In one such scenario, search appliance 180 boots in a network containing a DHCP server. In such a case, search appliance 180 obtains a valid IP address from the DHCP server, and network setup of the search appliance 180 can be completed without the UDP client/server model described herein. The following are among the alternatives available to the user in a case that the network contains a DHCP server. For example, the end user need not take any action. Alternatively, if so desired, the UDP client/server bootstrap client can be run on a network server to discover a search appliance 180 connected to the network. For example, to obtain the IP settings as provided by the DHCP server, or change the IP settings to another static IP address.

In another scenario, search appliance 180 boots in a network that does not contain a DHCP server. In such a case, search appliance 180 waits for its IP address and subnet mask to be set, e.g., using the SET command of the UDP client/server model from the UDP server. In such a case, the end user configures the appliance within the network by running the program code which implements the UDP bootstrap client on the network device, e.g., data server 190. The UDP bootstrap client communicates with instances of search appliance 180, as described above, to discover one or more instances of search appliance 180, and/or to issue the command to set its IP address and subnet mask, to configure search appliance 180 for network communications.

At any time after successful completion of network setup, the UDP bootstrap client can be run to discover one or more instances of search appliance 180. For example, the bootstrap client can be used to obtain an IP address and subnet mask of one or more instances of search appliance 180, reset an IP address and subnet mask of one or more instances of search appliance 180 to static values, or reset one or more instances of search appliance 180 to a factory configuration.

Referring again to FIG. 1, it should be apparent that while FIG. 1 shows only a few computers 150, 160, and 170 connected to network 120, it is anticipated that dozens or hundreds or even thousands of similarly configured computers 150, 160, and 170 can be “indexed” and searched using instances of search appliance 180. In one or more embodiments of the present disclosure, multiple computers 150, 160, and 170 can be configured to communicate with search appliance 180 and one or more data servers 190 and with each other via network 120.

Using search appliance 180, a user of a computer, such as one of computers 150, 160, and 170, can initiate a search request to locate and retrieve desired data files from data server 190, for example, with the search request being received and processed by search appliance 180. In response to receipt of such a request, search appliance 180 can, if appropriate, provide access to the requested data files to the requester. As discussed above, in accordance with one or more embodiments and using search appliance 180, a user of one of computers 150, 160, and 170 , for example, can request and retrieve information in this fashion from not only data server 190, but from any other computer or computer system coupled to network 120, indexed using search appliance 180. Using search appliance 180, it is possible to submit a search request, review the results of a search, and index volumes of data located on a local shared resource, at a remote location connected to network 120, and across an intranet and the Internet. In addition to some of the typical applications that embodiments of the present disclosure can be used, it is contemplated that the present disclosure can be used for other searching applications, including for example, electronic discovery and computer forensics.

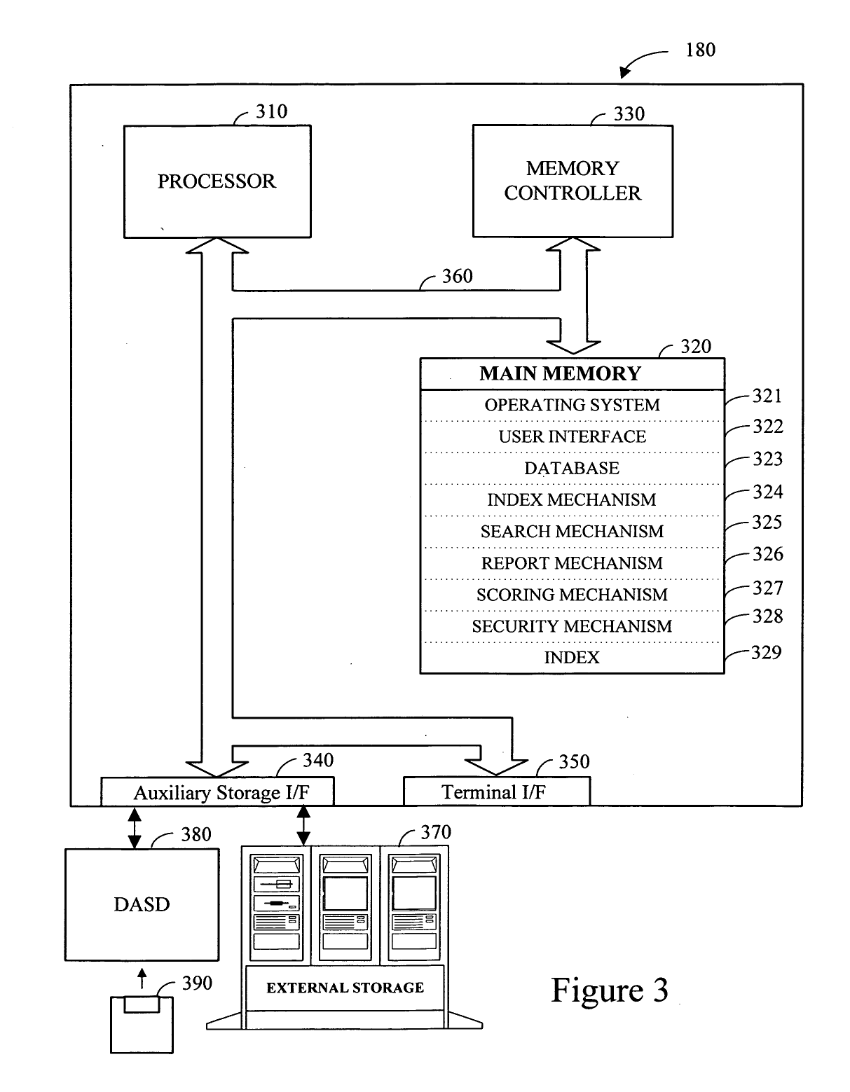

Referring now to FIG. 3, a block diagram is provide, which illustrates one example of an internal architecture of search appliance 180 in accordance with one or more embodiments of the disclosure. Search appliance 180 can also be configured with various additional software components (not shown) such as servers, firewalls, comprehensive security software, and the like. Given the relative advances in the state-of-the-art computer systems available today, it is anticipated that functions of search appliance 180 can be provided by many standard, readily available computing devices and systems configured in accordance with at least one embodiment presently disclosed.

Search appliance 180 suitably comprises at least one Central Processing Unit (CPU) or processor 310, a main memory 320, a memory controller 330, an auxiliary storage interface 340, and a terminal interface 350, all of which are interconnected via a system bus 360. It should be apparent that various modifications, additions, or deletions can be made to search appliance 180 illustrated in FIG. 3 within the scope of the present disclosure such as the addition of cache memory or the addition of other peripheral devices, for example. FIG. 3 is not intended to be an exhaustive example, but is presented for purposes of illustration.

Processor 310 performs computation and control functions of search appliance 180, and comprises a suitable central processing unit (CPU). Processor 310 can comprise a single integrated circuit, such as a microprocessor, or can comprise any suitable number of integrated circuit devices and/or circuit boards working in cooperation to accomplish the functions of a processor. Processor 310 suitably executes one or more software programs contained within main memory 320.

Auxiliary storage interface 340 allows search appliance 180 to store and retrieve information from auxiliary storage devices, such as external storage mechanism 370, magnetic disk drives (e.g., hard disks or floppy diskettes) or optical storage devices (e.g., CD-ROM). One example of such a storage device is a direct access storage device (DASD) 380. As shown in FIG. 3, DASD 380 can be a floppy disk drive that can read programs and data from a floppy disk 390.

While the present disclosure is described in the context of a fully functional computer system, those skilled in the art can appreciate that the various software mechanisms of the present disclosure are capable of being distributed in conjunction with signal bearing media as one or more program products in a variety of forms, and that embodiments of the present disclosure apply equally regardless of the particular type or location of signal bearing media used to actually carry out the distribution. Examples of signal bearing media include: recordable type media such as floppy disks (e.g., disk 390) and CD ROMS, and transmission type media such as digital and analog communication links, including wireless communication links.

Memory controller 330, through use of an auxiliary processor (not shown) separate from processor 310, is responsible for moving requested information from main memory 320 and/or through auxiliary storage interface 340 to processor 310. While for the purposes of explanation, memory controller 330 is shown as a separate entity; those skilled in the art understand that, in practice, portions of the function provided by memory controller 330 can reside in the circuitry associated with processor 310, main memory 320, and/or auxiliary storage interface 340.

Terminal interface 350 allows users, system administrators and computer programmers to communicate with search appliance 180, normally through separate workstations or through stand-alone computer systems such as computer systems 170 of FIG. 1. Although search appliance 180 depicted in FIG. 3 contains only a single main processor 310 and a single system bus 360, it should be understood that the present disclosure applies equally to computer systems having multiple processors and multiple system buses. Similarly, although the system bus 360 of one or more embodiments of the present disclosure is a typical hardwired, multi-drop bus, any connection means that supports bi-directional communication in a computer-related environment can be used.

Main memory 320 preferably contains an operating system 321, user interface 322, database management system 323, together with program code to implement functionality described in connection with embodiments of the present disclosure, such as index mechanism 324, search mechanism 325, report mechanism 326, scoring mechanism 327, and security mechanism 328. The term “memory” as used herein refers to any storage location in the virtual memory space of search appliance 180. It should be understood that main memory 320 need not necessarily contain all parts of all components shown. For example, portions of operating system 321 can be loaded into an instruction cache (not shown) for processor 310 to execute, while other files can be stored on magnetic or optical disk storage devices (not shown). In addition, although user interface 322, database 323, index mechanism 224, search mechanism 325, report mechanism 326, scoring mechanism 327, and security mechanism 328 are shown to reside in the same memory location as operating system 321, it is to be understood that main memory 320 can consist of multiple disparate memory locations.

Database management system 323 can be a relational database management system, which can use or implement a data model, or schema, definitions, and data stored according to the data model, such as is described in connection with one or more embodiments disclosed herein. The data stored using database management system 323 can change from query to query, depending on updated made to the stored data using database management system 323. It should also be noted that, in accordance with one or more embodiments,, any and all of the individual components shown in main memory 320 can be combined in various forms and distributed as a stand-alone program product. Finally, it should be noted that search appliance 180 can include additional components, not shown.

For example, while not required, embodiments of the present disclosure include a security mechanism 328 for verifying and validating user access to the data files located by search appliance 180. Security mechanism 328 can be incorporated into operating system 321 in accordance with one or more disclosed embodiments. In accordance with one or more embodiments, depending on the type and quantity of information stored in database 323, security mechanism 328 can be configured to provide different levels of security and/or encryption for computers 150, 160, and 170 and data server 190 of FIG. 1.

Additionally, the level and type of security measures applied by security mechanism 328 can be determined by the nature of a given search request and/or response to the search request, including the identity of the requestor. In some embodiments of the present disclosure, security mechanism 328 can be contained in, or implemented in conjunction with, hardware components such as hardware-based firewalls, routers, switches, dongles, and the like.

In accordance with at least one embodiment, operating system 321 includes software used to operate and/or control search appliance 180. In general, processor 310 typically executes operating system 321. Operating system 321 can be a single program or, alternatively, a collection of multiple programs that act in concert to perform the functions of an operating system. Any operating system now known to those skilled in the art, or later developed/identified, can be used with one or more embodiments of the present disclosure.

Although user interface 322 can take another form, it can comprise web pages, which can be displayed, using a browsing software application such as one identified herein, on a monitor coupled to search appliance 180, and/or displayed on a monitor coupled to computer connected to search appliance 180 via network 120, such as computer systems 150, 160 and 170. User interface 322 can be used to configure the various components shown in memory 320, including index mechanism 324, search mechanism 325, report mechanism 326, scoring mechanism 327, and security mechanism 328.

Database management system 323 is representative of any suitable database now known to those skilled in the art, and or later developed/identified. In one or more embodiments of the disclosure, database management system 323 is a relational database, and database management system 323 uses a Structured Query Language (SQL) to manipulate (e.g., create, update, query, etc.) data stored in the database. While database management system 323 is shown residing in main memory 320, it should be apparent that database management system 323 can also be physically stored in a location other than main memory 320. For example, database management system 323 can be stored on external storage device 370 or DASD 380 and coupled to search appliance 180 via auxiliary storage I/F 340. In one or more embodiments of the present disclosure, database 323 can contain keywords for the content contained or accessible via a corporate intranet or the Internet. In accordance with one or more embodiments, database management system 323 can consist of multiple disparate databases stored on many different computers or computer systems.

Although not shown in FIG. 2, in accordance with at least one embodiment, search appliance 180 includes a network interface for connecting to network 120, together with the network protocols needed to communicate via network 120. For example, in one or more embodiments of the disclosure, search appliance 180 includes the suite of protocols typically referred to as the Transmission Control Protocol/Internet Protocol, or TCP/IP.

Index mechanism 324 is a configurable indexing tool for categorizing various types of information and creating an index to be used in conjunction with searching and retrieving information over network 120, such as from data server 190. Index mechanism 324 can be configured manually with various levels of user intervention or programmatically, depending on the specific type of data to be indexed. Index mechanism can perform an initial index and can be configured to re-index the data files contained in database 323 at user-specified intervals, which index can be used to facilitate searching contents of database 323.

Search mechanism 325 can include a web-based software application accessible via a graphical user interface, such as user interface 322, to request and retrieve information from database 323. In one or more embodiments of the present disclosure, search mechanism 325 can include a Natural Language Processor (NLP) based search engine which, in conjunction with the other components of search appliance 180, such as indexing mechanism 324, index 329, scoring mechanism 327 and report mechanism 326, for example, can be used as a robust search tool for locating and retrieving desired content.

In general, a user of computers 150, 160, and 170 of FIG. 1 can access search mechanism 325 via a standard web browser such as Safari, FireFox, Netscape, Internet Explorer, etc. In accordance with one or more embodiments, a user can request information using search mechanism 325, which can serve as an interface to the information stored in database 323. It is anticipated that various reports related to the information contained in database 323 can be generated by report mechanism 326, which can include a browser-based user interface for displaying search results.

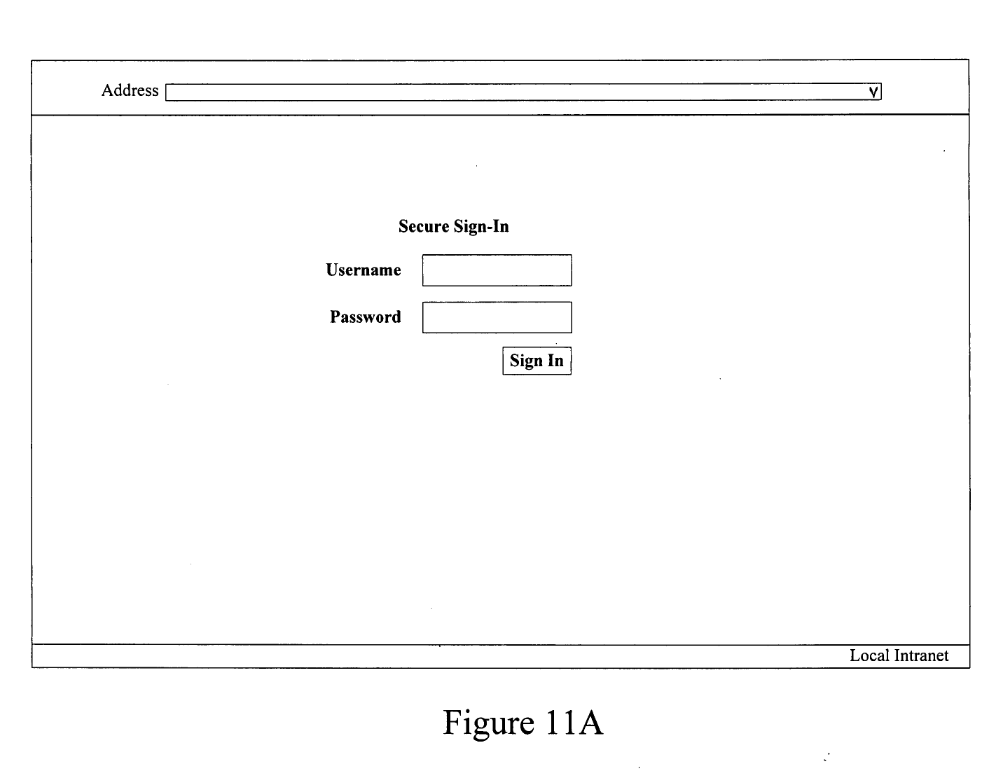

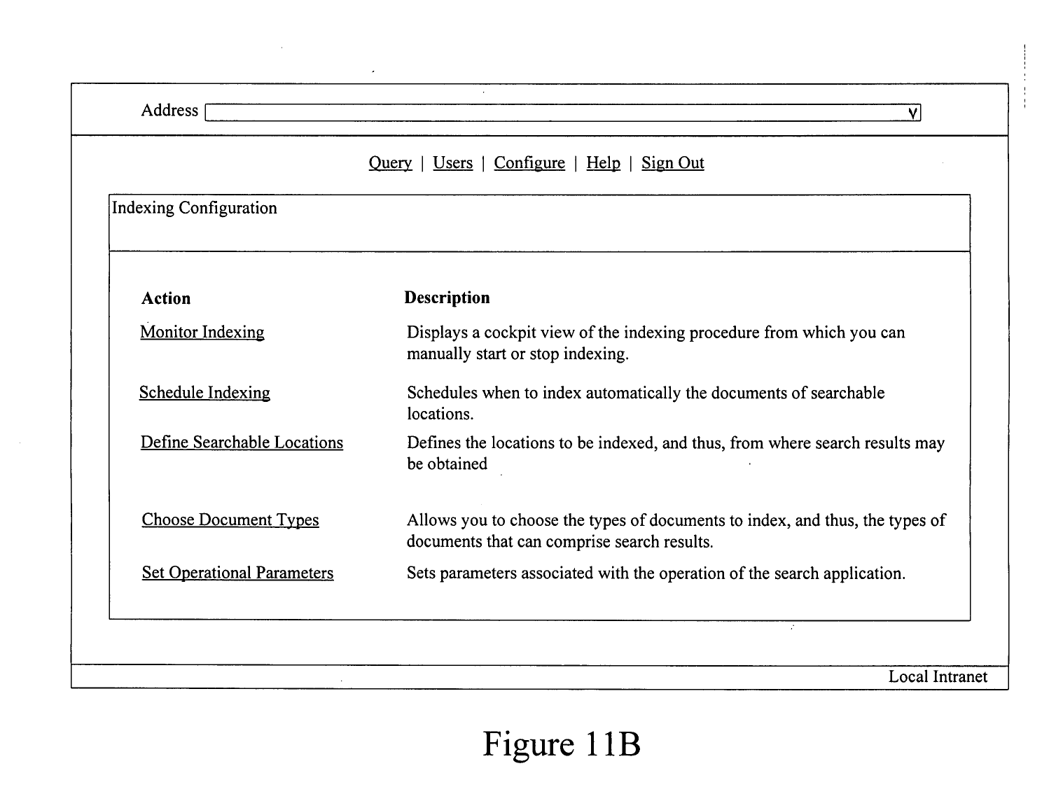

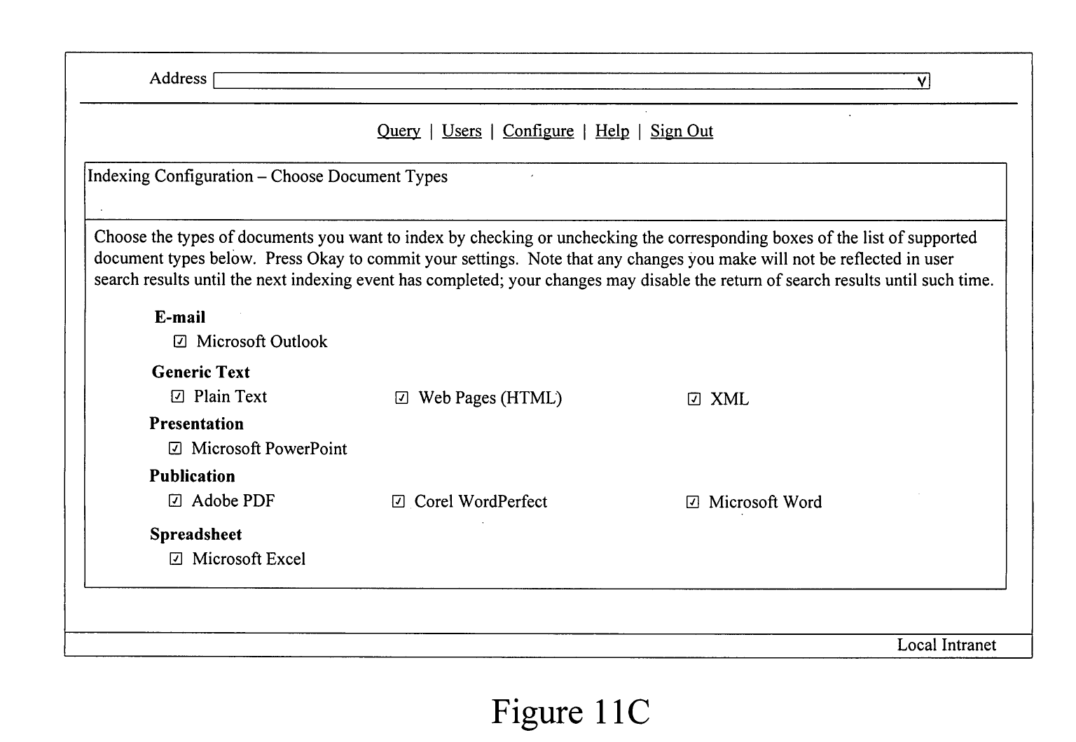

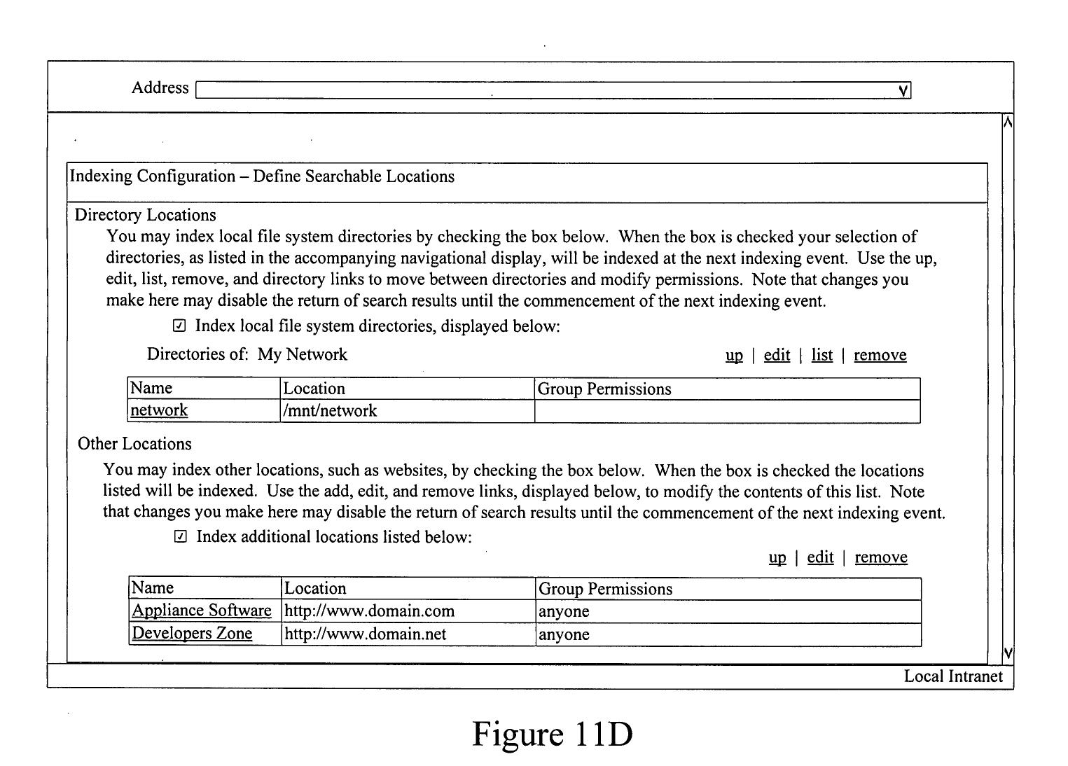

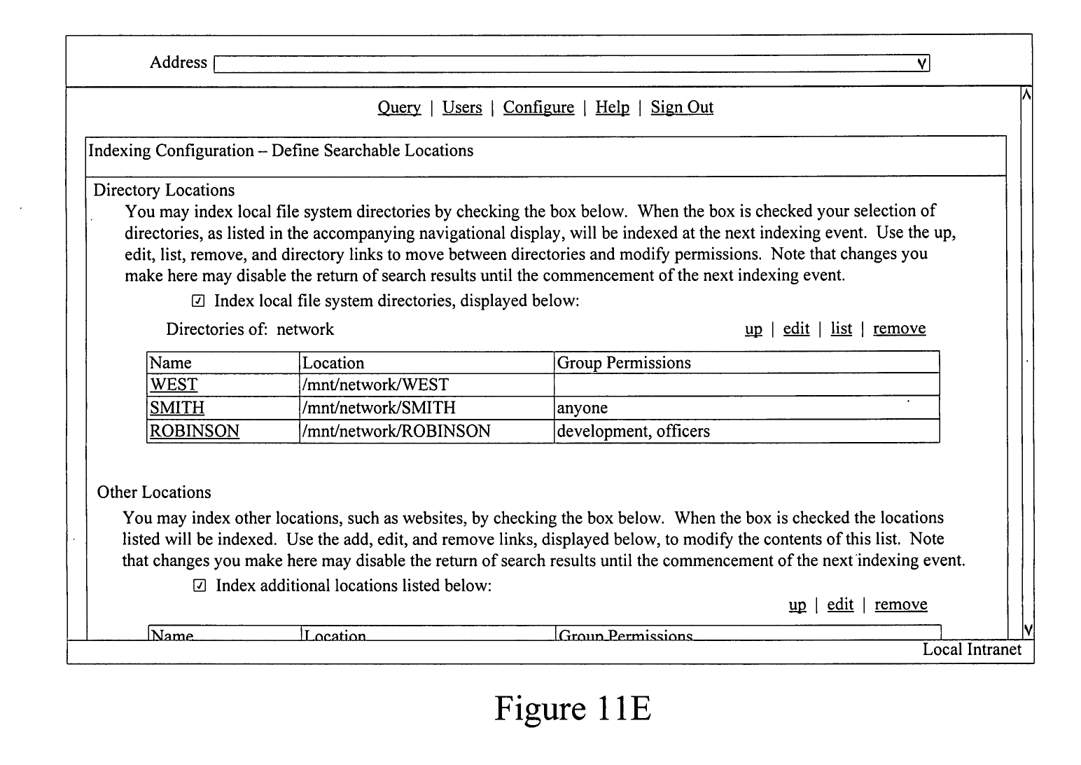

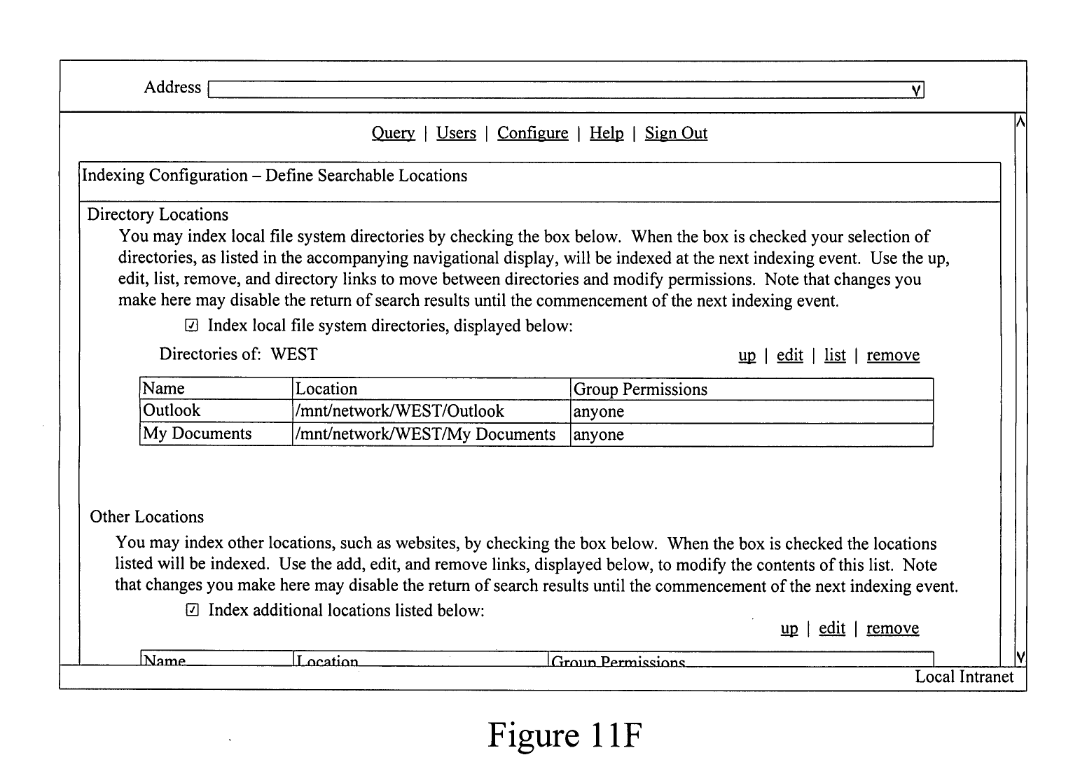

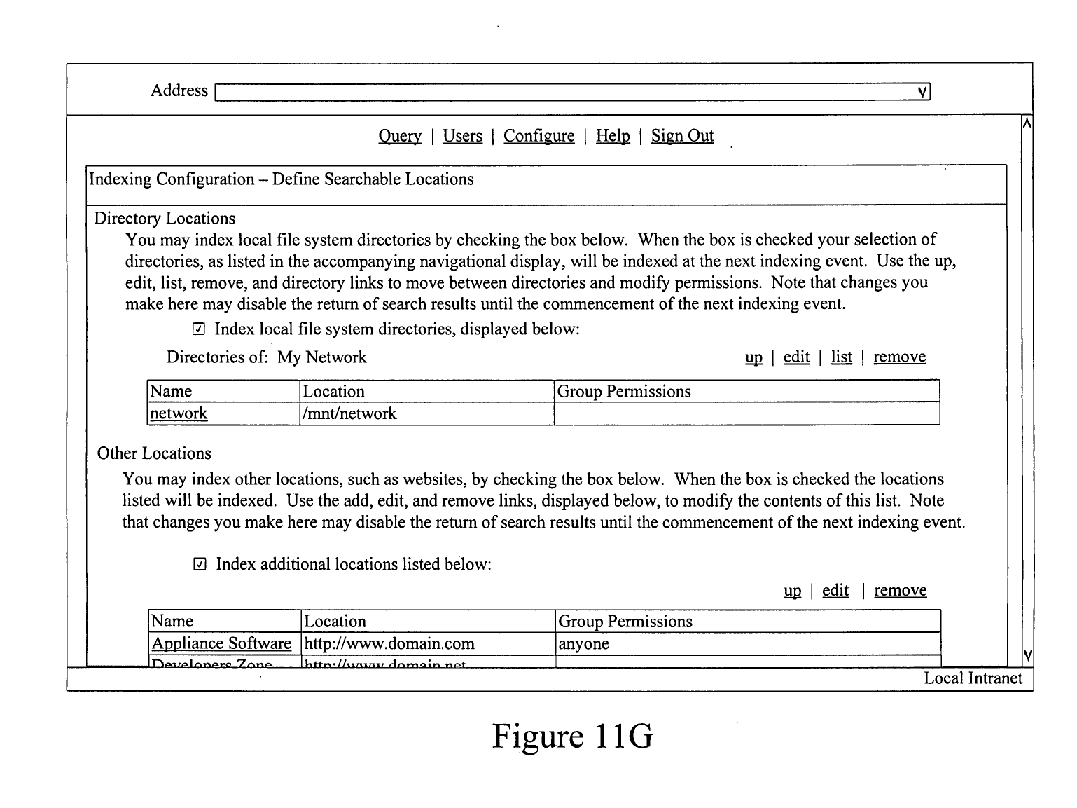

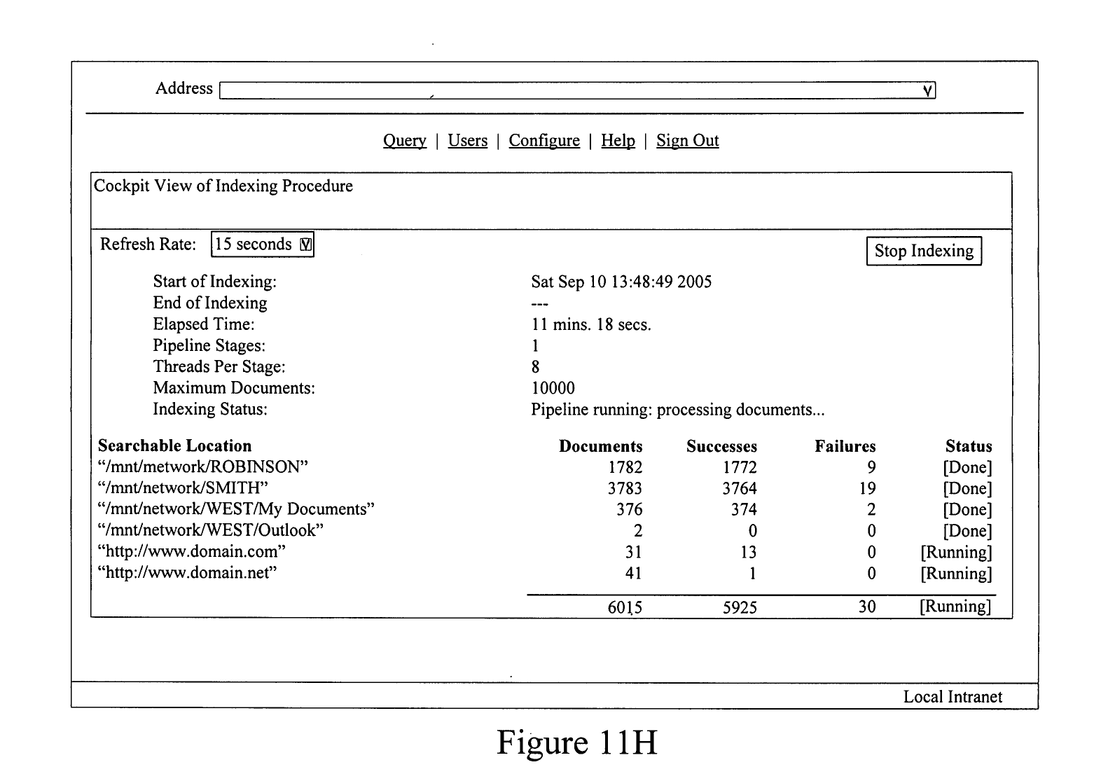

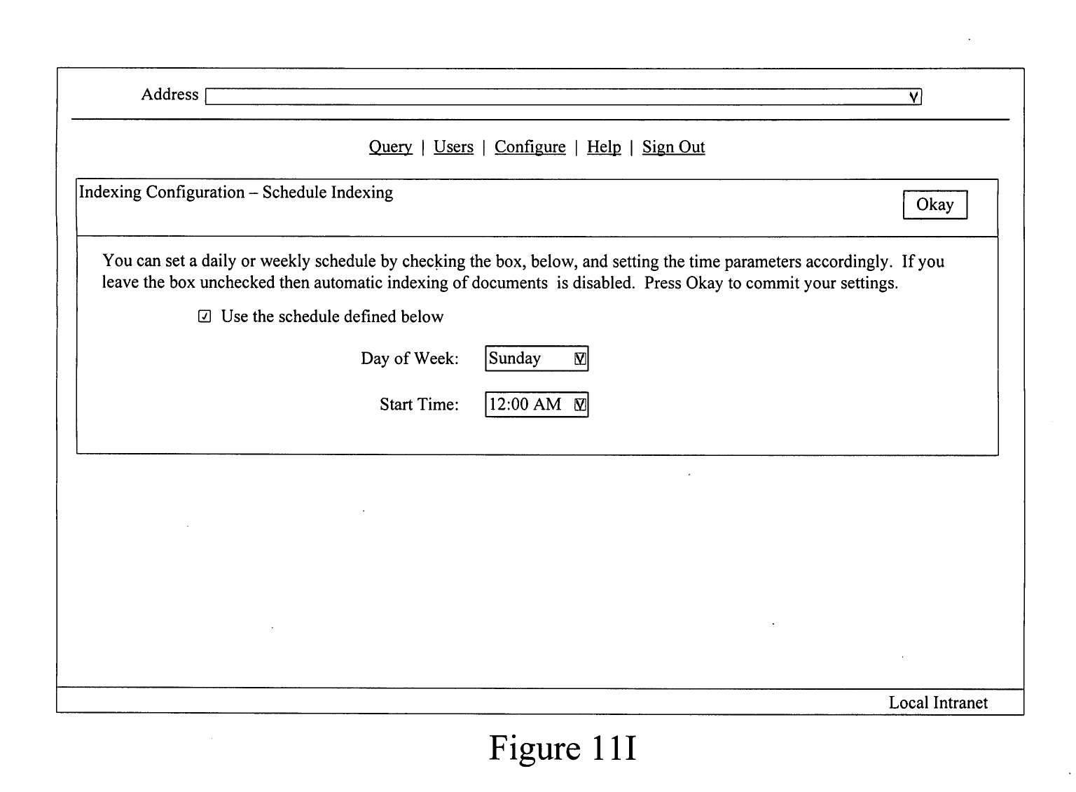

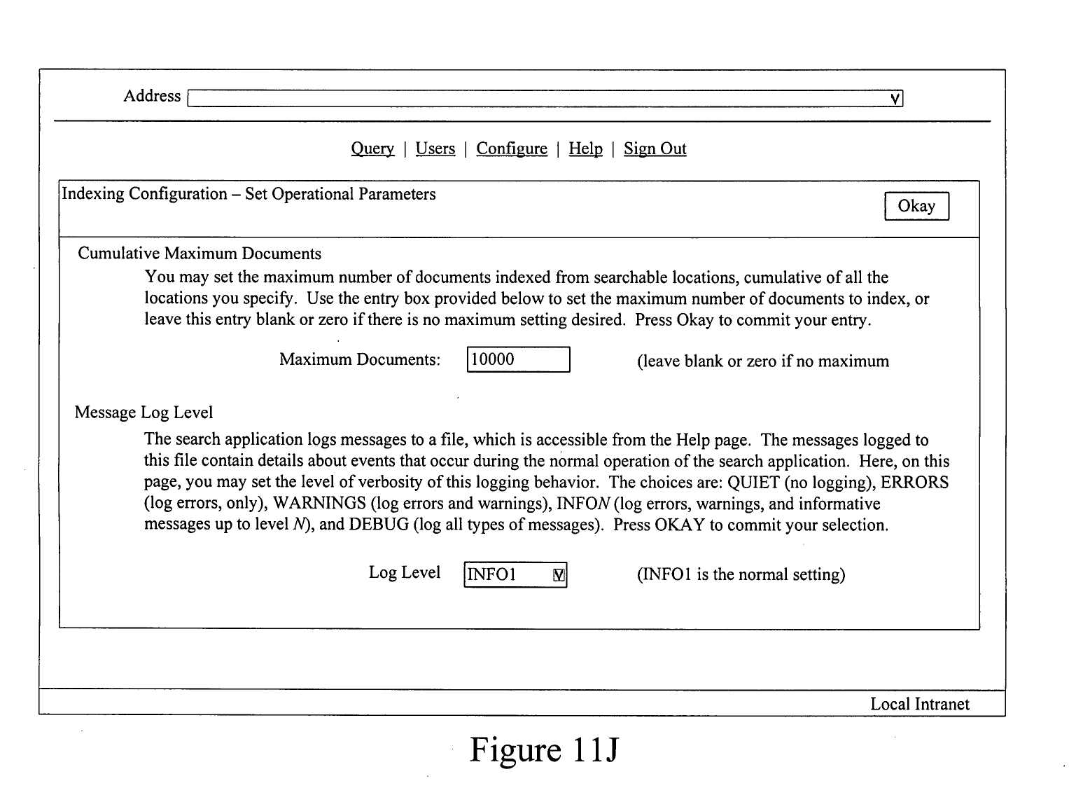

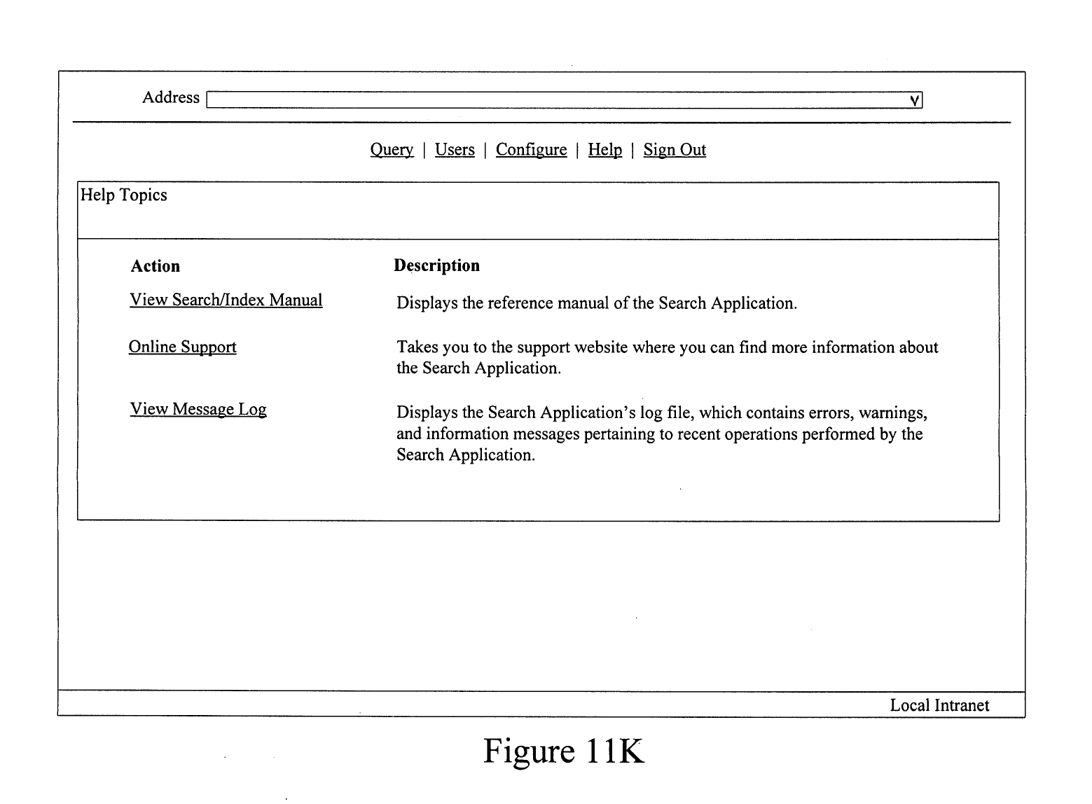

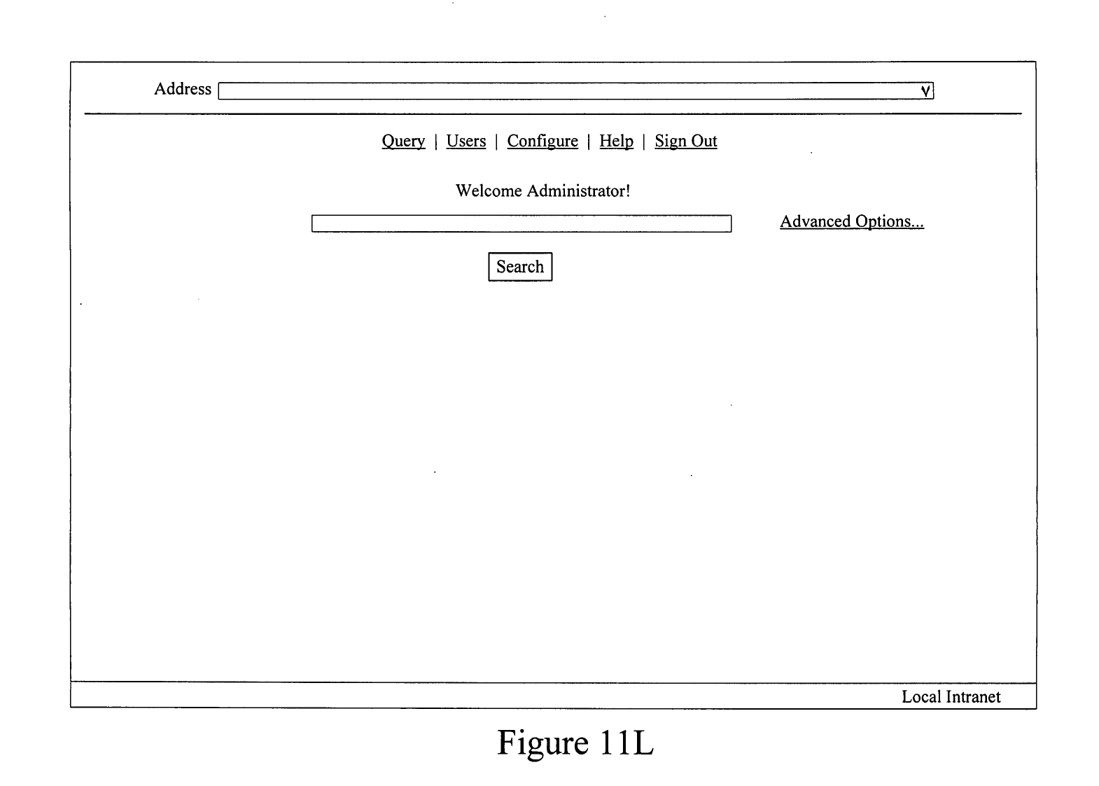

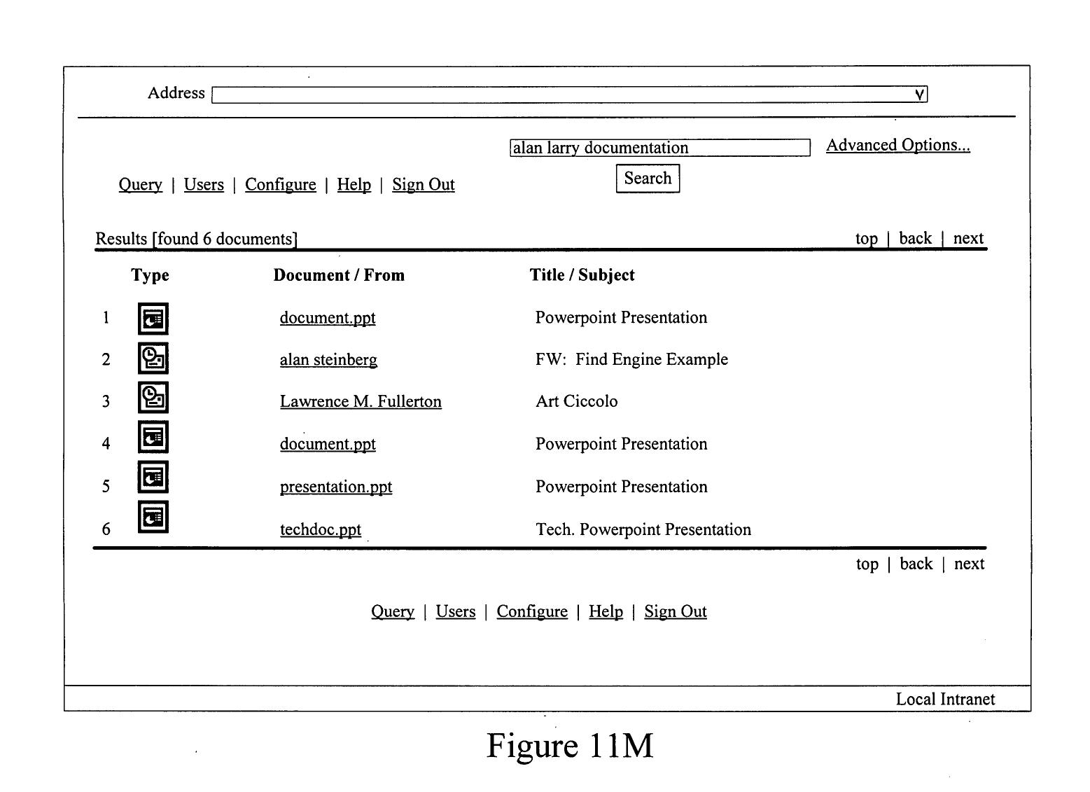

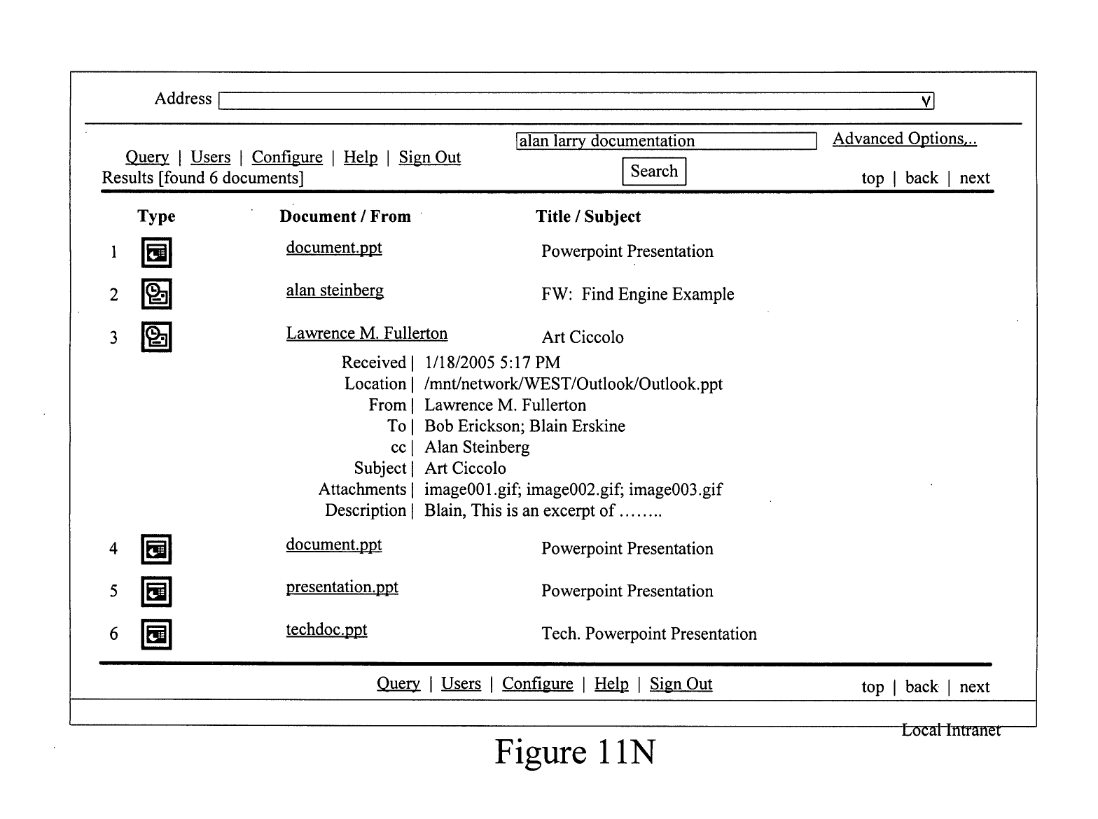

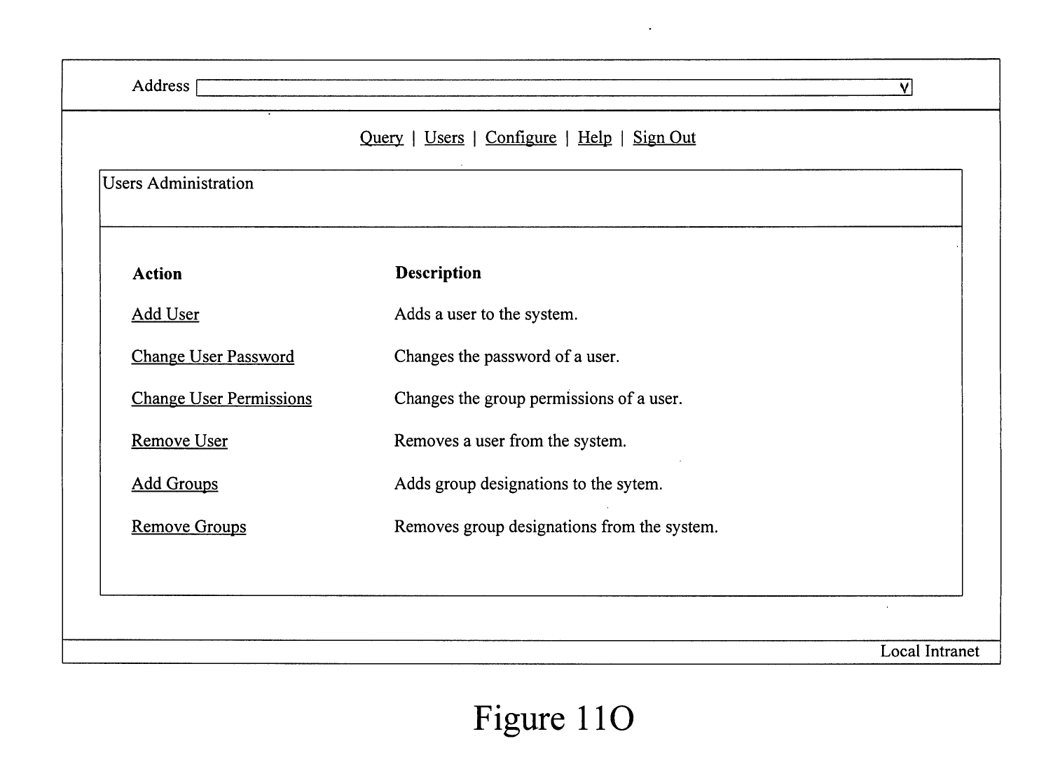

Report mechanism 326 can provide output, either via a hard copy or display on a monitor, a variety of reports, including reports of the results from accessing database 323 via search mechanism 325. These reports can include the results of the various searches performed by a computer user, such as computer system 170 of FIG. 1. These various reports can be formatted and presented to the user based on the specific type of request made by the user and the type of information to be returned to the user. FIG. 11 discussed below provides examples of output that can be provided in accordance with one or more embodiments presently disclosed.

In accordance with embodiments of the present disclosure, scoring mechanism 327 can be configured to score and rank the results obtained by search mechanism 325 in response to a user's search request, or query. An number of scoring methodologies can be employed by scoring mechanism 327 to score search results so that the results can be ranked in a way most likely to present relevant results first. In one or more embodiments of the present disclosure, scoring mechanism 327 can be user configurable, allowing the user to determine which features and scoring factors (weighting methods) to apply when search results are returned in response to given search query.

In one embodiment of the disclosure, scoring mechanism 327 comprises a scoring mechanism to score documents returned from a search query based on a total number, or frequency, of occurrences of the N unique stem words contained in the original search query. In a case where Mdocument results are returned, equation (1) set forth below provides an example of an equation used to determine a score for the m^{th} result:

$${S}_{N}^{( m )} = {\sum }_{i = 1}^{N} {x}_{i}^{( m )} , \qquad ( 1 )$$

where Xᵢ^{(m)} is the frequency of occurrence of the i^{th} stem word within the m^{th} document. Under some circumstances, this “frequency weighting” formula may not provide any special consideration for occurrences of more than one stem word in a document. Using this scoring scheme, the sum of the frequencies of all the stem words is measured.

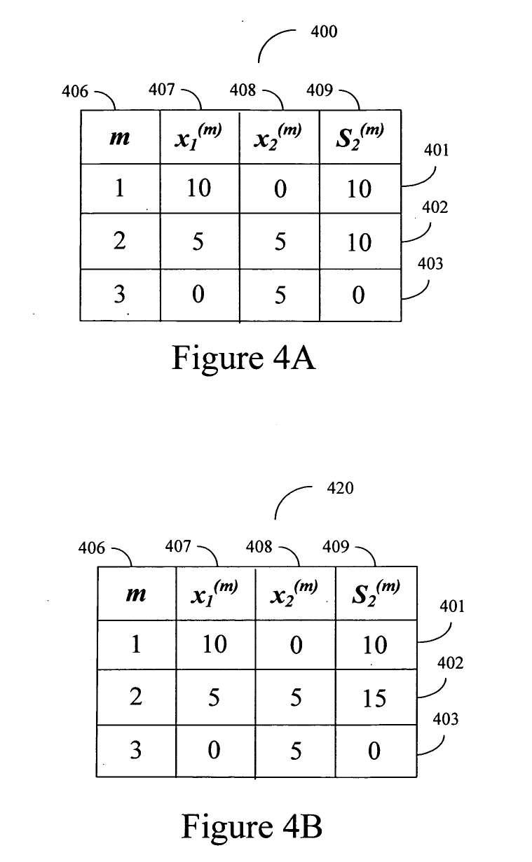

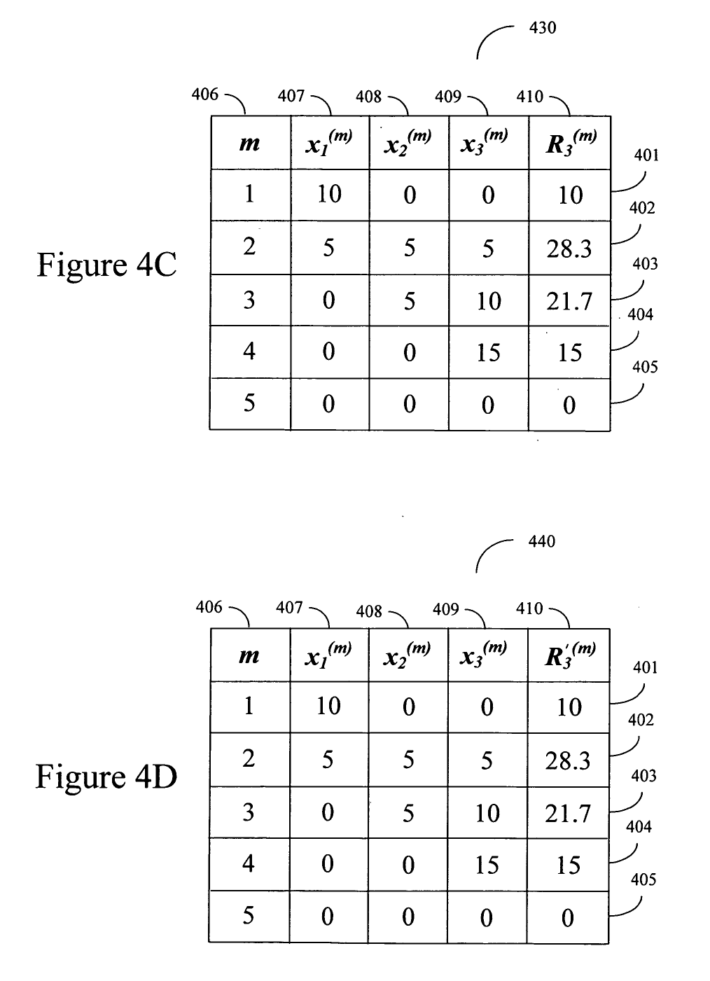

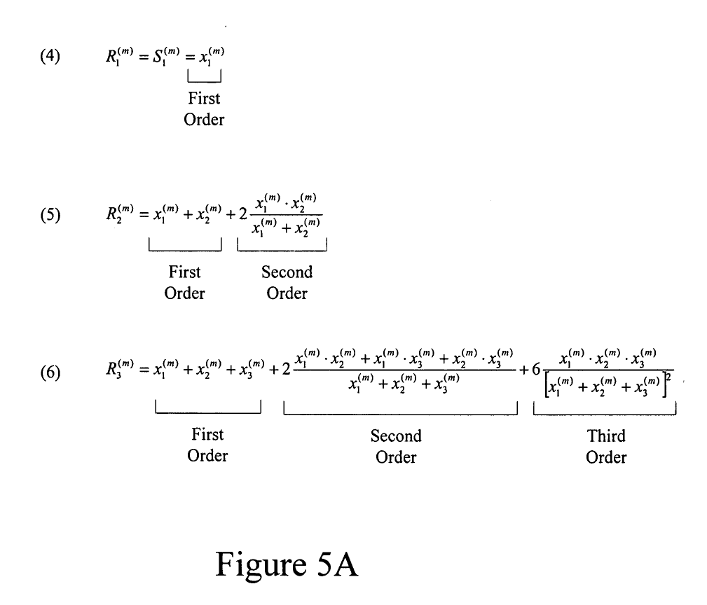

FIG. 4, which comprises FIGS. 4A to 4D, provides examples of scoring for use in accordance with one or more embodiments of the disclosure. Table 400 of FIG. 4A includes column 406 which identifies three documents, each of which has corresponding frequency counts for first and second search terms shown in columns 407 and 408, and a score for each of the three documents shown in column 409 and rows 401 to 403.

Referring to FIG. 4A, a scoring example is provided for a search query involving two unique stem words, in which two results are returned with the same score. Column 404 identifies a given document, i.e., m equals 1, 2 or 3, each one of rows 401 to 403 corresponds to a given stem word. Column 405 identifies the frequency of occurrence of the first stem word in the m^{th} document. Similarly, column 406 identifies the frequency of occurrence of the second stem word in the m^{th} document. Column 407 provides a ranking for each document based on the frequencies of occurrence associated with each stem word, which ranking can be calculated using equation (1) above.

As seen in FIG. 4A, row 401 corresponding to the first result contains 10 occurrences of the first stem word while row 402, which corresponds to the second result, contains 5 occurrences of each of the two stem words. If the measure of relevancy is the sum of the number of occurrences across all of the stem words, both documents would be scored the same and would have the same relevance in the search result. However, in accordance with at least one embodiment, it might be desirable to consider the second result to be more relevant than the first result, since the second result contains both stem words identified in the original search query. In accordance with such an embodiment, scoring mechanism 327 takes into account the simultaneous occurrences of stem words in the same document, which document might be considered to be more relevant than another document which contains fewer stem words.

In accordance with embodiments of the present disclosure, scoring mechanism 327 determine a score for a search result taking into account occurrences of multiple keywords, or stem words, in a single document. In accordance with such embodiments, scoring mechanism 327 determines a score for a result using a product of frequencies, e.g., xᵢ^{(m)}, in order to quantify correlation, for example. In other words, by introducing products of frequencies xᵢ^{(m)} in accordance with one or more embodiments, it is possible to account for the correlation between multiple stem words appearing in the same document. This approach is referred to herein as “enhanced frequency weighting.”

In at least one embodiment, in enhanced frequency weighting, equation (1) is expanded using combinatorial analysis, and introduces combinations of the products of frequencies, in ever higher-order products, to an order equal to the number of stem words in a given multi-keyword search query. Additionally, in order to maintain scale, each product created in this fashion can be scaled to the size of the original term, and thus, to each term that precedes it in the expansion. This can be accomplished by dividing each product by the appropriate multiplicative power of the original scoring formula, e.g., S_{N}^{(m)} of equation (1) above. The result is the original scoring formula corrected by higher-order correlations between stem words within the document. An example of such a formula which can be used for a query involving N unique stem words is as shown below:

$${R}_{N}^{( m )} = {S}_{N}^{( m )} \cdot {\sum }_{n = 1}^{N} \{ \frac{1}{{[ {S}_{N}^{( m )} ]}^{n}} \cdot {\sum }_{{a}_{1} \neq {a}_{2} \neq ⋯ \neq {a}_{n}}^{N} {x}_{{a}_{1}}^{( m )} \cdot {x}_{{a}_{2}}^{( m )} ⋯ {x}_{{a}_{n}}^{( m )} \} , \qquad ( 2 )$$

with the original scoring formula denoted, as before, by equation (1).

The equation (2) above can also be written in the following form:

$${R}_{N}^{( m )} = {S}_{N}^{( m )} \cdot {\sum }_{n = 1}^{N} \{ \frac{n !}{{[ {S}_{N}^{( m )} ]}^{n}} \cdot {\sum }_{{a}_{1} < {a}_{2} < ⋯ < {a}_{n}}^{N} {x}_{{a}_{1}}^{( m )} \cdot {x}_{{a}_{2}}^{( m )} ⋯ {x}_{{a}_{n}}^{( m )} \} , \qquad ( 3 )$$

Examples using the formula represented by equations (2) and (3) are presented which demonstrate an effect on a relevancy scoring for different numbers of keywords in a given search query. When N=1, for example, the scoring formula produces the results set forth FIG. 4A, since the relevancy determination is the frequency, or number, of occurrences of the stem word in each file. In other words,
R₁^{(m)}=S₁^{(m)}=x₁^{(m)}. (4)

However, when N=2, corresponding to a two-keyword search, the scoring formula becomes:

$${R}_{2}^{( m )} = {x}_{1}^{( m )} + {x}_{2}^{( m )} + 2 \frac{{x}_{1}^{( m )} \cdot {x}_{2}^{( m )}}{{x}_{1}^{( m )} + {x}_{2}^{( m )}} . \qquad ( 5 )$$

FIG. 4B provides an example of an outcome using equation (5) in accordance with at least one embodiment of the disclosure. Table 420 of FIG. 4B provides column 406 which identifies three documents, each of which has corresponding frequency counts for first and second search terms shown in columns 407 and 408, and a score for each of the three documents shown in column 409 and rows 401 to 403. As seen in table 420 of FIG. 4B, the result corresponding to m=2, i.e., row 402, is scored with higher relevancy than the result shown in row 402 of Table 400 of FIG. 4A. This is due to a correction term added to the original scoring algorithm, which accounts for the fact that the m=2 document contains both stem words in the search query. To illustrate further, the following provides an example having three N=3, the results of which are depicted FIG. 4C. In accordance with at least one embodiment, in a case of N=3, the scoring formula becomes:

$${R}_{3}^{( m )} = {x}_{1}^{( m )} + {x}_{2}^{( m )} + {x}_{3}^{( m )} + 2 \frac{{x}_{1}^{( m )} \cdot {x}_{2}^{( m )} + {x}_{1}^{( m )} \cdot {x}_{3}^{( m )} + {x}_{2}^{( m )} \cdot {x}_{3}^{( m )}}{{x}_{1}^{( m )} + {x}_{2}^{( m )} + {x}_{3}^{( m )}} + 6 \frac{{x}_{1}^{( m )} \cdot {x}_{2}^{( m )} \cdot {x}_{3}^{( m )}}{{[ {x}_{1}^{( m )} + {x}_{2}^{( m )} + {x}_{3}^{( m )} ]}^{2}} . \qquad ( 6 )$$

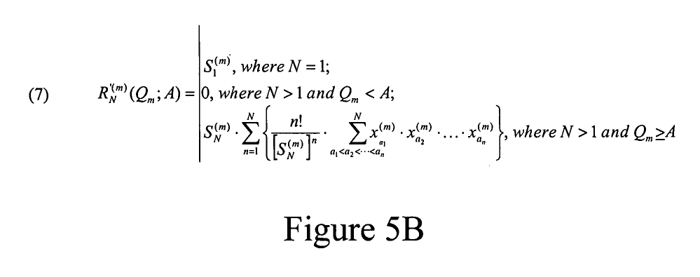

FIG. 5, which comprises FIGS. 5A and 5B, provides an example of scoring in exemplary cases in accordance with one or more embodiments of the present disclosure. Reference is now made to FIG. 5A, which provides an example of scoring involving one, two and three terms in accordance with at least one embodiment. As discussed above, equation (4) can be used to score results in a case that the search query comprises a single search, or stem, word. Equation (5) illustrates a scoring technique in a case that a search query contains two terms. Equation (5) includes a first order, or portion, which sums the frequency of occurrences of the first and second terms independent of a simultaneous occurrence of the stem words in a document, and the second order portions adjusts for the simultaneous occurrence of the terms in a document. In a case that three terms are used in a search, a third order can be used to adjust for the simultaneous occurrence of all three terms in a document, as shown in equation (6) of FIG. 5. In equation (6), the first order portion corresponds to a summation of the frequencies of occurrence of each of the three terms in document independent of a simultaneous occurrence of two or more of the stem words, the second term of this formula corrects for the simultaneous occurrences of pairs of the three words within the document, and the third term corrects for the simultaneous occurrence of all three words in the document.

Referring to table 430 of FIG. 4C, column 406 identifies five documents, which have corresponding frequency counts for first, second and third search terms shown in columns 407 to 409, respectively, and a score for each of the five documents shown in column 410 and rows 401 to 405. As shown in table 430, using equation (6), the document containing all three stem words, corresponding to m=2 shown in row 402, is ranked higher than other documents that have the same aggregate frequency of occurrence calculated using equation (1) (e.g., documents corresponding to rows 403 and 404). The document corresponding to m=3, row 403, contains two of the three stem words and is ranked second.

Those skilled in the art should recognize that a document containing only one stem word might not always be scored or ranked lower than a document containing multiple stem words. For example, if the document corresponding to m=4, row 404, had a third-word count of 30 instead of 15 it would be deemed more relevant than the document of m=2. Nevertheless, in a case that total frequency counts for keywords are comparable, or to some degree comparable, the scoring formula of the present disclosure produces increased relevancy when multiple keywords from a search query are found in a given document.

Using equation (6) and if the document corresponding to m=4 in table 430 had a third-word count of 30 instead of 15 it would out rank the document of m=2 shown in row 402 of table 430. Thus, while equation (6) accounts for multiple keywords appearing in the same document, under certain circumstances, it might overemphasize the relevance of lesser matches that happen to have large total counts of occurrences.

To address the above, in accordance with one or more embodiments, the scoring formula of equation (6) can be modified for those cases where N>1. More particularly, it is possible to introduce an adjustable cutoff number A≦N, where A represents a minimum threshold number of unique stem words. The score corresponding to a document is set to zero if the number of unique stem words appearing in a document is less than A. In accordance with such embodiments, the threshold number can be used to address a case in which a result has high aggregate frequency of occurrence across the N stem words, but has little correlation between the stem words. In such a case, the threshold can be used to determine whether or not to eliminate a result from the search results returned to a user. In accordance with such embodiments, with Qₘ equal to the number of distinct stem words appearing in the m^{th} document, the scoring formula of equation (6) can be modified as shown in equation (7) shown in FIG. 5B.

As an example, consider again the N=3 case shown in table 430 of FIG. 4C. Table 430 of FIG. 4D provides column 406 which identifies the five documents shown in table 430 of FIG. 4C. Each of the documents have corresponding frequency counts for first, second and third search terms shown in columns 407 to 409, respectively, and a score for each of the five documents shown in column 410 and rows 401 to 405. With A chosen such that A=2, the computed scores are depicted in table 440 of FIG. 4D. The formula of equation (6) applies for which Qₘ=2 and Qₘ=3. Other results are depicted in table 430 have scores of zero, based on equation (7).

In accordance with embodiments using a threshold to determine a scoring, e.g., using equation (7), it is possible to identify relevance of documents based on simultaneous occurrence of multiple stem words of a search query. In accordance with one or more embodiments of the present disclosure, other criteria can be used alone or in combination with the scoring techniques discussed above.

In one or more embodiments of the present disclosure, the user can select any or all of the various features of scoring mechanism 327 including without limitation standard frequency weighting and/or enhanced frequency weighting.

Referring again to FIG. 3. in one or more embodiments of the disclosure of the present disclosure, search appliance 180 can include a security mechanism 328. Security mechanism 328 is configured to provide a security model for providing enhanced search results, based on the identity and role of the searcher. In one or more embodiments of the present disclosure, security mechanism 328 employs a log-in model where each user must have a user ID and a password to authenticate their identity on the network and to access search mechanism 325. Security mechanism 328 is described in more detail below.

Index 329 represents the index that is constructed by index mechanism 324, based on the content stored in shares accessible via network 120. Index 329 is used by search mechanism 325 to locate content relevant to a given search query presented by a user of a computer, such as one of computers 150, 160, and 170. Index 329 can be periodically rebuilt at a configurable interval in order to accurately reflect any changes made to the content in shares accessible via network 120.

Although index 329 is shown separately from database management system 323, it should be appreciated that index 329 can be created and maintained using database management system 323. A discussion of one example of a data model used for indexing and searching is provided below.

Those skilled in the art should recognize that although index mechanism 324, search mechanism 325, report mechanism 326, scoring mechanism 327, and security mechanism 328 are shown as separate entities in FIG. 3, index mechanism 324, search mechanism 325, report mechanism 326, scoring mechanism 327, and security mechanism 328 can be combined into a single software program or application or program product.

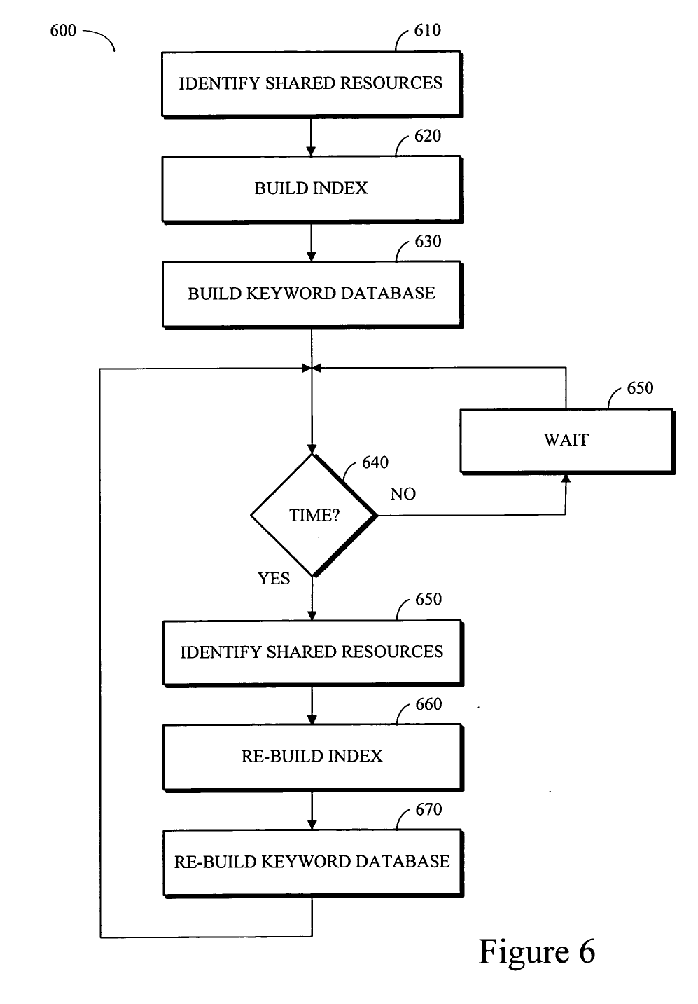

Referring now to FIG. 6, a process 600 of maintaining and updating an index for the data files used in conjunction with a search appliance in accordance with one or more embodiments of the present disclosure is depicted. As shown in FIG. 6, indexing of the data files can be performed on shared resources determined to be available via network 120 at step 610.

As part of step 610, network 120 is searched to identify shared, or sharable, resources, or shares. More particularly, search appliance 180 searches, also referred to herein as crawling or web crawling, the network for sharable resources, or shares, and maintains/updates a repository of information, using database management system 323, associated with each share to facilitate indexing and/or search. Search appliance 180 is capable of performing network searches, including all files stored on a server or network of servers determined to be shared, not mere HTTP (index.htm) searches. For example, a sharable resource can be a hard disk drive, or other storage media, fixed or removable, or one or more folders, files, documents, pages etc. stored thereon, with “sharable” access rights. In addition, sharable resources can include web pages typically displayed via web browser.

The initial index can be built using database management system 323 index mechanism 324 (step 620). Indexing can be accomplished by any means now known to those skilled in the art, or later developed/identified. In accordance with one or more embodiments, as part of the indexing methodology, the creation date and/or last modified date for each data file is captured and stored. In conjunction with the construction of an index, a keyword database is constructed (step 630) using the key words or terms contained in the data files stored on data server 190. In accordance with at least one embodiment, the keyword database can be accessed by search mechanism 325 to identify search result items in response to submission of a search query submitted by a user, for example. A database model used in accordance with one or more embodiments to store indexing and shared resource information is discussed in more detail below.

In accordance with one or more embodiments, an index and/or a keyword database can be re-built to identify changes in sharable resources, e.g., resources for which the sharable characteristics have changed, and/or to identify changes in content to be reflected in the index. In one or more embodiments, a period of time can be used to determine when to re-build one or more of the index and keyword database. In accordance with such embodiments, if it is determined at step 640 that the time period has not elapsed (step 640=“NO”), process 600 can continue at steps 640 and 650 to in order to wait for such a time. If it is determined at step 640 that the period of time has elapsed (step 640=“YES”), a search can be conducted, at step 650, via network 120 to locate sharable resources to re-build an index and a keyword database at steps 660 and 670, respectively.

In accordance with one or more embodiments, when re-building an index, a previously captured creation date and/or last modified date can be examined and compared with a modification date associated with each file that is to be indexed. If there has been no change in the relevant date, then the file need not be re-indexed and the key words associated with that file need not be modified in the keyword database. However, if an existing file has been modified, as determined by examining the previously captured date with the new file modification date, for example, the new modification date can be captured and the document can be re-indexed and the keywords associated with that document can be updated in the keyword database.

Additionally, if a new file has been added, e.g., to data server 190, then it can be added to the index and the appropriate keywords can be added to the keyword database. However, if a given file no longer exists, e.g., on data server 190, then all references to that file in the index and all keywords associated with that file stored in the keyword database can be removed. In this fashion, the keyword database can be re-built.

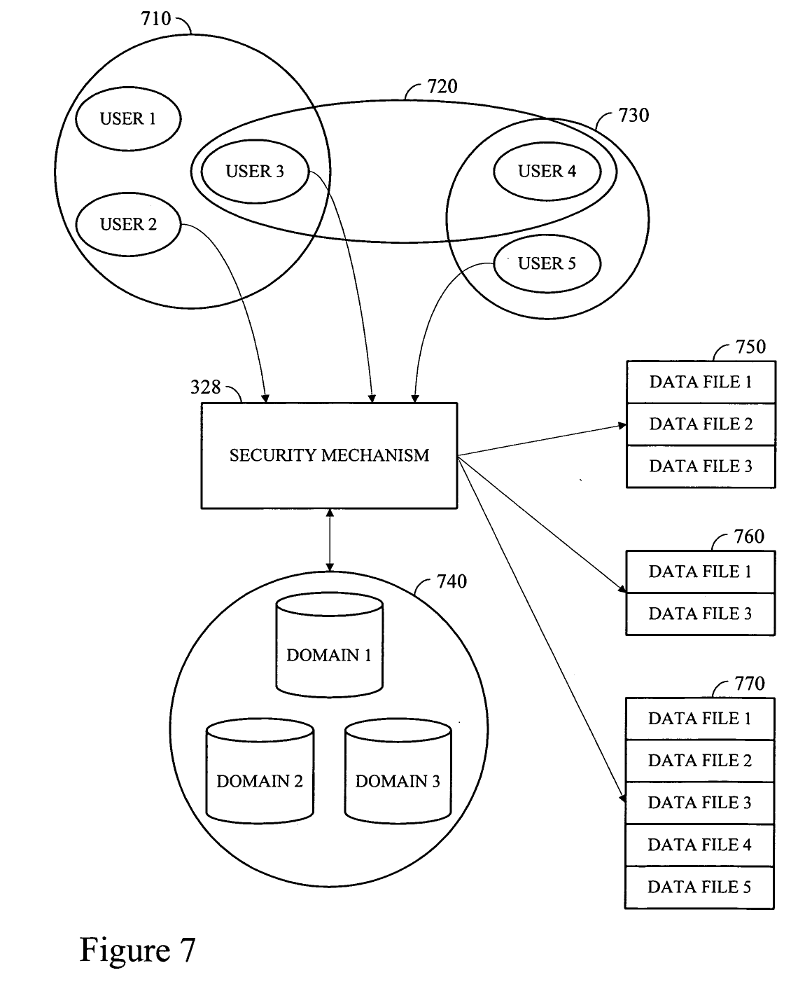

Referring now to FIG. 7, the use of security mechanism 328 to provide customized search results in accordance with one or more embodiments of the present disclosure is depicted. In accordance with at least one embodiment, security mechanism 328 can be configured to provide various levels of security functionality. In one or more embodiments of the present disclosure, both indexed content and query results are protected from unauthorized access by security mechanism 328. The approach to securing data from unauthorized access can be implemented at the enterprise level and also deployed at the desktop, as appropriate or desired, for example. In one or more embodiments of the present disclosure, security mechanism 328 comprises an internal database, used by security mechanism 328 to track a variety of user and context sensitive information in order to ensure access to information only by approved system users.

In accordance with embodiments of the present disclosure, after shared resources are identified, and an index and keyword database are created, the security of the indexed content can be implemented in conjunction with the security desired for database 740. As previously explained, database 740 can comprise data from multiple disparate data stores and the security assigned to the data in database 740 can vary from dataset to dataset. In the case of FIG. 7, database 740 is comprised of three separate data stores identified as domain 1, domain 2, and domain 3. Those skilled in the art should recognize that the use of three separate data stores and domains is for illustration only and more or fewer data stores and/or domains can be used in conjunction with various embodiments of the present disclosure.

In accordance with one or more embodiments, security for search results returned by search mechanism 325 and reported via report mechanism 326 can be implemented via a role-based administration of web services. In accordance with such embodiments, a system of one or more federated servers can be constructed in which a password-protected, server-shared.database is used to define relational tables that store various types of administrative information and correspondences. In embodiments of the present disclosure, users, groups, domains, user roles, and domain groups are defined security components and used by security mechanism 328 to allow or deny access to various types of data stored in database 740 or potentially accessible via search mechanism 325, depending on the status of the various security components.

As shown in FIG. 7, the users are placed in different groups, such as groups 710, 720 and 730, with each group identified as having access to particular domains and/or data files. In this fashion, security mechanism 328 can be used to provide customized search results and protect sensitive data files. User 1, User 2, and User 3 are assigned to user group 710. User 3 and User 4 are assigned to user group 720. Similarly, user 4 and user 5 are assigned to user group 730.

In the example shown in FIG. 7, each of user 2, user 3, and user 4 submits the same search query to database 740. However, because each of these users is assigned to different user groups, the results that are provided in response to their respective queries can be substantially different. In response to the search request from user 2, security mechanism 328 allows dataset 750 to be returned to user 2. In response to the same search request received from user 3, dataset 760 is returned. Finally, in response to the same search request submitted by user 5, security mechanism 328 allows dataset 770 to be returned.

Since user 3 belongs to both user group 710 and 720, a decision must be made as to which groups' access rights can be granted to user 3. This can be accomplished so as to ensure that the desired security levels are maintained. For example, in one security model which can be used with one or more embodiments, the more restrictive access rights of the two user groups can be applied. In a different security model for use with one or more embodiments, the more liberal access rights of the two user groups can be applied. It should be apparent to those skilled in the art that the assignment of users to various user groups can be accomplished in any way necessary to achieve the desired security results. Additionally, each user group can be as small as a single user.

Taken together, the various system user security components can define all registered users of the system and provide a framework or methodology for determining which users are authorized to access which information. The information relative to each user is stored in the database tables associated with the database for security mechanism 328. In accordance with one or more embodiments, various fields can include at least the unique username and a password for each user of search appliance 180 of FIG. 1.

In accordance with one or more embodiments, group permissions can be similarly stored in a database table which includes fields such as a name for each permission group, where a permission group is a customized text string descriptive of a role or function of the enterprise, such as “sales,” “support,” or “admin.” In addition, in accordance with one or more embodiments, a user can inherit security-related permissions and restrictions, based on the specific group permissions for the group to which the user is assigned.

Searchable domains are stored in a database table whose fields define the location, such as a website URI text string, of each domain from which content can be extracted by indexing operations conducted by index mechanism 324 at the request of a user. In general, a user can be restricted to searching only those domains that are identified in the searchable domains tables for that user and/or for the specific group to which that user belongs.

User roles can be stored in a database table whose fields serve to relate system users to group permissions, thus defining one or more roles a user plays within an enterprise. Specifically, a field exists in which a primary key of the system users table can appear in multiple records, each time uniquely corresponding to a second field containing a primary key of an entry of the group permissions table.

Similarly, in accordance with one or more embodiments, domain groups can be stored in a database table whose fields serve to relate searchable domains to group permissions, thus associating a domain with one or more group permissions of the enterprise. A field can exist in which a primary key of the searchable domains table can appear in multiple records, each time uniquely corresponding to a second field containing a primary key of an entry of the group permissions table

In accordance with one or more embodiments, the above-discussed database tables and their relationships can be used to provide a role-based security protocol to protect the results returned from a given user search request. More particularly, using the same security components and sequence/numbering scheme identified above, a specific security protocol can be implemented. User authentication is provided via a match of input username and password to those stored in the system users table, identifying the user as the individual claimed. The text string names of groups of the enterprise are obtained from the group permissions table. Domains of content within or without the enterprise are obtained from the searchable domains table. The user roles table indicates the groups to which the authenticated user belongs. The domain groups table indicates, for a given searchable domain, what groups of users can access that domain's content, and thus, via the user roles table and the matching of group permissions primary keys, what searchable domains the authenticated user has privilege to see

Thus, in accordance with at least one embodiment, the above administrative information can be used to filter the query of a search request, so as to return only information from those domains the authenticated user is permitted to see, based on that individual's role within the enterprise. It should be noted, although alternative levels of granularity can be used, the level of granularity of search restriction can be at a level of a searchable domain, in a case that group permissions are assigned to searchable domains. In other words, the access granted users can be, but is not usually, granted at the level of individual documents, as in a typical file system. However, in one or more embodiments of the present disclosure, an administrator can define searchable domains with a granularity that can vary from finely grained (e.g., at a single-file-level), to medium grained (e.g., at a set-of sub-directories level), or coarsely grained (e.g., at a entire-website level). Thus, the granularity of group permissions can be variable, depending on how the searchable domains are defined. Since documents of a common level of sensitivity are typically grouped together, domains are generally defined correspondingly.

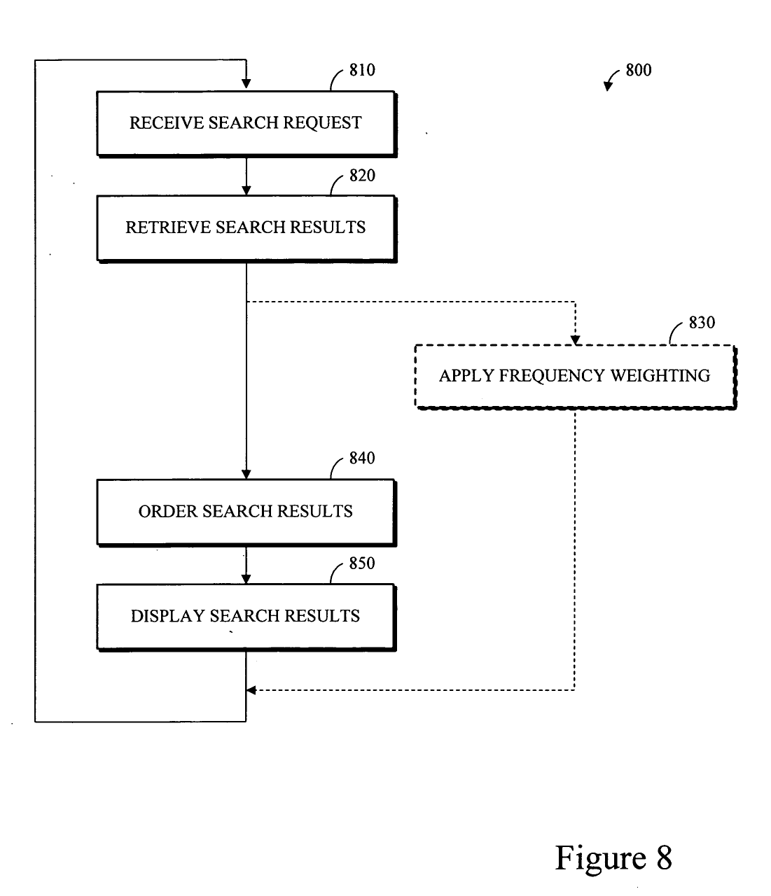

Referring now to FIGS. 3 and 8, a method 800 for scoring and ranking search results in accordance with one or more embodiments of the present disclosure is shown. When a search request is received from a user (step 810), search mechanism 325, in conjunction with database 323 and index mechanism 324 can be deployed to perform the requested search and retrieve the results (step 820).

The results having been obtained, scoring mechanism 327 can be deployed to determine a scoring of the search results. Scoring mechanism 327 can use any of the equations described herein to score results, as discussed above. As shown in FIG. 8, any one or more of the various weighting mechanisms previously described can be used to with, or as an alternative, to score the search results. For example, in accordance with one or more embodiments, search results can be determined by applying frequency weighting (e.g., “enhanced frequency weighting”) (step 830). In accordance with one or more embodiments, the application of one or more weighting factors can be user-configurable, and it is possible for each user to configure scoring mechanism 327 for maximum benefit.

Once the desired user-selected weighting factors have been applied to the search results, the search results can be ordered (step 840) and presented to the user (step 850). In this fashion, the search results can be enhanced and customized for each individual user of search appliance 180.

In one or more embodiments of the present disclosure, search mechanism 325 can use a search model to facilitate searching performed in response to a query consisting of one or more keywords, for example. The search model includes a data model used for searching, indexing and ranking operations, techniques such as word stemming and parts-of-speech tagging, and a lexicon that can learn new words encountered while performing initial and incremental indexing. In addition, the search model can use a pipeline architecture, as is described in more detail below. The search model can also include scoring, or ranking, of search result items, e.g., documents, such as that performed using scoring mechanism 327 to rank the results of a query used with one or more embodiments of the present disclosure.

Word stemming can be used to remove common morphological and inflectional endings from words, so as to normalize terms. One example of such a word stemming mechanism is the Martin Porter Stemming Algorithm. One example of parts-of-speech tagging is the University of Pennsylvania (Penn) Treebank Tagset.

With regard to a search model which can be used in accordance with one or more embodiments, an illustrative description of a design of data structures used, the layout of the supporting database, and incremental indexing is provided. More particularly, the layout of the database and how it is used to maintain long-term storage of the index constructed from document content is discussed. In addition, a design of data structures that exist in memory to provide a short-term working store for the indexing procedure is discussed. A discussion of an indexing procedure is provided, and a principal use case of the search query, showing how a keyword search model is applied to return results to the end user, based on prior indexing, is provided.

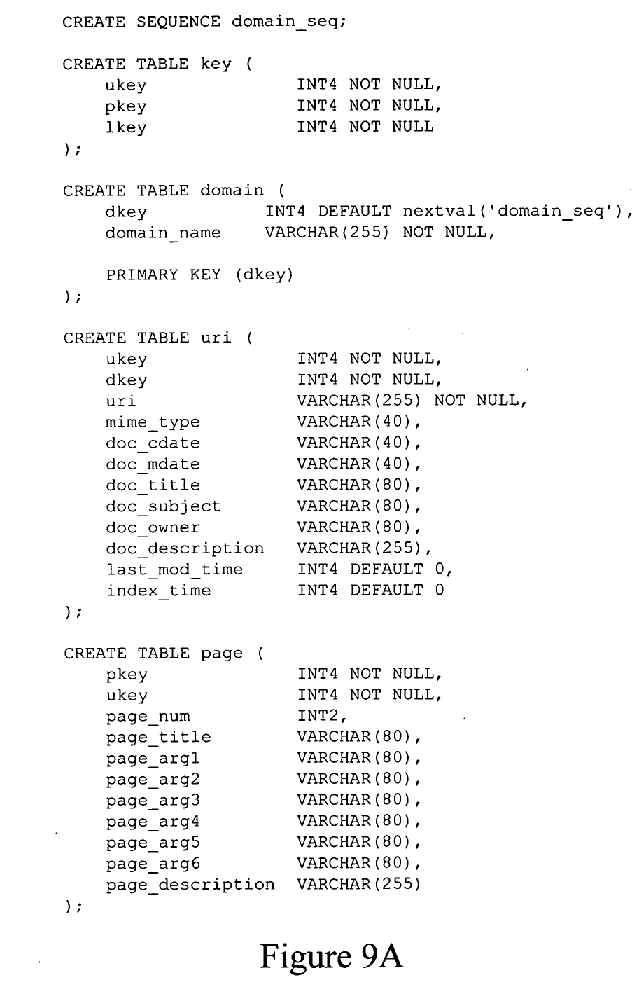

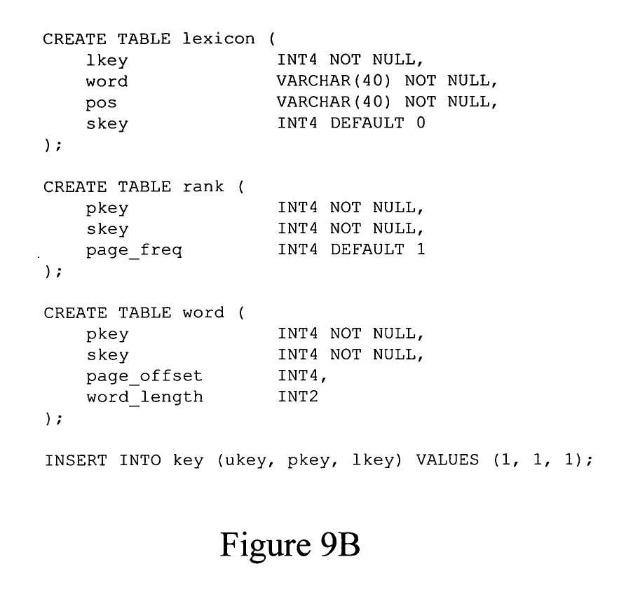

An illustrative example of a database schema used in one or more embodiments of the disclosure is shown in FIG. 9, which comprises FIGS. 9A and 9B. The schema includes key, domain, uri, page, lexicon, rank and word tables described below.

In one or more embodiments of the disclosure, relationships between database tables, which are used to form the inner joins of search queries, are not explicitly stated. In accordance with embodiments of the present disclosure, use of primary or foreign keys can be limited in order to allow the insert of new records via a file import mechanism rather than through the use of the SQL INSERT statement. It should be apparent that most, if not all, database vendors do not permit a file import if the table to which data is being imported defines an auto incrementing field and/or explicit foreign key relationships.

A file import mechanism can be used in embodiments of the present disclosure to achieve efficiencies. More particularly, in view of the numbers of records to be created in generating a search model index, use of an SQL INSERT to insert records in database tables in a relational database is particularly time consuming and impractical. Accordingly, in embodiments of the disclosure, data that is to be inserted into the database is first written to temporary files, or buffers, and then imported into the database. One example of an exception to this approach involves the domain table, which defines an auto incremented index field, and the key table, which maintains counts of indices. Since relatively few records are involved, the file import mechanism need not be used in creating records in the domain and key tables.

In one or more embodiments of the disclosure, the domain, uri, and page tables are used to store information about the document pages that are visited during indexing. A domain refers to a location where documents can be stored, such as a website or file directory. According to this model, every domain that is indexed can be recorded as an entry in the domain table. A document can be referred to by its Universal Resource Indicator, or URI, which can be associated with a specific domain. Every document that is indexed can be recorded as an entry in the uri table. For every page visited there can be a record entered into the page table that corresponds to a specific document and domain. For example, when an e-mail archive that resides in a file system directory is indexed, each e-mail of the archive is recorded as an entry of the page table.

To further illustrate with reference to the data model set forth above, the lexicon and rank tables can be used in indexing the information accessible via network 120. More particularly, the lexicon table, which contains the learning dictionary of the keyword search model, contains an entry for every original, case-insensitive word known to the indexing algorithm, including the parts of speech of each word. The pos field, which can be a comma delimited list of tags constructed, for example, from the Penn Treebank tag set. In addition, the lexicon table can contain an entry for every stem word that can be constructed from the set of known original words. Every entry in the lexicon table is associated with a unique index, denoted by the lkey field. In addition, the ukey field can be a specific lkey index corresponding to a stem word. The ukey field can be used to establish a relationship between ever original word and its corresponding stem word, within the same table. That is, for example, every stem word entry in lexicon can be self-referential, such that the values of lkey and skey of a stem word entry can be identical. An entry in the rank table records the frequency of occurrence of a stem word within a document page, as it is known within the lexicon table.

The word table records the positions of original words encountered during indexing, so that they can be highlighted in subsequent search result presentations. The original words need only be referred to by their corresponding stem words, hence the appearance of the field skey within the definition of the word table.

As discussed above, buffering and a file import mechanism can be used in one or more embodiments of the present disclosure. A data structure is used to provide a buffer for data before it is written to the database. The data that is buffered corresponds to the fields in the uri, page, rank, and word tables. A more detailed discussion of the data structure and the buffering process is discussed in more detail below, however and in accordance with one or more embodiments, buffered data is can be written at the end of indexing, or when memory availability reaches a predefined threshold, requiring a flush of data to free the memory. New records can be written to the tables from the buffered data via a file import mechanism, and existing records can be updated via an SQL UPDATE command.

Another type of data structure used in indexing is an N-ary trie tree, where N is a number of characters (e.g., upper case) in the alphabet, plus digits and punctuation marks. This tree structure can be used to hold the contents of the entire lexicon in memory and to provide fast lookups (e.g., a word lookup), for example. Initially and prior to commencing indexing, the tree structure is populated using the contents of the lexicon table. If new words are encountered during indexing, they can be added to the tree. At the end of indexing, the contents of the tree can be written back to the lexicon table. Preferably, the tree's contents can be written back to the lexicon table using a file import mechanism, as discussed above. For example, entries in the tree which represent new words found during indexing can be imported to the lexicon table via a temporary buffer, or file, using a file import mechanism.

In accordance with embodiments of the invention, the N-ary trie tree structure can be used with large dictionaries of words because text-string lookup within the trie structure is quite fast. Each node of the tree contains an array of size N, where each element of the array is potentially a child node. Memory considerations can be relatively minimal for implementations within pointer-accessible programming environments that implement the N-size array as a pointer array. In one illustrative embodiment, N=69, which is sufficiently small to limit excessive memory allocation.

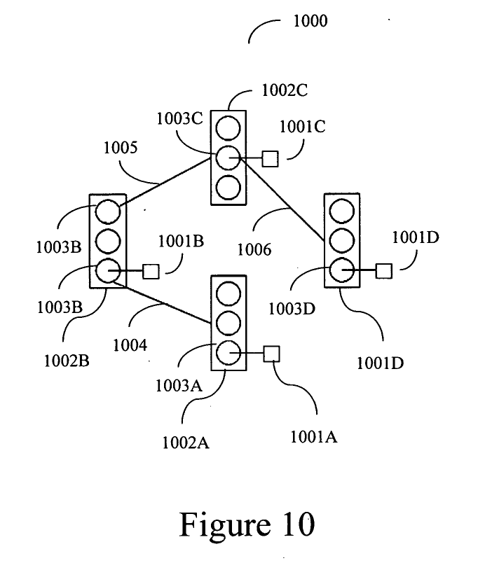

FIG. 10 provides an example of a 3-ary trie tree in accordance with at least one disclosed embodiment. In the example shown, tree 1000 is constructed from an alphabet consisting of the upper case letters A, B, and C. Each of the elements (circles) of the 3-size rectangles, or arrays, 1002A to 1002D, corresponds to a letter, with the top element in an array corresponding to A, the middle element to B, and the bottom element to C. Circles 1003A to 1003D represent allocated nodes. The squares 1001A to 1001D represent an allocation of data at a node, such as the parts of speech of a word. The example of the 3-ary trie tree shown in FIG. 10 depicts the storage of data for the words AB, ABC, C, and CC. In array 1002A, node indicator 1001A indicates that element 1003A, which corresponds to the letter “C” is allocated. Similarly, node indicators 1001B to 1001D correspond to allocations of letters “C”, “B” and “A” in arrays 1002B to 1002D, respectively. Array 1002A corresponds to the word “C”. Following traversal path 1004 from array 1002A to array 1002B, the word “CC” can be formed from elements 1003A and 1003B. Similarly, following traversal path 1005, arrays 1002B and 1002C can form the word “AB” from elements 1003B and 1003C. The word “ABC” can be formed using elements 1003B, 1003C and 1003D of arrays 1002B, 1002B and 1002C, respectively, and traversal paths 1005 and 1006.

In one or more embodiments of the present disclosure, indexing can be performed using a pipeline thread architecture. More particularly, the sequential nature of indexing can be broken up into segments and assigned to the multiplexing stages of the pipeline, so as to enhance throughput. For example, in accordance with one or more embodiments, web crawling can be assigned to the first stage of the pipeline, and the second stage can be used to perform initial format parsing of documents. Additional stages might be used for further passes through documents (such as to apply sophisticated image recognition algorithms). In one of the final stages of the pipeline, indexed content can be written to the working store.

In one example of an application of the pipeline used in embodiments of the present disclosure, a single multiplexing stage can be assigned to perform all of the tasks of indexing, from web crawling, to format parsing, to indexing of words. In accordance with one or more embodiments, the concatenation of all of the sequential tasks can comprise the indexing procedure.

In one or more embodiments of the disclosure, as discussed herein, indexing includes a parsing of documents, or other items found on network 120, to identify new words to be added to the lexicon. In addition, with respect to each document, indexing identifies the words contained within the document, the locations of each of these words, and a frequency of occurrence of the words found in the document.

Thus, in the course of the indexing, embodiments of the present disclosure contemplate the ability of the lexicon to learn new words. When indexing begins, the current content of the lexicon is loaded into memory, as discussed herein. This includes any predefined entries whose parts of speech and corresponding stem words have been carefully reviewed, such as by visual inspection. When new words are entered as part of the learning process, their stem words can be estimated using the Porter stemming algorithm, for example. Also, each new word can be assigned a default part of speech, such as by using the NN tag of the Penn Treebank tag set, for example. It is further contemplated that, in connection with one or more embodiments of the disclosure, the lexicon of the keyword search model can be initialized, e.g., in a version shipped to the end customer, with predefined entries or no entries at all.

The following provides a discussion of incremental indexing, which can be used with a keyword search model used in one or more embodiments of the present disclosure. According to one approach in implementing incremental indexing, two distinct time values: (i) the start time, index_time, of the indexing procedure and (ii) the last modification time, last_mod_time, are maintained for each document visited. These values can be stored, respectively, in the index_time and last_mod_time fields of each record of the uri table of the database schema set forth above.

When indexing commences, in accordance with at least one embodiment, document information stored in the uri table is preferably loaded into a data structure in memory to facilitate comparison of last modification times. If the document cannot be found in the data structure, it is added to the data structure, together with its last modification time and the start time of the present indexing. If the document is found in the data structure, then its modification time is compared to the modification stored in the data structure corresponding to the document. If the two times are equal then the document is not indexed again. Otherwise, the document is again fully indexed, i.e., every page, and the information pertaining to the document, including its last_mod_time and index_time, is updated in the data structure.

In accordance with at least one embodiment, prior to completing an indexing operation, once indexed content has been either inserted or updated, a “final scrub” of the database can be performed. This final scrub can remove obsolete records from the database. For example, those entries that correspond to documents that are identified during the indexing operation as no longer existing (e.g., a document no longer resides within the domains indexed by the current indexing operation) or for whatever reason no longer able to be indexed. Documents so identified during an indexing operation can be removed by deleting their corresponding entries from the uri table, along within any explicit or implicit relationships to other tables in the database. Thus, for example, all pages of such documents also can be deleted from the page table. Obsolete records of the uri table are those whose values within the index_time field do not equal the present start time of indexing.

An example of application of a query generated based on a request from an end user is shown below.
SELECT skey, pos FROM lexicon WHERE word=‘FOO’;

In the example, the query is processed against the search model described above. The example query includes a keyword, “FOO”, which is taken from the user request (e.g., the user request might involve a request for documents containing the word “FOO”). The query shown below is an SQL query involving the lexicon table of the keyword search model, which can be used to look up each unique keyword in the lexicon table of the model database. The lexicon table of the database contains entries for words and their stems and maintains a relationship between each word and its stem. When a keyword of the query is found in the database using the sample SQL query, the parts of speech, pos, of the word, and a reference to its stem word, skey, can be obtained. If the word is principally a noun, i.e., in the Penn Treebank notation, an NN or NNP part of speech, a further SQL query of the database can be performed to obtain the frequencies of occurrence of the stem word within the pages of indexed documents. An example of this later SQL query follows:
SELECT domain_name, uri, page_num, page_title, page_freq FROM rank, page, uri, domain
WHERE (rank.skey=12345 AND rank.pkey=page.pkey AND page.ukey=uri.ukey AND uri.dkey=domain.dkey);

The above SQL query is an example of an inner join that exploits the relationships between the document, page, and rank tables, which were introduced earlier. In this way, the relevant pages of documents can be returned to the end user after the scoring operation, such as that performed by scoring mechanism 327 described herein, is applied to sort the results. In accordance with one or more embodiments of the disclosure, results with a score of zero can be pruned from the list before return to the end user.

In one or more embodiments of the present disclosure, search appliance 180 identifies servers which provide shared resources, or shares. A browser service, or server, provides a list of available resources on a network domain. A master browser maintains the main or master list of computers and shared resources. For example, all workgroups or domains can have one master browser. Thus, a master browser maintains a master list of shared resources, and browser servers maintain a subset of the master list of shared resources. These lists are updated periodically to reflect shared resources added or removed.

According to at least one embodiment of the present disclosure, search appliance 180 searches network 120 to identify sharable resources using SAMBA, an open source utility suite which provides information about shared resources. Documentation for the SAMBA utility suite can be found at www.samba.org.

One such utility provided with the SAMBA utility suite is SMBtree, which can be used to browse the network to identify a list, e.g., in the form of a tree, showing known domains, the servers in those domains, and the shares on the servers. It has been determined by the inventors of the present disclosure that this utility does not necessarily provide an accurate and complete listing of the domains, servers and/or shares. Accordingly, in accordance with embodiments of the present disclosure, other SAMBA utilities are used to supplement the SMBtree utility, in order to obtain a more complete identification of shares accessible via the network.

Another SAMBA utility, a master and browser lookup utility, used to supplement, or in place of, the SMBtree utility, locates all of the browsers, i.e., the master browser and browser servers, on the network, together with their NetBIOS names. Another utility, the SMBclient utility, is then used in embodiments of the present disclosure to obtain directory information from the servers identified by the former utility. In addition, the SMBtree utility can be used to provide a list of the servers and shares on the servers. The process can be iteratively performed until no new servers are returned. In one or more embodiments of the disclosure, the iterative process is implemented as a PERL script.

Shares discovered using the above-identified iterative process, for example, can be mounted to provide access to shared files. That is, for example, a mount operation which references a network device, such as a server or storage appliance and/or a file system, storage device, directory, file, etc. of the network device, makes the referenced item available for access. While the SMB protocol/file system implementation of SAMBA can be used to mount shared files discovered using the above-described iterative process, older versions of the SMB protocol do not support digital signatures, or digital signing. This can result in an incompatibility with file systems that use an authentication technique, such as digital signing, in connection with, or as part of, a mounting operation. For example, more recent implementations of Microsoft's implementation of the CIFS protocol use digital signing for mount authentications.

Thus, in at least one embodiment of the disclosure, the CIFS VFS (i.e., Common Internet File System Virtual File System) is used to mount shares discovered using the above-described iterative process. CIFS VFS is an open source initiative in collaboration with Samba, which allows access to such shares as servers and storage appliances. CIFS VFS implements digital signing, and encompasses the SMB protocol, and is compatible with newer Microsoft implementations of the CIFS protocol, of which SMB is a predecessor. CIFS VFS, which implements digital signing and encompasses the SMB protocol, can be used to mount SMB file shares and the newer CIFS file shares, for example, particularly when digital signing is used within mount authentications. The document entitled “Common Internet File System (CIFS)—Technical Reference (Rev. 1.0)”, SNIA CIFS Technical Workgroup, dated Feb. 27, 2002, provides additional information regarding CIFS VFS, and is incorporated herein by reference. The technical reference is available at http://www.snia.org/tech_activities/CIFS/CIFS-TR-1p00_FINAL.pdf.

FIG. 11, which includes FIG. 11A to FIG. 11O, provides illustrative examples of screens from a user interface of a search appliance in accordance with one or more embodiments of the disclosure. More particularly, the screens provide examples of selections/options offered via a user interface used in one or more embodiments of the disclosure. It should be apparent that the examples provided in these figures are not exhaustive, and that other and/or additional screens and information can be displayed in connection with one or more embodiments of the present disclosure.

A user login screen is shown in FIG. 11A, which allows a user to log into and gain access to functionality provided by search appliance 180, in accordance with various embodiments of the present disclosure. For example, after successfully logging in, a user can be presented with a screen as shown in FIG. 11B, which provides a number of options for indexing configuration. It should be apparent that the options shown in FIG. 11B are examples of indexing configuration options, and are not meant to limit or exclude other options that might be provided with one or more embodiments of the present disclosure.

One of the options shown in FIG. 11B is the “Monitor Indexing” option, which provides a view the status of an indexing operation, start an indexing operation or stop an indexing operation. FIG. 11H illustrates a screen which includes information showing the status of an indexing operation in progress. For example, the start, end and elapsed times associated with an indexing operation can be displayed. In addition, information related to a pipelined indexing operation can be monitored using the “Monitoring Indexing” option. It is also possible to terminate an indexing operation.

Selection of the “Schedule Indexing” option in FIG. 11B provides an ability to schedule an indexing operation to automatically begin at the designated time. FIG. 11I shows a sample screen displayed in response to selection of the “Schedule Indexing” option, wherein day of the week and start time can be specified for an indexing operation.

With reference to FIG. 11B, the “Define Searchable Locations” option selection provides the ability to define location that are to be indexed, and thus from where search results can be obtained. FIGS. 11D to 11G illustrate display screens responsive to selection of the “Define Searchable Locations” option.

Referring again to FIG. 11B, the “Choose Document Types” option allows a user to select the types of documents that are to be indexed in an indexing operation. The scope of a search as well as the search results can be indirectly identified using this option. FIG. 11C provides an example of a screen displayed in response to selection of the “Choose Document Types” option. As illustrated by the sample selections shown in FIG. 11C, examples of document types include electronic mail, generic text, presentation, publication and spreadsheet. In addition, as illustrated, it is also possible to specify document type by the application used to generate the document.

The “Set Operational Parameters” option shown in FIG. 11B allows a user to set parameters associated with the operation of search appliance 180. FIG. 11J provides an example of a screen displayed in response to selection of the “Set Operational Parameters” option. For example, a maximum number of documents indexed from searchable locations can be specified, as well as a level of messages to be logged during operation of search appliance 180, e.g., during a search or indexing operation.

FIG. 11K illustrates an example of a help screen displayed in response to selection of a help option. For example, help can be obtained for search appliance 180, and/or contents of a log file can be displayed.

FIG. 11L provides an example of a screen in which a search is entered according to one or more embodiments of the disclosure. FIG. 11M and FIG. 11N provide examples of results of a search, using keywords “alan”, “larry”, “presentation” and “publication”, conducted using search appliance 180, in accordance with one or more embodiments of the present disclosure. As can be seen in FIG. 11N, the contents of a document uncovered in a search can be displayed.

FIG. 11O shows examples of options which can be used to perform “Users Administration” operations, such as “Add User”, “Change User Password”, “Change User Permissions”, “Remove User”, “Add Groups”, and “Remove Groups”.

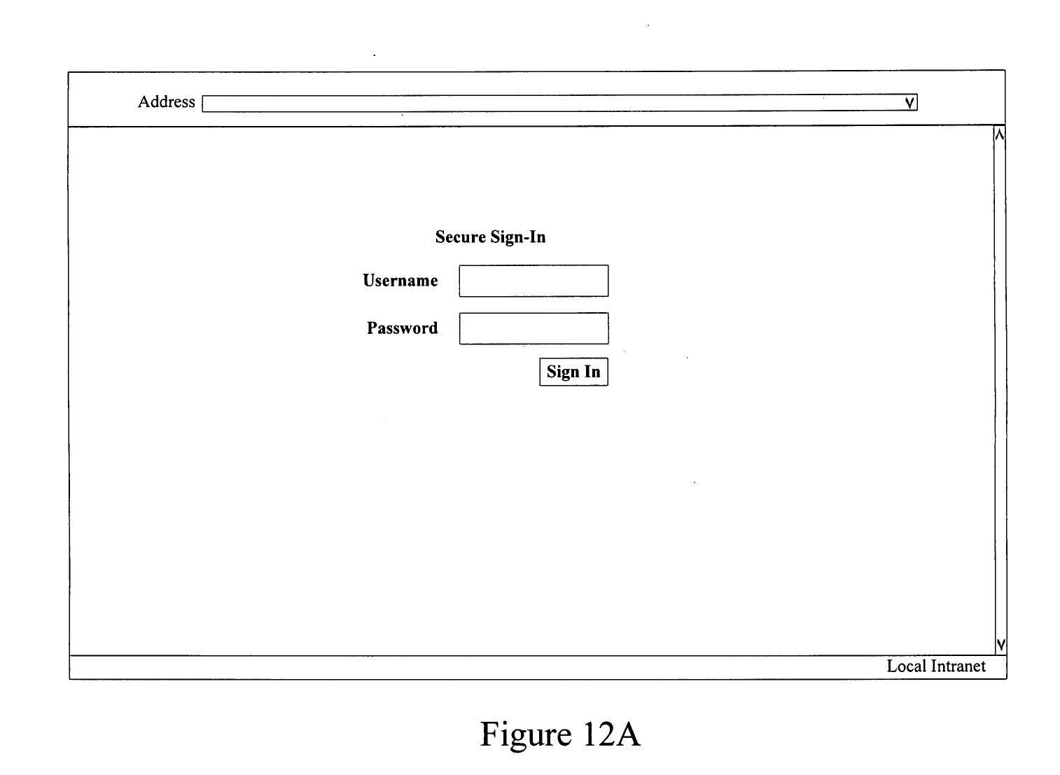

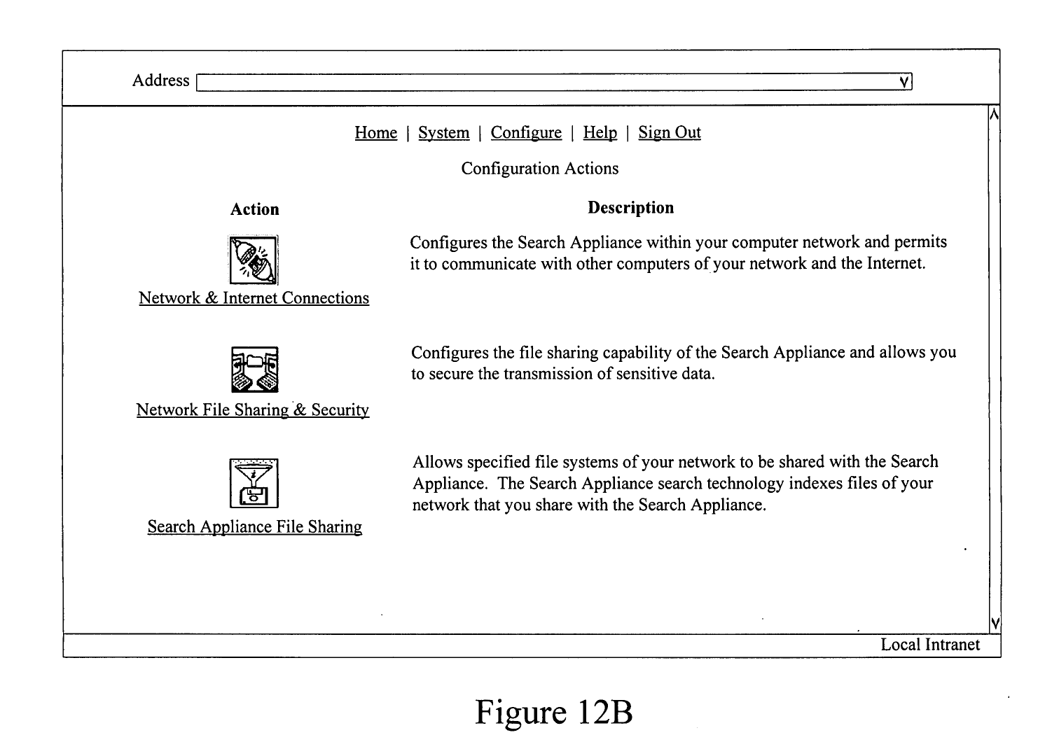

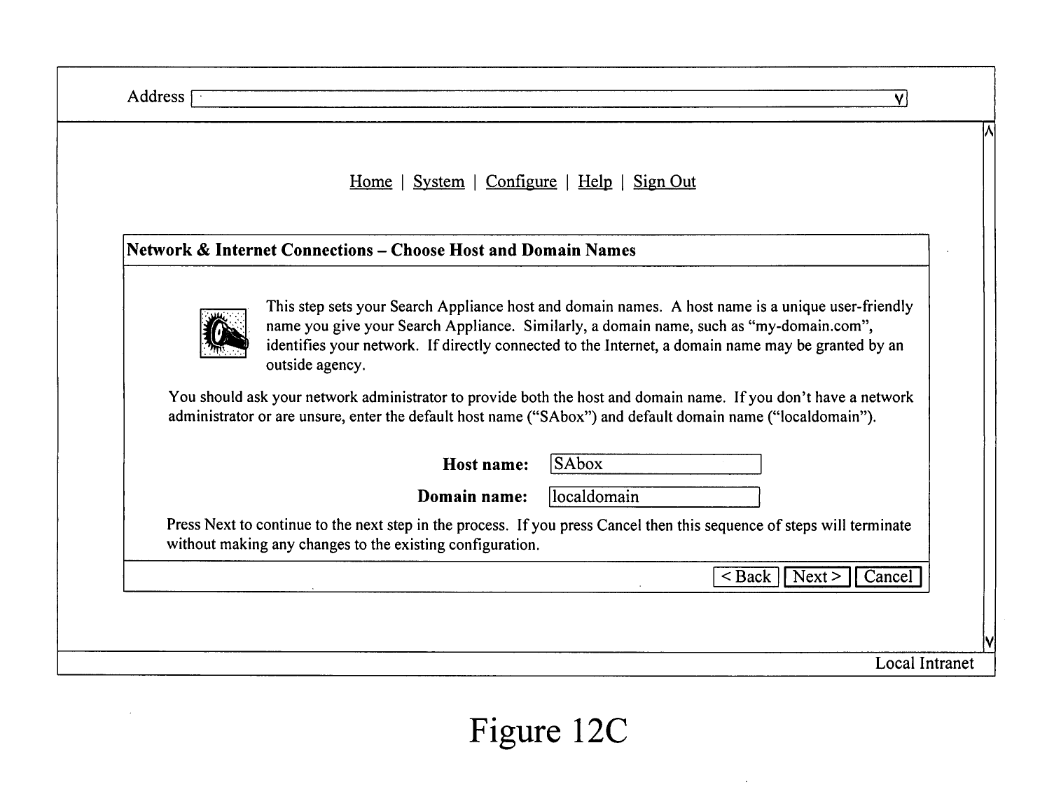

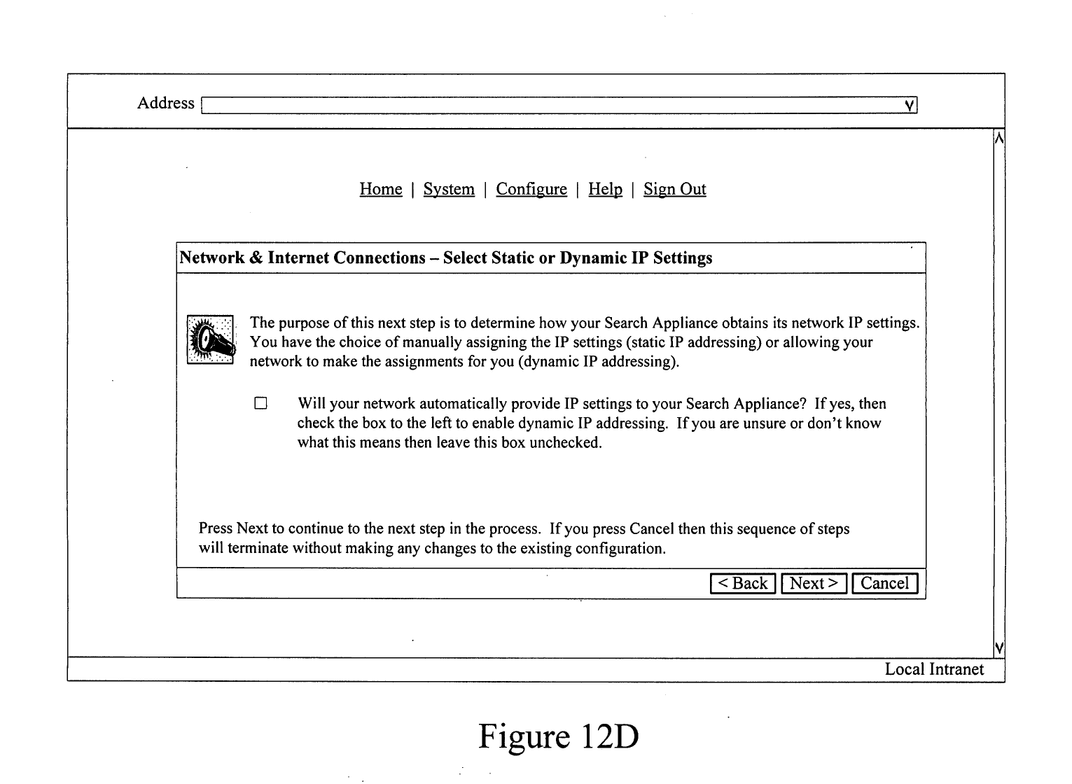

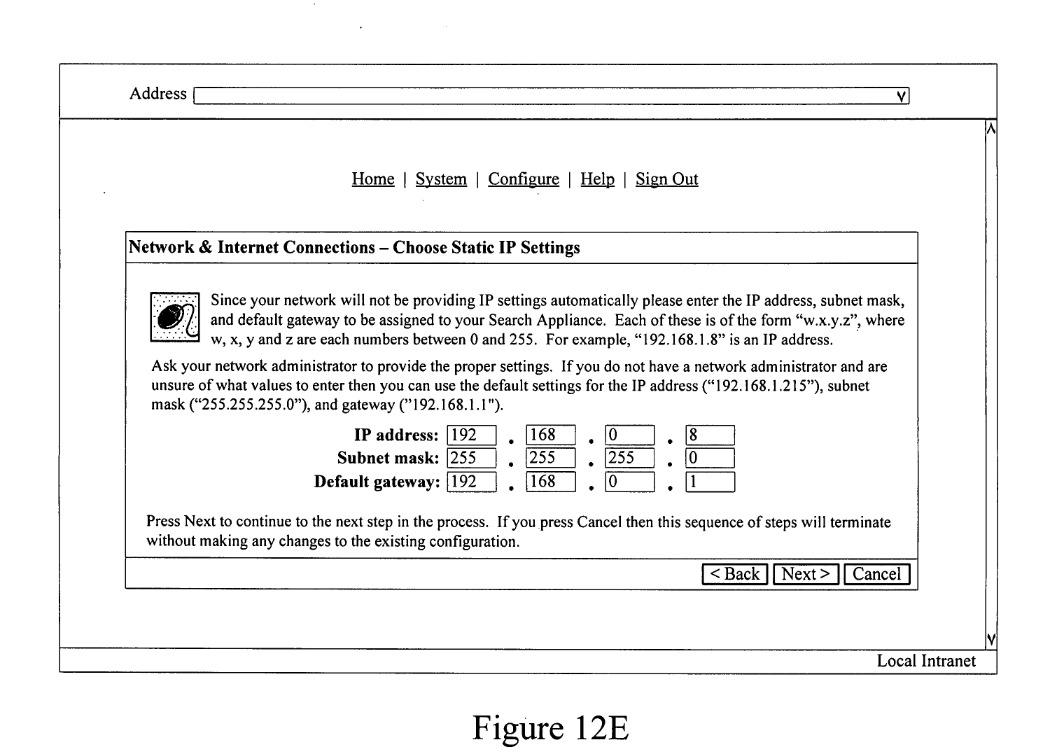

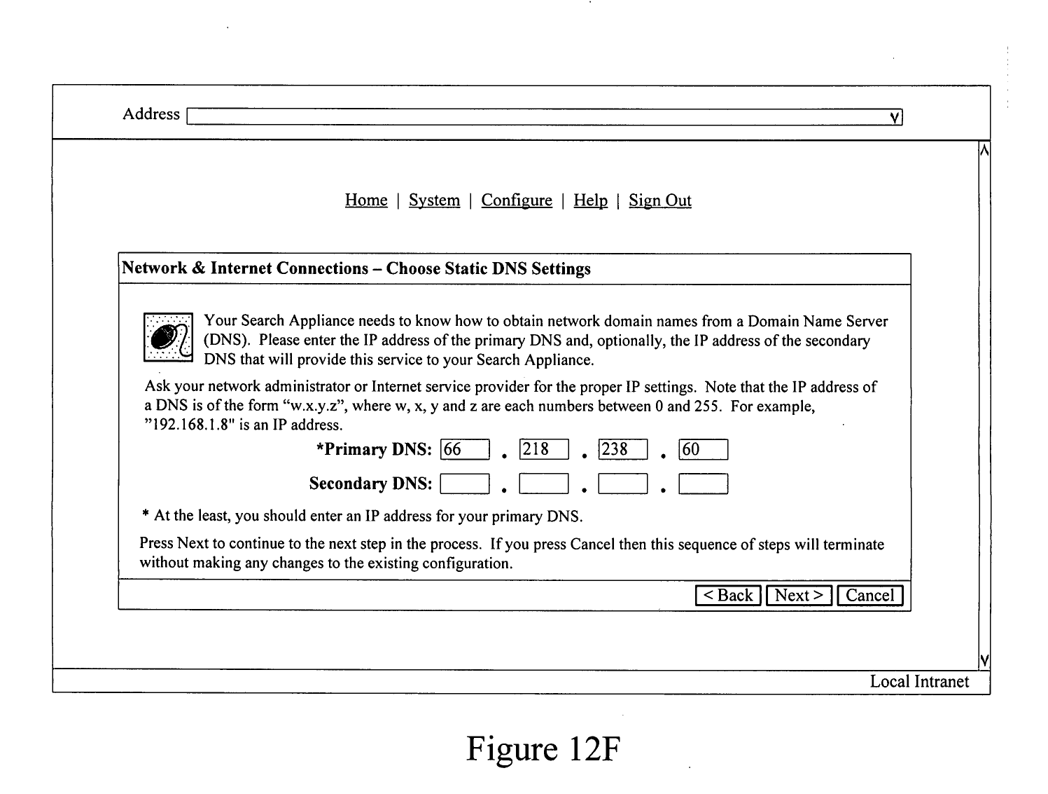

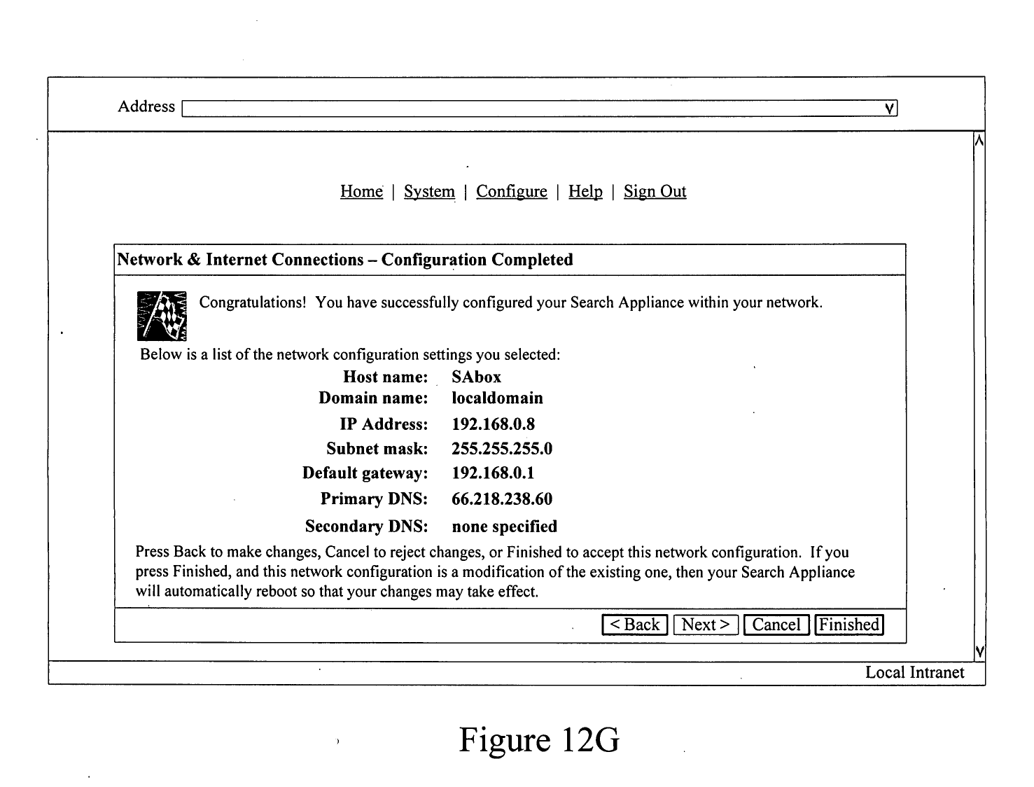

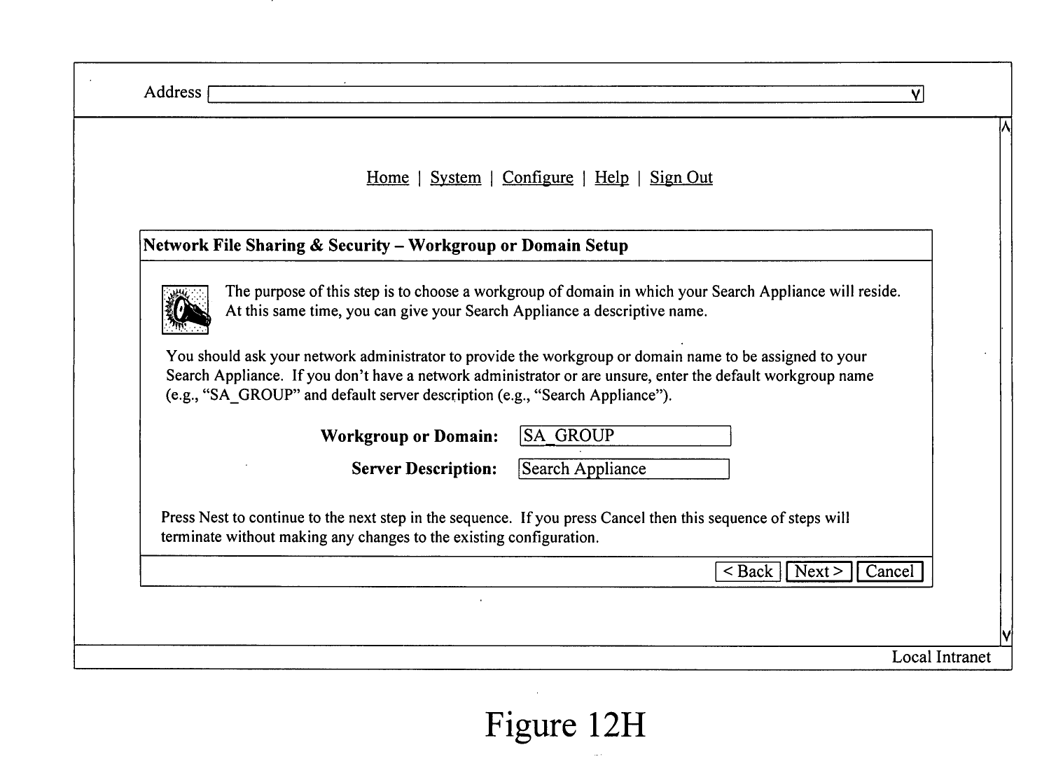

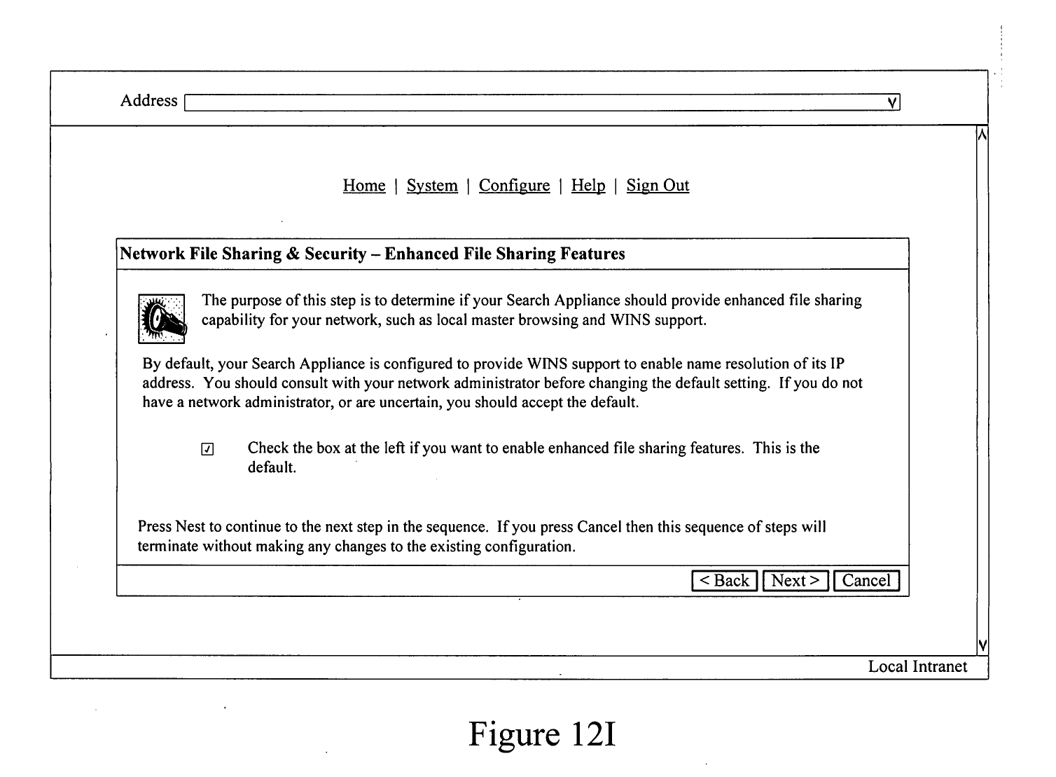

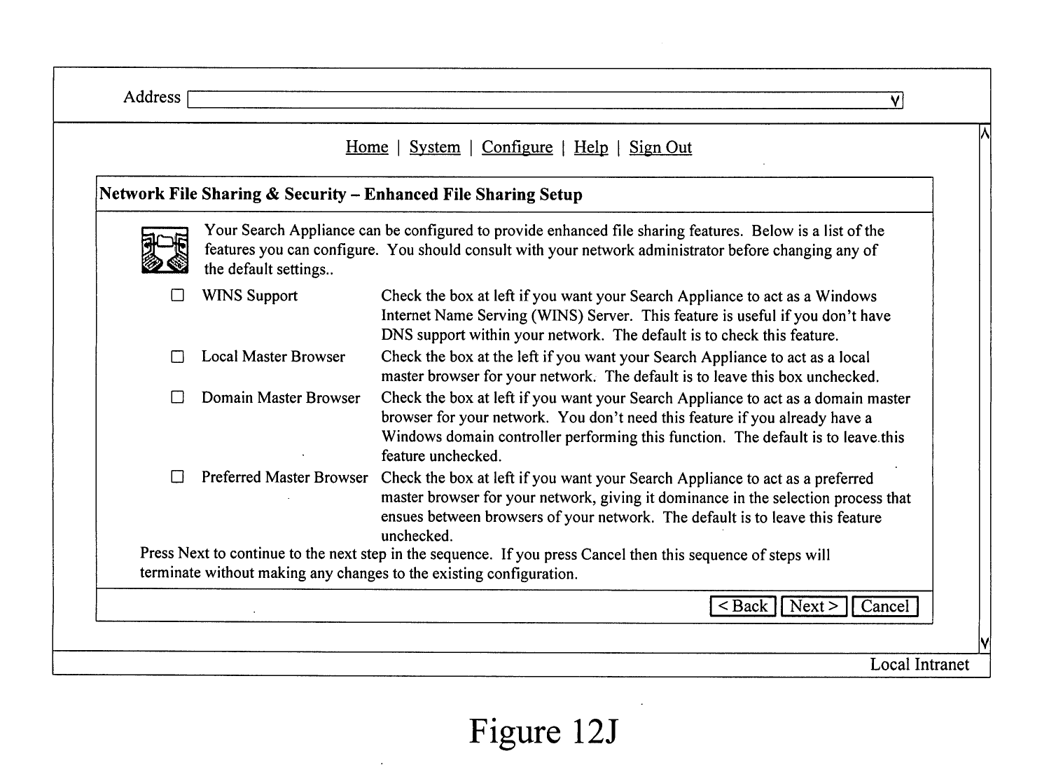

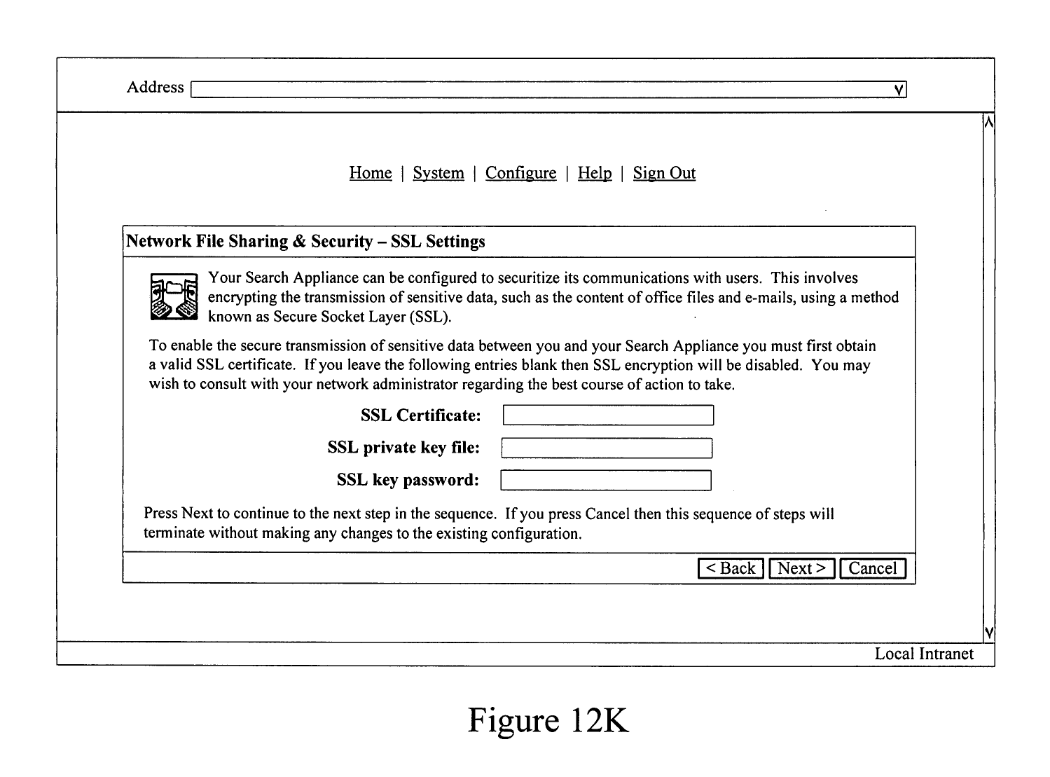

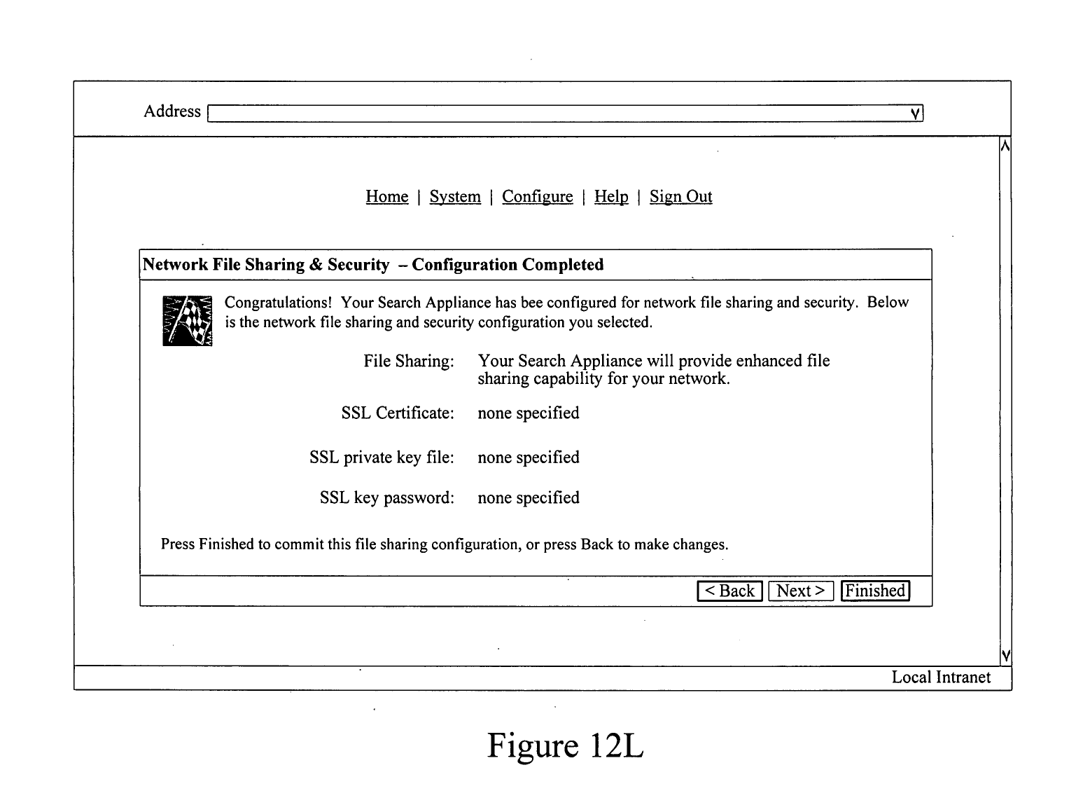

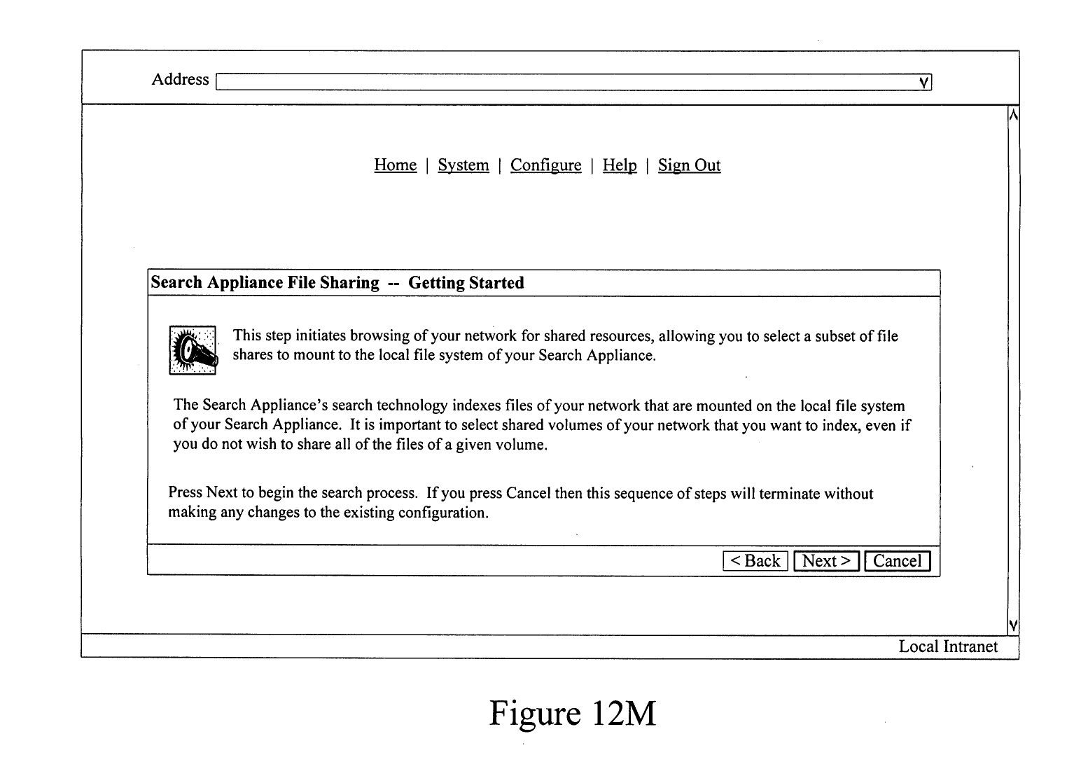

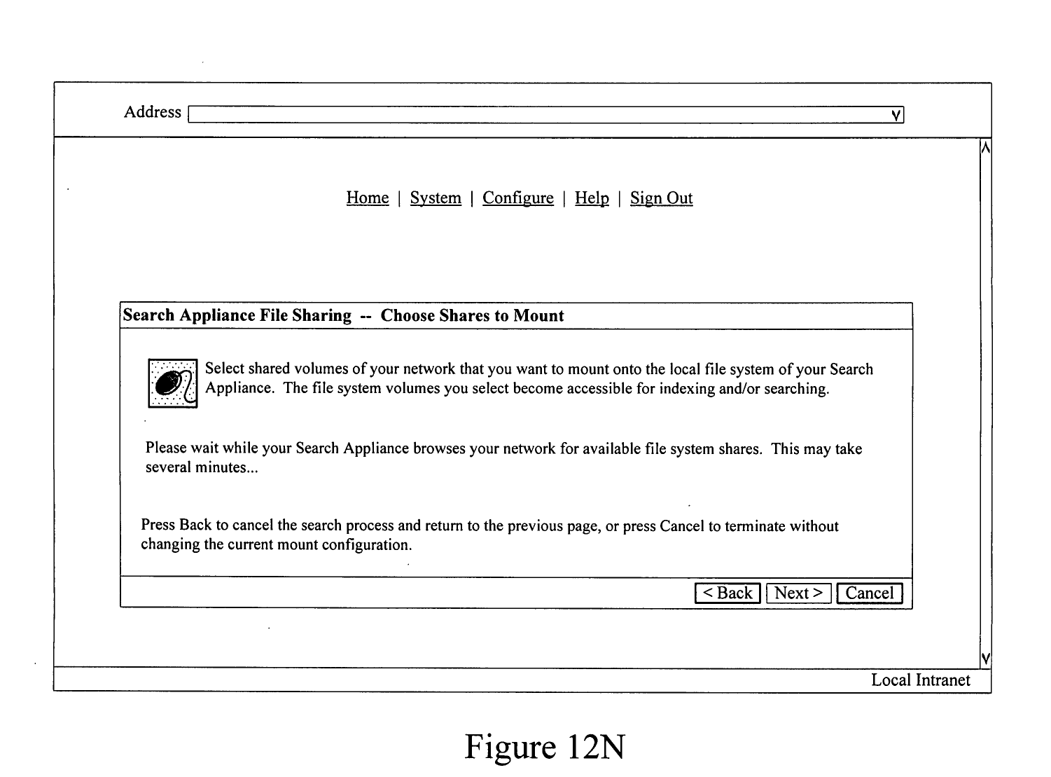

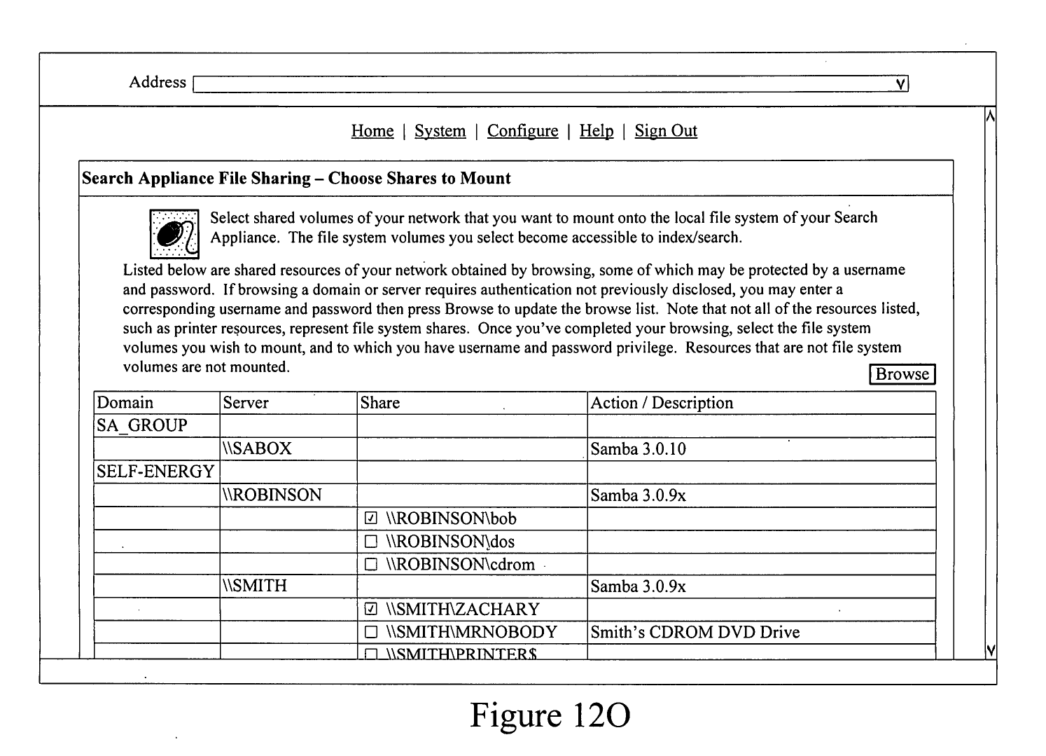

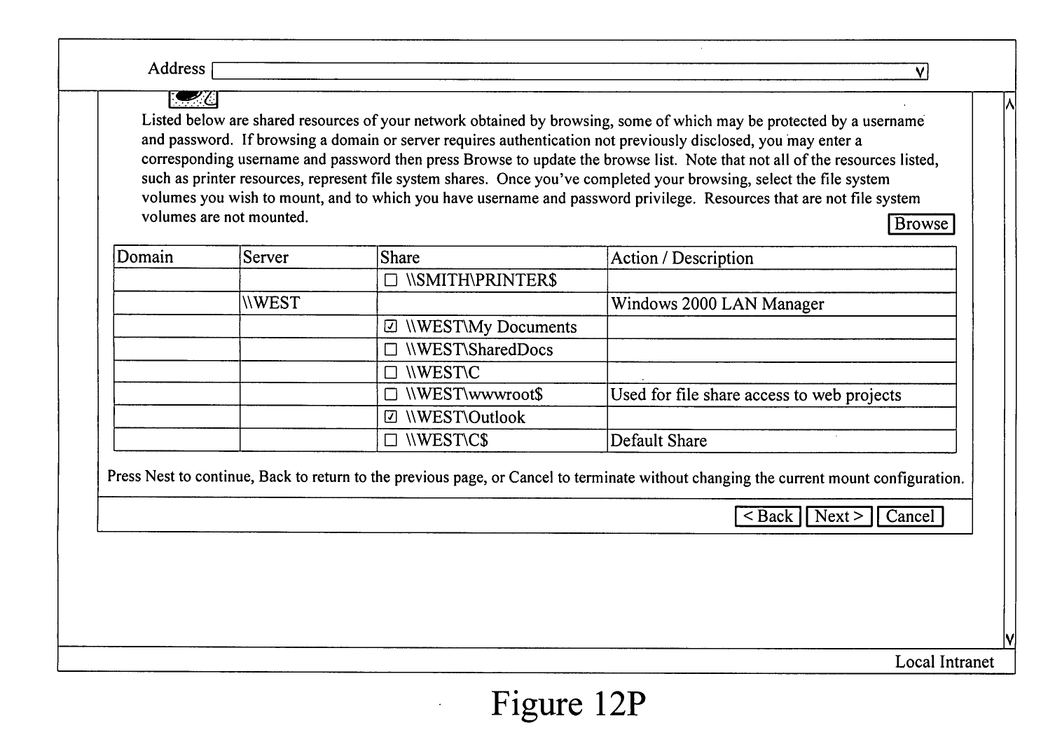

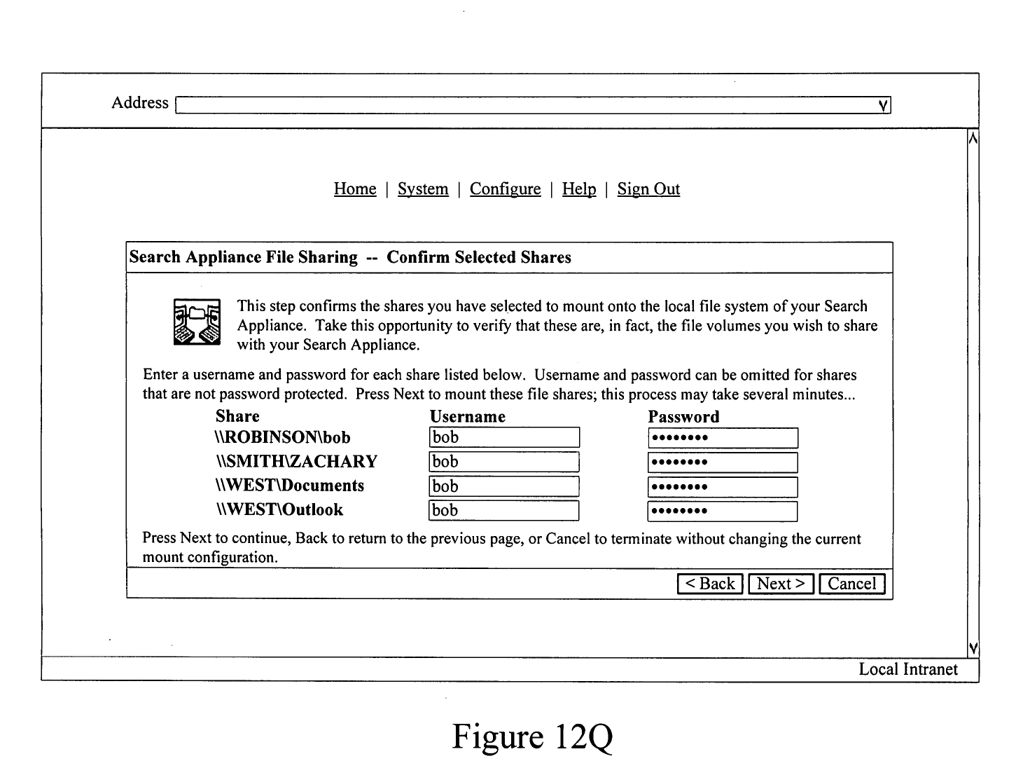

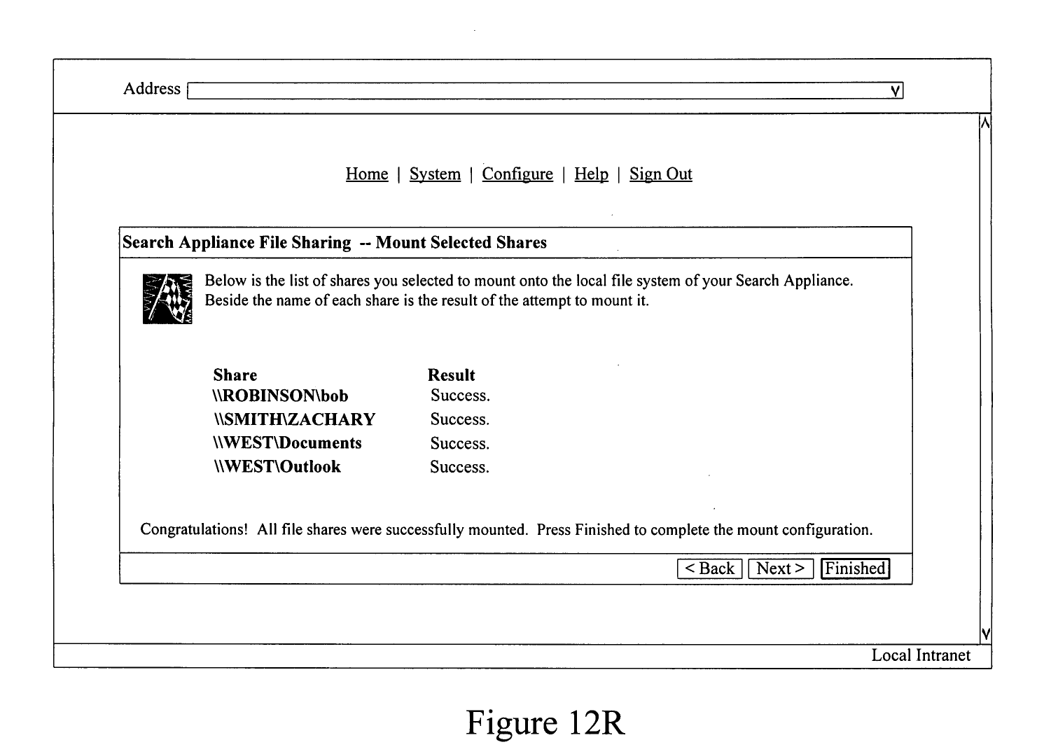

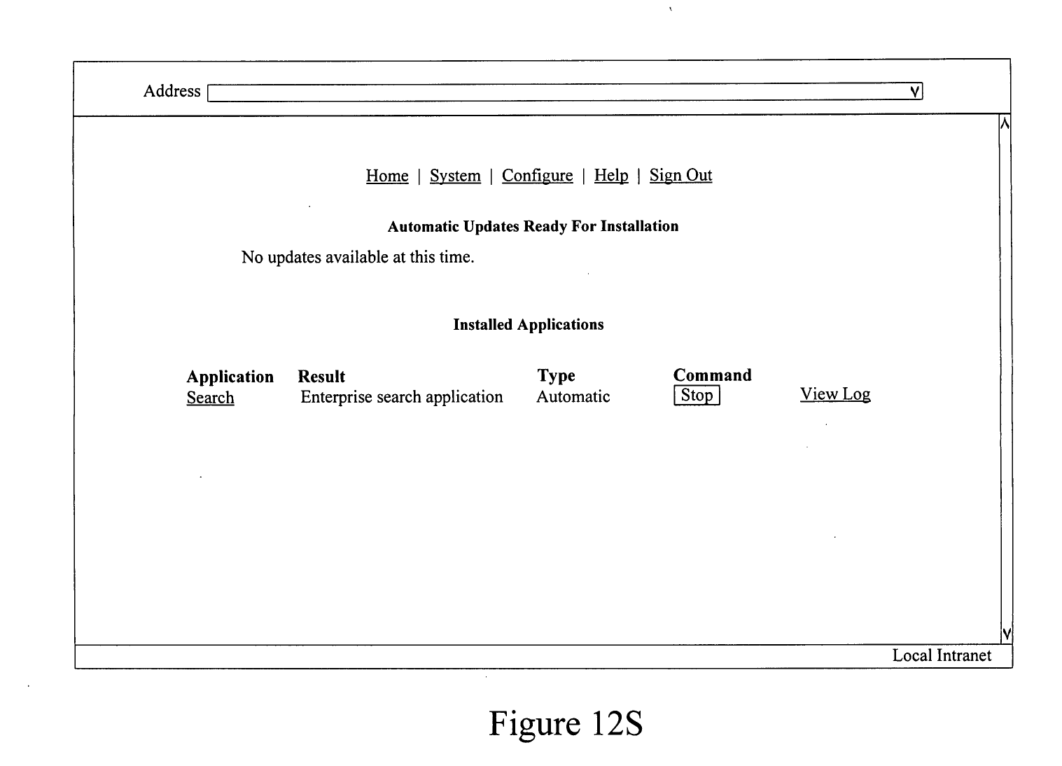

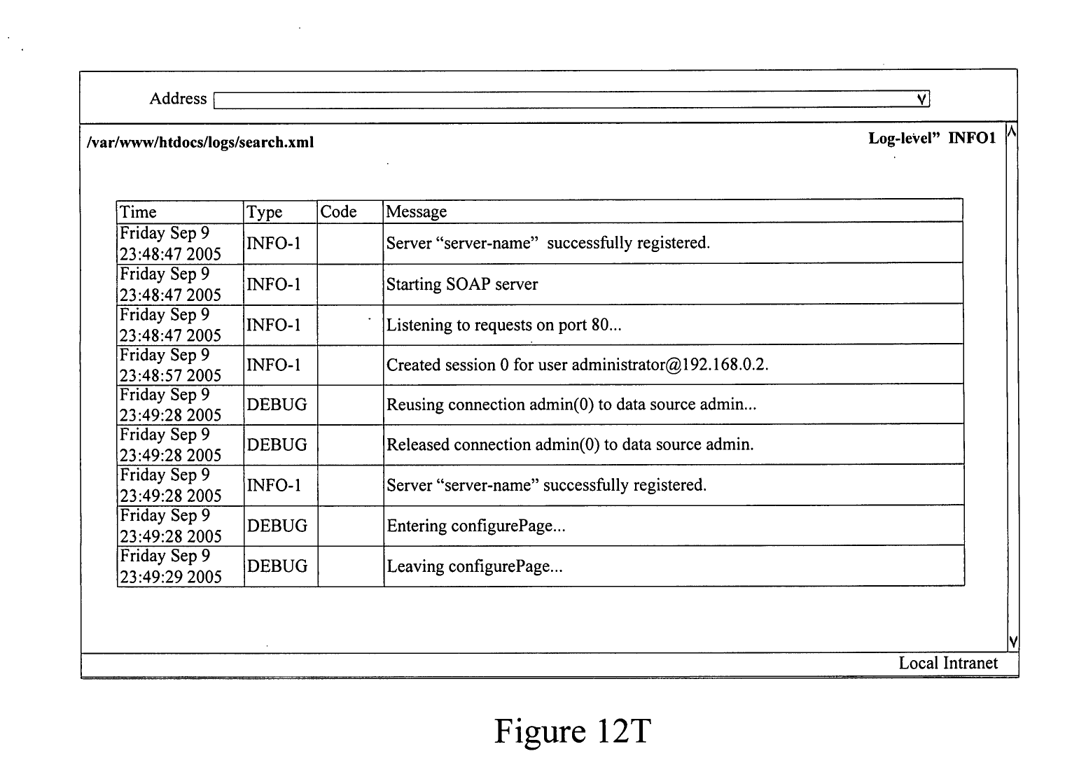

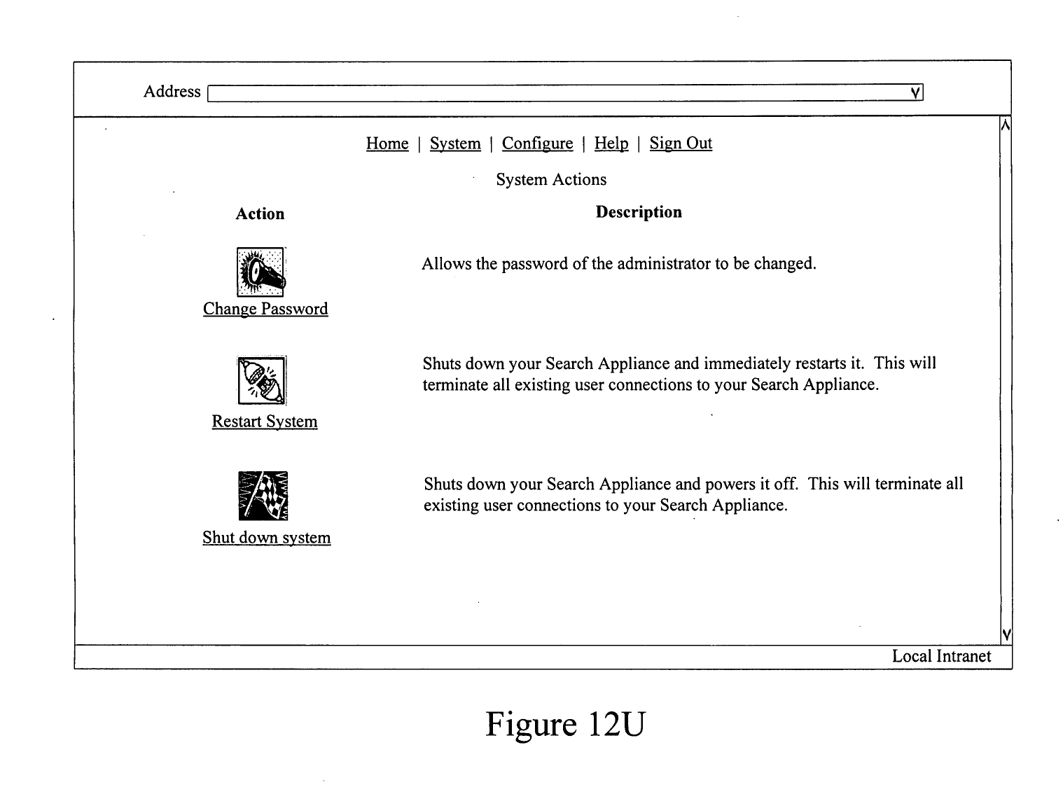

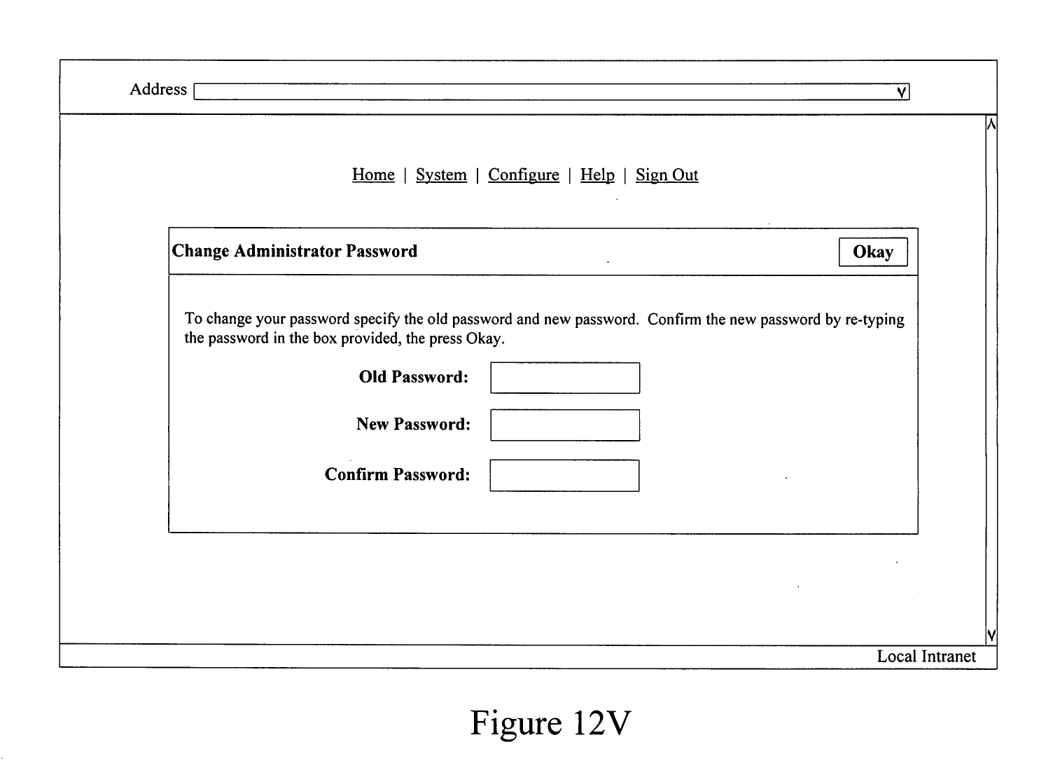

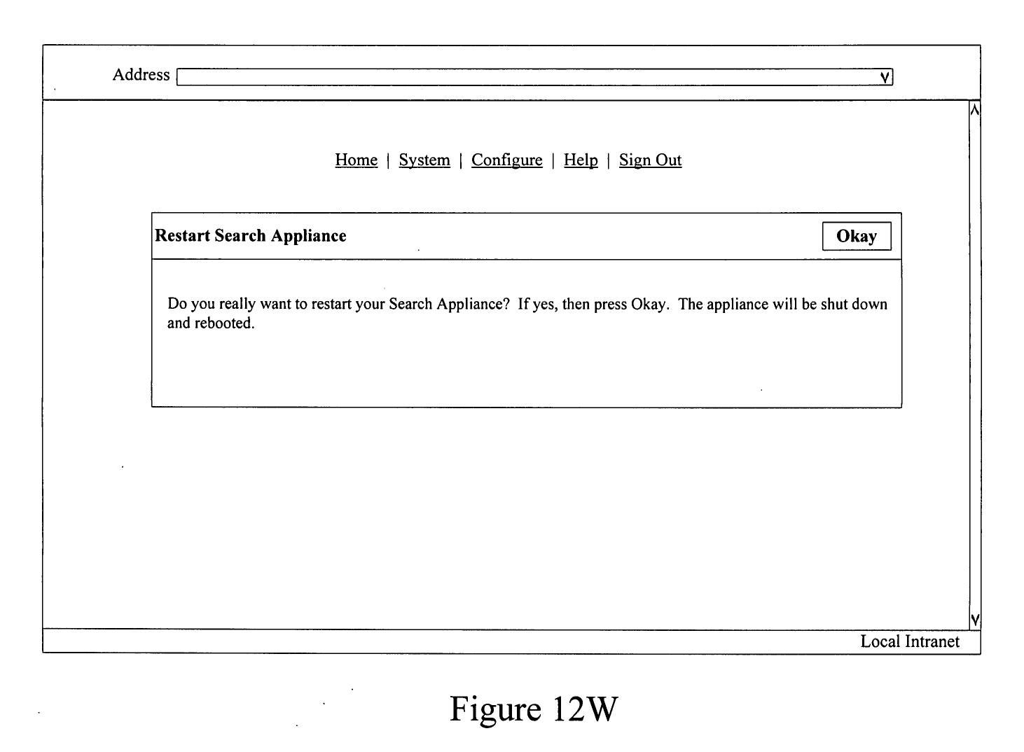

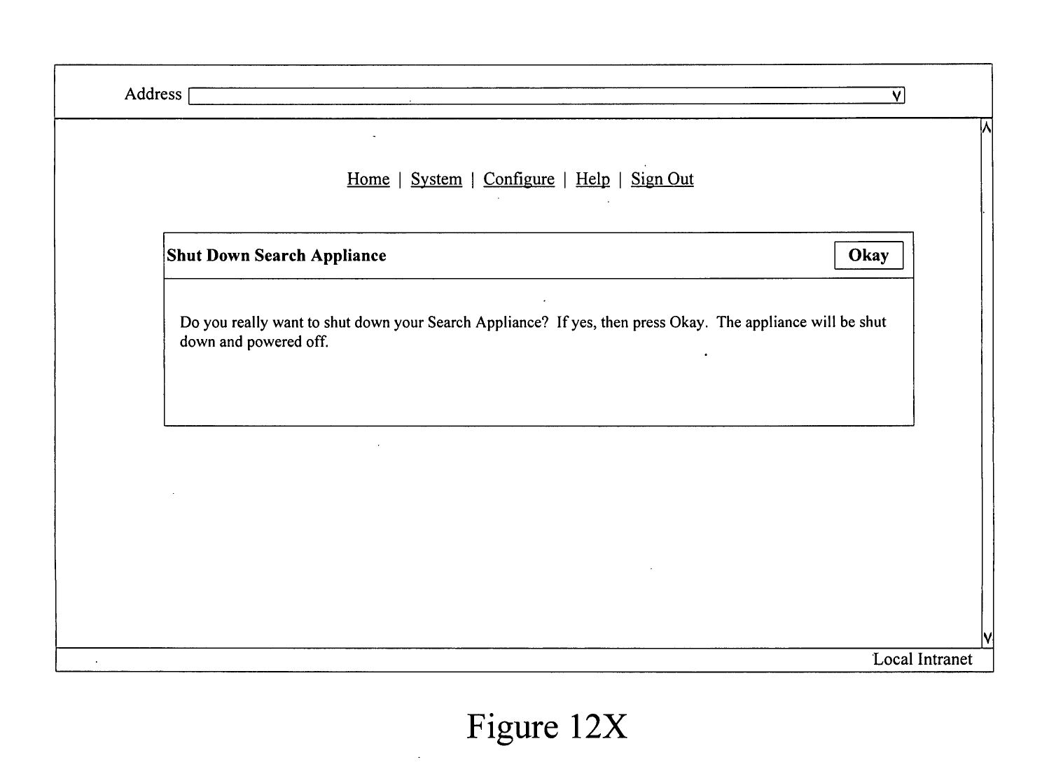

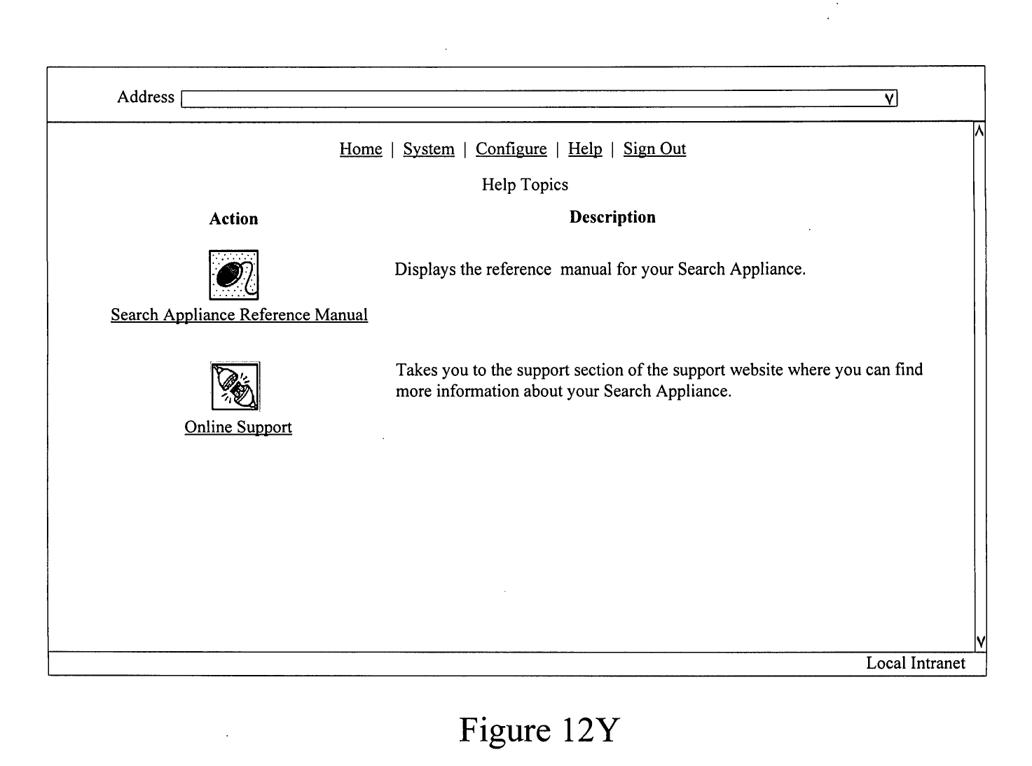

FIG. 12, which includes FIG. 12A to FIG. 12Y, provides illustrative examples of screens from a user interface used in configuration operations for, and/or associated with, search appliance 180 in accordance with one or more embodiments of the present disclosure. It should be apparent that the examples provided in these figures are not exhaustive, and that other and/or additional screens and information can be displayed in connection with one or more embodiments of the present disclosure.

FIG. 12A depicts a login screen, in which a user can enter a username and password to gain access to some or all of the remaining portions of the user interface. For example, after a successful login, the screen shown in FIG. 12B can be displayed to allow the user to select between “Network & Internet Connections”, “Network File Sharing & Security” and “Search Appliance File Sharing”.

The “Network & Internet Connections” option can be used to configure search appliance 180 for a specific computer network, in order for the search appliance 180 to communicate with other computers on the network and/or the Internet. FIG. 12C to FIG. 12G provide examples of screens that can be displayed in response to selection of this option. FIG. 12C can be used to specify host and domain names associated with search appliance 180. FIG. 12D provides an option to either manually or automatically discover the IP settings for search appliance 180. As discussed above, in accordance with one or more embodiments of the disclosure, the IP settings corresponding to an instance of search appliance 180 can be established automatically using a UDP client/server model.

In a case that manual configuration of the IP settings of a search appliance 180 is selected, a screen such as that shown in FIG. 12E can be displayed, to allow a user to enter an IP address, subnet mask, and default gateway for search appliance 180. In addition, FIG. 12F can be used to enter IP addresses corresponding to primary and secondary domain name servers which can assist search appliance 180 in obtaining network domain names. FIG. 12G provides an example of a screen displayed at the successful completion of the manual configuration of IP setting for search appliance 180.

A screen such as that shown in FIG. 12H can be displayed in response to selection of the “Network File Sharing & Security” option given in FIG. 12B. Referring to FIG. 12H, a workgroup and domain for search appliance 180 can be identified. FIG. 12I and FIG. 12J provide the ability to specify enhanced file sharing features for search appliance 180, e.g., use of local master browsing. Search appliance 180 can communicate via using encrypted transmissions based on options provided in the screen shown in FIG. 12K. FIG. 12L provides an example of a screen displayed at the successful completion of the network file sharing and security configuration options performed.

FIG. 12M to FIG. 12R provide examples of screens containing options to “mount” file shares, for purposes of indexing and searching using search appliance 180. FIG. 12O and FIG. 12P illustrate a screen, bottom and top, respectively, which lists shared resources obtained by search appliance 180 browsing network 120. The file system volumes that are to be mounted can be selected using this screen. FIG. 12Q provides a screen containing a listing of file system volumes confirming the selections made using the screen shown in FIG. 12O and FIG. 12P. The screen shown in FIG. 12R provides a status of the mounting operation.

FIG. 12S provides an example of a maintenance screen, which can be used to determine the status of updates, for example, that have already been or should be installed on search appliance 180. FIG. 12T provides an example of a log displayed in response to selection of the “View Message Log” option of FIG. 11K. FIG. 12U to FIG. 12Y illustrate screens related to various system-level options, e.g., security and restarts, as well as some help topics.

In summary, the present disclosure provides an apparatus and method for the broad application of indexing, locating and retrieving desired information in an efficient and effective manner. Lastly, it should be appreciated that the illustrated embodiments are exemplary embodiments only, and are not intended to limit the scope, applicability, or configuration of the present disclosure in any way. Rather, the foregoing detailed description provides those skilled in the art with a convenient road map for implementing the exemplary embodiments of the present disclosure. Accordingly, it should be understood that various changes may be made in the function and arrangement of elements described in the various exemplary embodiments without departing from the spirit and scope of the present disclosure as set forth in the appended claims.

What we claim is:

1. A device connectable to a network, the device comprising:
an integrator configured to integrate the device on the network using dynamically-established network settings including a network address for the network device;
a resource identifier configured to:
traverse at least a portion of the network to discover one or more network devices connected to the network;
identify information sources associated with at least one of the discovered network devices;
generate at least one index of information items associated with the identified information sources;
an information retrieval engine configured to identify information items available from the identified information sources that satisfy a search criteria.

2. The apparatus of claim 1, wherein said resource identifier is further configured to maintain a list of discovered network devices.

3. The apparatus of claim 2, wherein said resource identifier is further configured to use the discovered network devices list to identify information sources.

4. The apparatus of claim 1, wherein the resource identifier is further configured to maintain a search repository which comprises a database, the database comprising domain, universal resource indicator (URI), and page tables used to store information corresponding to pages within documents stored as files at a location, or domain, on the network.

5. The apparatus of claim 4, wherein:
the domain table includes a name corresponding to each domain;
the URI table includes a URI for each document, together with a last modification date and an index time;
the page table has an entry for each page.

6. The apparatus of claim 5, wherein the page comprises a web page, an electronic mail page, or a page within a document.

7. The apparatus of claim 4, further comprising a database management system configured to update existing records in the database, and a data importer configured to import new records to the database.

8. The apparatus of claim 4, further comprising a dynamically-updatable lexicon of words, parts of speech of each word, and at least one stem word corresponding to a word stored in the lexicon.

9. The apparatus of claim 8, further comprising a buffer to store the lexicon, said buffer having an N-ary trie structure, where N represents a number of elements in a character set.

10. The apparatus of claim 9, wherein said resource identifier is further configured to identify updates to the lexicon while indexing the information items associated with the identified information sources, the updates being stored in said N-ary trie buffer structure prior to being written to the database.

11. The apparatus of claim 4, wherein the database further comprises a rank table, the rank table comprising one or more entries, each entry of which records a frequency of occurrence of a stem word in an information item.

12. The apparatus of claim 11, the frequency of occurrence is updated to reflect a change in the information item.

13. The apparatus of claim 11, wherein said information retrieval engine is further configure to rank the identified information items in accordance with a score determined for each information item identified by said information retrieval engine, the score being based at least in part on the frequency of occurrence of one or more stem words associated with the information item.

14. The apparatus of claim 1, wherein each of the information sources comprises a storage media, file system directory, file document, or page.

15. The apparatus of claim 1, wherein said information retrieval engine is further configured to determine a score for each of the information items identified by said information retrieval engine.

16. The apparatus of claim 15, wherein the search criteria comprises at least one stem word, said information retrieval engine further configured to determine a number of occurrences of each search criteria stem word in each of the identified information items and to determine the score for a given one of the identified information items based at least in part on an aggregate of the number of occurrences of each search criteria stem word found in the given information item.

17. The apparatus of claim 16, wherein said information retrieval engine is further configured to determine the score for the given information item based on the aggregate and a weighting which takes into account simultaneous occurrences of search criteria stem words associated with the given information item.

18. The apparatus of claim 1, wherein said integrator is configured to communicate configuration information to a network server and to receive the network settings in response.

19. The apparatus of claim 18, wherein said integrator is configured to authenticate the network server prior to communicating the configuration information to the network server or prior to using the network settings to integrate the device on the network.

20. The apparatus of claim 18, wherein said integrator is configured to use a user datagram protocol (UDP) client/server model to integrate the device on the network.

21. The apparatus of claim 1, wherein said resource identifier is further configured to identify network domains, identify servers in each of the identified network domains and shares on each of the identified servers.

22. The apparatus of claim 21, wherein said resource identifier is further configured to use a mount operation to access an identified server, a storage device associated with an identified server, and/or a file system associated with a storage device.

23. The apparatus of claim 22, wherein said resource identifier is further configured to supply authentication information for use with the mount operation.

24. A method for use with a device connectable to a network, the method comprising:
integrating the device on the network using dynamically-established network settings including a network address for the network device;
traversing at least a portion of the network to discover one or more network devices connected to the network;
identifying information sources associated with at least one of the discovered network devices;
generating at least one index of information items associated with the identified information sources;
identifying information items available from the identified information sources that satisfy a search criteria.

25. The method of claim 25, further comprising maintaining a list of discovered network devices.

26. The method of claim 26, further comprising identifying information sources using the discovered network devices list.

27. The method of claim 25, further comprising maintaining a search repository which comprises a database, the database comprising domain, universal resource indicator (URI), and page tables used to store information corresponding to pages within documents stored as files at a location, or domain, on the network.

28. The method of claim 28, wherein:
the domain table includes a name corresponding to each domain;
the URI table includes a URI for each document, together with a last modification date and an index time;
the page table has an entry for each page.

29. The method of claim 29, wherein the page comprises a web page, an electronic mail page, or a page within a document.

30. The method of claim 28, further comprising updating existing records in the database, and importing new records to the database.

31. The method of claim 28, further comprising maintaining a dynamically-updatable lexicon of words, parts of speech of each word, and at least one stem word corresponding to a word stored in the lexicon.

32. The method of claim 32, further comprising storing the lexicon in a buffer having an N-ary trie structure, where N represents a number of elements in a character set.

33. The method of claim 33, further comprising identifying updates to the lexicon while indexing the information items associated with the identified information sources, the updates being stored in the N-ary trie buffer structure prior to being written to the database.

34. The method of claim 28, wherein the database further comprises a rank table, the rank table comprising one or more entries, each entry of which records a frequency of occurrence of a stem word in an information item.

35. The method of claim 34, further comprising updating the frequency of occurrence to reflect a change in the information item.

36. The method of claim 35, further comprising ranking the identified information items in accordance with a score determined for each information item identified by said information retrieval engine, the score being based at least in part on the frequency of occurrence of one or more stem words associated with the information item.

37. The method of claim 25, wherein each of the information sources comprises a storage media, file system directory, file document, or page.

38. The method of claim 25, further comprising determining a score for each of the identified information items.

39. The method of claim 38, wherein the search criteria comprises at least one stem word, said method further comprising:
determining a number of occurrences of each search criteria stem word in each of the identified information items; and
determining the score for a given one of the identified information items based at least in part on an aggregate of the number of occurrences of each search criteria stem word found in the given information item.

40. The method of claim 39, further comprising determining the score for the given information item based on the aggregate and a weighting which takes into account simultaneous occurrences of search criteria stem words associated with the given information item.

41. The method of claim 25, further comprising communicating configuration information to a network server and receiving the network settings in response.

42. The method of claim 41, further comprising authenticating the network server prior to communicating the configuration information to the network server or prior to using the network settings to integrate the device on the network.

43. The method of claim 41, further comprising integrating the device on the network using a user datagram protocol (UDP) client/server model.

44. The method of claim 25, further comprising identifying network domains, identifying servers in each of the identified network domains and identifying shares on each of the identified servers.

45. The method of claim 44, further comprising accessing an identified server, a storage device associated with an identified server, and/or a file system associated with a storage device using a mount operation.

46. The method of claim 45, further comprising supplying authentication information for use with the mount operation.
